(19) United States
(12) Patent Application Publication
(10) Pub. No.: US 2025/0287387 A1
(43) Pub. Date: Sep. 11, 2025

(54) TERMINAL, BASE STATION, AND WIRELESS COMMUNICATION METHOD

(71) Applicant: NTT DOCOMO, INC., Tokyo (JP)

(72) Inventors: Daisuke Kurita, Tokyo (JP); Hiroki Harada, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/859,838

(22) PCT Filed: Apr. 27, 2022
(86) PCT No.: PCT/JP2022/019197

§ 371 Date: Oct. 24, 2024

(51) Int. Cl. H04W 72/23; H04L 5/14

(52) U.S. Cl. CPC H04W 72/23; H04L 5/14

(57) ABSTRACT

An aspect of the present disclosure provides a terminal having: a control unit for controlling PDCCH overbooking in a cross division duplex (XDD) time unit in which PDCCH monitoring is set; and a reception unit for executing PDCCH monitoring on a PDCCH monitoring occasion selected in the controlled PDCCH overbooking.

### TECHNICAL FIELD

The present disclosure relates to a terminal, a base station and a wireless communication method.

### BACKGROUND ART

In Universal Mobile Telecommunications System (UMTS) networks, Long Term Evolution (LTE) has been standardized for the purpose of a higher data rate, low latency and the like. Also, LTE-Advanced (3GPP (Third Generation Partnership Project) Release (Rel.) 10-14) has been standardized for the purpose of a larger capacity, advancement and the like of the LTE (3GPP Rel. 8 and 9).

Successor systems of the LTE (referred to as 5^{th} generation mobile communication system (5G), 5G+ (plus), 6^{th} generation mobile communication system (6G), New Radio (NR), 3GPP Rel. 15 and after or the like, for example) are being also discussed.

### CITATION LIST

### Patent Literature

### NPL 1

“Initial Views on Release 18 NR” RP-210293, 3GPP TSG RAN Meeting #91-e Electronic Meeting, Mar. 16-26, 2021

### SUMMARY OF INVENTION

In a future radio communication system (for example, the NR), it is envisaged that multiple user terminals (User Equipments (UEs)) communicate under environments of ultra-high densities and high traffics.

In such environments, shortage of uplink (UL) resources compared to downlink (DL) resources is envisaged.

In previous NR specifications, however, methods for increasing the uplink resources have not been sufficiently discussed. If the methods cannot be controlled properly, there is a risk that system performance such as increases in latency and reduction in coverage performance may be reduced.

Thus, one objective of the present disclosure is to provide a terminal, a base station and a wireless communication method for enhancement of use efficiency of resources.

According to one aspect of the present disclosure, there is provided a terminal including

According to another aspect of the present disclosure, there is provided a terminal including a receiver that receives a PDCCH monitoring configuration for an XDD (Cross Division Duplex) operation, and a controller that controls PDCCH monitoring in accordance with the PDCCH monitoring configuration.

According to another aspect of the present disclosure, there is provided a terminal including a receiver that receives a PDCCH monitoring capability regarding an XDD (Cross Division Duplex) operation for radio resources, and a controller that controls PDCCH monitoring in accordance with the PDCCH monitoring capability.

According to another aspect of the present disclosure, there is provided a terminal including a controller that controls PDCCH overbooking in XDD (Cross Division Duplex) time units where PDCCH monitoring is configured, and a receiver that performs the PDCCH monitoring in a PDCCH monitoring occasion selected in the controlled PDCCH overbooking.

According to another aspect of the present disclosure, there is provided a terminal including a controller that selects a PDCCH monitoring beam in XDD (Cross Division Duplex) time units where PDCCH monitoring is configured, and a receiver that performs the PDCCH monitoring for the selected PDCCH monitoring beam.

### BRIEF DESCRIPTION OF DRAWINGS

FIG. 1 is a block diagram for illustrating a functional arrangement of a base station (gNB) according to one embodiment of the present disclosure;

FIG. 2 is a block diagram for illustrating a functional arrangement of a terminal (UE) according to one embodiment of the present disclosure;

FIGS. 3A and 3B each illustrate an exemplary arrangement of radio resources in XDD (Cross Division Duplex) according to one embodiment of the present disclosure;

FIG. 4 is a diagram for illustrating an XDD operation according to one embodiment of the present disclosure:

FIGS. 5A to 5E each illustrate a pure time unit and an XDD time unit according to one embodiment of the present disclosure:

FIG. 6 is a diagram for illustrating a PDCCH monitoring occasion according to one embodiment of the present disclosure;

FIG. 7 is a diagram for illustrating PDCCH overbooking according to one embodiment of the present disclosure:

FIG. 8 is a block diagram for illustrating a PDCCH monitoring beam according to one embodiment of the present disclosure;

FIG. 9 is a block diagram for illustrating an exemplary XDD configuration according to one embodiment of the present disclosure;

FIG. 10 is a diagram for illustrating an exemplary arrangement of XDD radio resources according to one embodiment of the present disclosure;

FIG. 11 is a diagram for illustrating an exemplary XDD configuration according to one embodiment of the present disclosure;

FIG. 12 is a diagram for illustrating an exemplary arrangement of XDD radio resources according to one embodiment of the present disclosure;

FIGS. 13A and 13B illustrate an exemplary configuration and an exemplary arrangement of radio resources for the XDD according to one embodiment of the present disclosure;

FIGS. 14A and 14B illustrate an exemplary configuration and an exemplary arrangement of radio resources for the XDD according to one embodiment of the present disclosure;

FIG. 15 is a diagram for illustrating an exemplary XDD configuration according to one embodiment of the present disclosure;

FIG. 16 is a diagram for illustrating an exemplary arrangement of XDD radio resources according to one embodiment of the present disclosure;

FIGS. 17A and 17B illustrate an exemplary configuration and an exemplary arrangement of radio resources for the XDD according to one embodiment of the present disclosure;

FIGS. 18A and 18B illustrate an exemplary configuration and an exemplary arrangement of radio resources for the XDD according to one embodiment of the present disclosure;

FIG. 19 is a diagram for illustrating an exemplary XDD configuration according to one embodiment of the present disclosure;

FIG. 20 is a diagram for illustrating an exemplary arrangement of XDD radio resources according to one embodiment of the present disclosure;

FIGS. 21A and 21B illustrate an exemplary configuration and an exemplary arrangement of radio resources for the XDD according to one embodiment of the present disclosure;

FIGS. 22A and 22B illustrate an exemplary configuration and an exemplary arrangement of radio resources for the XDD according to one embodiment of the present disclosure;

FIG. 23 is a diagram for illustrating an exemplary XDD configuration according to one embodiment of the present disclosure;

FIG. 24 is a diagram for illustrating an exemplary arrangement of XDD radio resources according to one embodiment of the present disclosure;

FIG. 25 is a diagram for illustrating an exemplary arrangement of XDD radio resources according to one embodiment of the present disclosure;

FIG. 26 is a diagram for illustrating an exemplary arrangement of XDD radio resources according to one embodiment of the present disclosure;

FIG. 27 is a diagram for illustrating an exemplary arrangement of XDD radio resources according to one embodiment of the present disclosure;

FIG. 28 is a diagram for illustrating an exemplary arrangement of XDD radio resources according to one embodiment of the present disclosure;

FIG. 29 is a diagram for illustrating an exemplary arrangement of XDD radio resources according to one embodiment of the present disclosure;

FIG. 30 is a diagram for illustrating an exemplary arrangement of XDD radio resources according to one embodiment of the present disclosure;

FIGS. 31A and 31B each illustrate an exemplary arrangement of XDD radio resources according to one embodiment of the present disclosure;

FIG. 32 is a diagram for illustrating monitoring capabilities of respective releases according to one embodiment of the present disclosure;

FIGS. 33A and 33B each illustrate an exemplary arrangement of XDD radio resources according to one embodiment of the present disclosure;

FIGS. 34A and 34B each illustrate an exemplary arrangement of XDD radio resources according to one embodiment of the present disclosure;

FIG. 35 is a diagram for illustrating a prioritization according to one embodiment of the present disclosure;

FIG. 36 is a diagram for illustrating a prioritization according to one embodiment of the present disclosure;

FIG. 37 is a diagram for illustrating an exemplary arrangement of XDD radio resources according to one embodiment of the present disclosure;

FIG. 38 is a diagram for illustrating a prioritization according to one embodiment of the present disclosure;

FIG. 39 is a diagram for illustrating a prioritization according to one embodiment of the present disclosure;

FIG. 40 is a diagram for illustrating an exemplary arrangement of XDD radio resources according to one embodiment of the present disclosure;

FIG. 41 is a diagram for illustrating a prioritization according to one embodiment of the present disclosure;

FIG. 42 is a diagram for illustrating a prioritization according to one embodiment of the present disclosure;

FIGS. 43A to 43C each illustrate a prioritization according to one embodiment of the present disclosure;

FIGS. 44A to 44C each illustrate a prioritization according to one embodiment of the present disclosure;

FIG. 45 is a diagram for illustrating a prioritization according to one embodiment of the present disclosure;

FIG. 46 is a diagram for illustrating a prioritization according to one embodiment of the present disclosure;

FIG. 47 is a diagram for illustrating a prioritization according to one embodiment of the present disclosure;

FIGS. 48A to 48D each illustrate a prioritization according to one embodiment of the present disclosure;

FIGS. 49A to 49D each illustrate a prioritization according to one embodiment of the present disclosure;

FIGS. 50A to 50D each illustrate a prioritization according to one embodiment of the present disclosure;

FIGS. 51A to 51D each illustrate a prioritization according to one embodiment of the present disclosure;

FIG. 52 is a block diagram for illustrating a hardware arrangement of a base station and a terminal according to one embodiment of the present disclosure; and

FIG. 53 is a block diagram for illustrating a hardware arrangement of a vehicle according to one embodiment of the present disclosure.

### DESCRIPTION OF EMBODIMENTS

Embodiments of the present disclosure are described below with reference to the drawings.

### (Radio Communication System)

In the following, an architecture of a radio communication system according to one embodiment of the present disclosure is described. In this radio communication system, communication is conducted using any or combinations of radio communication methods according to the above embodiments of the present disclosure. The radio communication system may be a system that implements communication using a Long Term Evolution (LTE), a 5^{th} generation mobile communication system New Radio (5G NR), a subsequent radio communication system thereof or the like.

Also, the radio communication system may support dual connectivity among multiple Radio Access Technologies (RATs) (Multi-RAT Dual Connectivity (MR-DC)). The MR-DC may include dual connectivity (E-UTRA-NR Dual Connectivity (EN-DC)) for the LTE (Evolved Universal Terrestrial Radio Access (E-UTRA)) and the NR, dual connectivity for the NR and the LTE (NR-E-UTRA Dual Connectivity (NE-DC)) or the like.

In the EN-DC, abase station (eNB) in the LTE (E-UTRA) is a master node (MN), and a base station (gNB) in the NR is a secondary node (SN). In the NE-DC, a base station (gNB) in the NR is a master node, and a base station (eNB) in the LTE (E-UTRA) is a SN.

The radio communication system may support dual connectivity among multiple base stations within the same RAT (for example, dual connectivity where both the MN and the SN are base stations (gNBs) in the NR (NR-NR Dual Connectivity (NN-DC)).

The radio communication system may include a base station forming a macro cell C1 having a wider coverage and a base station disposed in the macro cell C1 and forming a smaller cell C2 than the macro cell C1. A terminal (UE) may be located within at least one cell. The location, number or the like of respective cells and terminals are not limited to a certain aspect.

A terminal may be connected to at least one of the multiple base stations. The terminal may use at least one of carrier aggregation (CA) using multiple component carriers (CCs) and the dual connectivity (DC).

Each CC may be included in at least one of a first frequency band (Frequency Range 1 (FR1) and a second frequency band (Frequency Range 2 (FR2)). The macro cell C1 may be included in the FR1, and the small cell C2 may be included in the FR2. For example, the FR1 may be a frequency band below 6 GHz (sub-6 GHz), and the FR2 may be a frequency band above 24 GHz (above-24 GHz). Note that the frequency bands, definitions or the like of the FR1 and FR2 are not limited to them, and the FR1 may correspond to a frequency band higher than the FR2, for example.

Also, the terminal may communicate in the respective CCs using at least one of Time Division Duplex (TDD) and Frequency Division Duplex (FDD).

The multiple base stations may be connected in a wired (for example, an optical fiber confirming to Common Public Radio Interface (CPRI), an X2 interface or the like) or wireless (for example, NR communication) manner. For example, the NR communication is used as a backhaul between two base stations, the base station corresponding to an upper station may be referred to as an Integrated Access Backhaul (IAB) donner, and the base station corresponding to a relay station may be referred to as an IAB node.

The base station may be connected via other base stations or to a core network directly. The core network may include at least one of an Evolved Packet Core (EPC), a 5G Core Network (5GCN), a Next Generation Core (NGC) or the like.

The terminal may support at least one of the LTE, the LTE-A, the 5G, the 6G and others.

In the radio communication system, an Orthogonal Frequency Division Multiplexing (OFDM) based radio access scheme may be used. For example, Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA) or the like may be used in at least one of downlink (DL) and uplink (UL).

The radio access scheme may be referred to as waveform. Note that other radio access schemes (for example, other single carrier transmission schemes, other multi-carrier transmission schemes or the like) may be used for UL and DL radio access schemes in the radio communication system.

In the radio communication system, a downlink shared channel (Physical Downlink Shared Channel (PDSCG)), a broadcast channel (Physical Broadcast Channel (PBCH)), a downlink control channel (Physical Downlink Control Channel (PDCCH)) and other shared among terminals may be used as downlink channels.

Also, in the radio communication system, an uplink shared channel (Physical Uplink Shared Channel (PUSCH)), an uplink control channel (Physical Uplink Control Channel (PUCCH)), a random access channel (Physical Random Access Channel (PRACH)) and others shared among terminals may be used as uplink channels.

User data, upper layer control information, a System Information Block (SIB) and others are transmitted in the PDSCH. User data, upper layer control information and others may be transmitted in the PUSCH. Also, a Master Information Block (MIB) may be transmitted in the PBCH.

Lower layer control information may be transmitted in the PDCCH. The lower layer control information may include downlink control information (DCI) including scheduling information for at least one of the PDSCH and the PUSCH, for example.

Note that the DCI for scheduling the PDSCH may be referred to as a DL assignment, DL DCI or the like, and the DCI for scheduling the PUSCH may be referred to as an UL grant, UL DCI or the like. Note that the PDSCH may be interchangeably referred to as DL data, and the PUSCH may be interchangeably referred to as UL data.

A control resource set (CORESET) and a search space may be used to detect the PDCCH. The CORESET corresponds to a resource for searching for the DCI. The search space corresponds to a search area and a search method for a PDCCH candidate. One CORESET may be associated with one or more search spaces. A UE may monitor for the CORESET associated with a certain search space based on a search space configuration.

One search space may correspond to a PDCCH candidate relevant to one or more aggregation levels. One or more search spaces may be referred to as a search space (SS) set. Note that “search space”, “search space set”, “search space configuration”, “search space set configuration”, “CORESET”, “CORESET configuration” or the like of the present disclosure may be interchangeably referred to as each other.

Uplink control information (UCI) including at least one of channel state information (CSI), acknowledgement information (referred to as Hybrid Automatic Repeat request ACKnowledgement (HARQ-ACK), ACK/NACK or the like, for example) and a scheduling request (SR) may be transmitted in the PUCCH. A random access preamble for connection establishment to a cell may be transmitted in the PRACH.

Note that various channels may be represented without adding the wording “Physical” at the header

In the radio communication system, a synchronization signal (SS), a downlink reference signal (DL-RS) and others may be transmitted. In the radio communication system, a cell-specific reference signal CRS), a channel state information reference signal (CSIU-RS), a demodulation reference signal (DMRS), a positioning reference signal (PRS), a phase tracking reference signal (PTRS) and others may be transmitted as the DL-RS.

For example, the synchronization signal may be at least one of a primary synchronization signal (PSS) and a secondary synchronization signal (SSS). A signal block including the SS (the PSS and the SSS) and the PBCH (and the DMRS for the PBCH) may be referred to as a SS/PBCH block, a SS block (SSB) or the like. Note that the SS, the SSB or the like may be also referred to as a reference signal.

Also, in the radio communication system, a sounding reference signal (SRS), a demodulation reference signal (DMRS) and others may be transmitted as an uplink reference signal (UL-RS). Note that the DMRS may be referred to as a UE-specific reference signal.

### (Device Arrangement)

Next, exemplary functional arrangements of a base station (gNB) and a terminal (UE) 200 that perform processes and operations as stated below are described. The gNB 100 and the UE 200 include functionalities for implementing the embodiments as stated below. Note that each of the gNB 100 and the UE 200 may include only a portion of the functionalities of the embodiments.

(gNB 100)

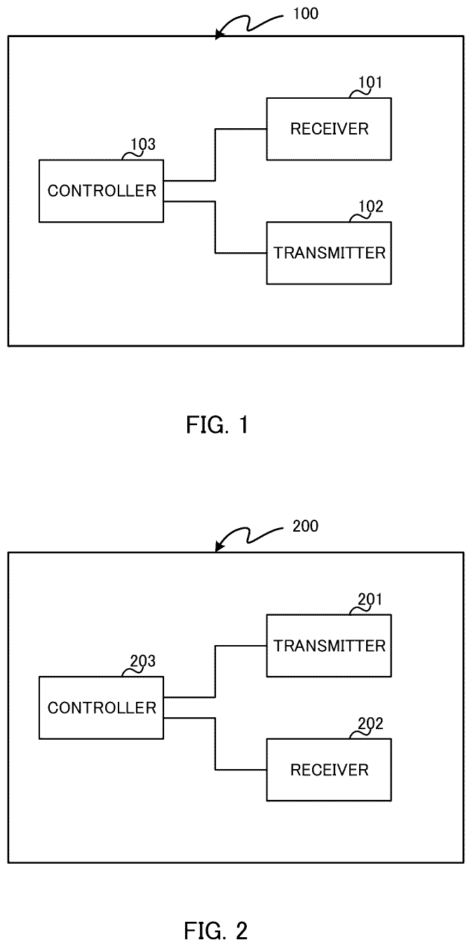

FIG. 1 is a diagram for one exemplary functional arrangement of the gNB 100. As illustrated in FIG. 1, the gNB 100 includes a receiver 101, a transmitter 102 and a controller 103. The functional arrangement as illustrated in FIG. 1 is merely one example. If operations associated with embodiments of the present invention can be practiced, separation of functionalities and names of the functional units are arbitrary.

The receiver 101 include a functionality of receiving various signals transmitted from the UE 200 and acquiring upper layer information from the received information, for example. The transmitter 102 includes a functionality of generating signals for transmission to the UE 200 and transmitting the signals in a wired or wireless manner.

The controller 103 stores preset configuration information and various configuration information for transmission to the UE 200 in a memory device and reads them from the memory device if necessary. Also, the controller 103 performs operations associated with communication with the UE 200. The functional unit regarding signal transmission at the controller 103 may be included in the transmitter 102, and the functional unit regarding signal reception at the controller 103 may be included in the receiver 101.

### (UE 200)

FIG. 2 is a diagram for illustrating one exemplary functional arrangement of the UE 200. The UE 200 includes a transmitter 201, a receiver 202 and a controller 203. The functional arrangement as illustrated in FIG. 2 is merely one example. If operations associated with embodiments of the present invention can be practiced, separation of functionalities and names of the functional units are arbitrary.

The transmitter 201 generates a transmission signal from transmission data and transmits the transmission signal in a wireless manner. The receiver 202 receives various signals wirelessly and acquires upper layer signals from the received physical layer signals. Also, the receiver 202 has a functionality of receiving a NR-PSS, a NR-SSS, a NR-PBCH, a DL/UL control signal a reference signal or the like transmitted from the gNB 100.

The controller 203 stores various configuration information received at the receiver 202 from the gNB 100 in a memory device and reads them from the memory device if necessary. Also, the controller 203 performs operations associated with communication with the gNB 100. The functional unit regarding signal transmission at the controller 203 may be included in the transmitter 201, and the functional unit regarding signal reception at the controller 203 may be included in the receiver 202.

### (XDD Operation)

Taking into account a time ratio of transmission and reception (for example, DL:UL=4:1) in time division duplex (TDD) until Rel. 16, some cases of transmission occasions of UL signals/channels being smaller than reception occasions of DL signals/channels may be considered. In these cases, the UE cannot transmit UL signals/channels frequently, and transmission delay of important UL signals/channels may arise. Also, since the UL transmission occasions are smaller than the DL reception occasions, signals/channels may be congested in the UL transmission occasions. In addition, since the UL signals/channels can be transmitted in a limited amount of time resources in the TDD, UL coverage enhancement technique with repetition may be also limitedly applied.

For future radio communication systems (for example, Rel. 17/18 and subsequent ones), it is discussed that a division duplex scheme where the TDD and frequency division duplex (FDD) are combined for UL and DL will be introduced.

The division duplex scheme may be referred to as XDD (Cross Division Duplex) or subband non-overlapping full duplex. The XDD or the subband non-overlapping full duplex may mean a duplex scheme where DL and UL are duplexed in a frequency division manner in one component carrier (CC) in a TDD band (the DL and the UL are simultaneously available).

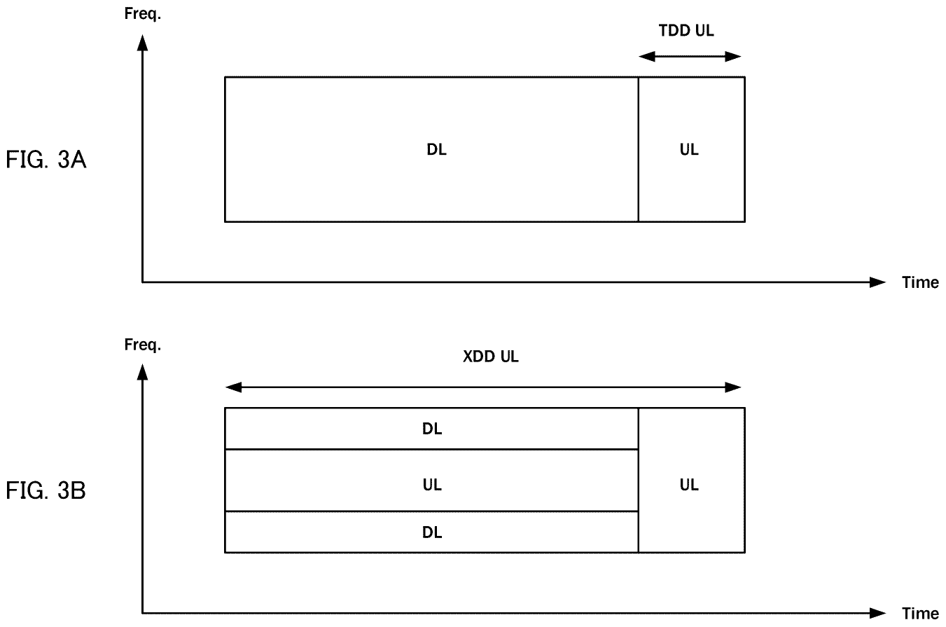

FIG. 3A is a diagram for illustrating one exemplary TDD configuration provided until Rel. 16. In the example as illustrated in FIG. 3A, a TDD slot or symbol is configured for the UE in a bandwidth such as one component carrier (CC)(which may be referred to as a cell or a serving cell) or a bandwidth part (BWP).

In the example as illustrated in FIG. 3A, the time ratio of DL slots and UL slots is 4:1. In such a conventional slot or symbol configuration in the TDD, a sufficient amount of UL time resources cannot be reserved, which may lead to UL transmission delay and reduce coverage performance.

FIG. 3B is a diagram for illustrating one exemplary XDD configuration. In the example as illustrated in FIG. 3B, there is an overlap in time between resources used for DL reception and resources used for UL transmission in one component carrier (CC). According to such a resource configuration, a larger amount of UL resources can be reserved, which can improve utilization efficiency of the resources.

For example, as illustrated in FIG. 3B, both ends in a frequency area may be configured for DL resources, and UL resources may be configured to be sandwiched between these DL resources. As a result, occurrence of cross link interference (CLI) with adjacent carriers can be avoided and reduced. Also, a guard area may be configured at the boundary between the DL resources and the UL resources.

Taking operational complexity of self-interference into account, it may be considered that only base stations use DL resources and UL resources simultaneously. In other words, for radio resources where DL and UL overlap temporally, a certain UE may use a DL resources, and another UE may use an UL resource.

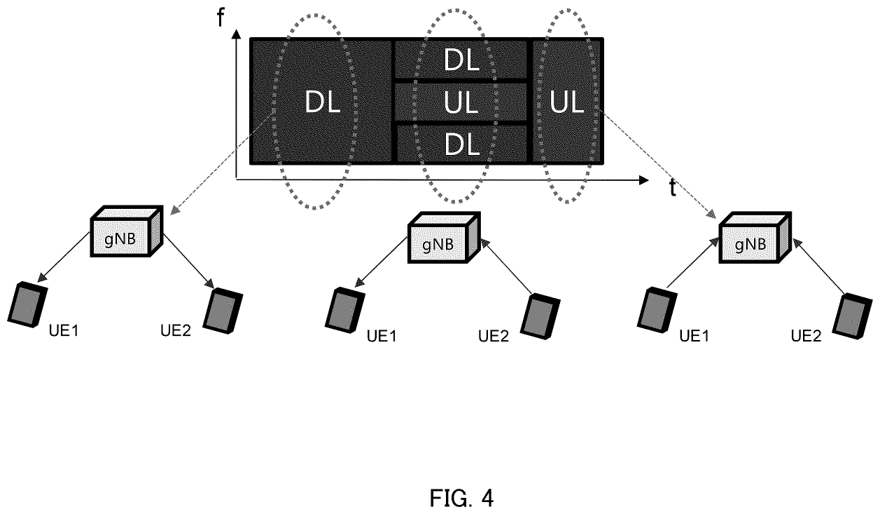

FIG. 4 is a diagram for illustrating one exemplary XDD operation. In the example as illustrated in FIG. 4, a portion of DL resources in a TDD band is configured for UL resources, and the DL and the UL are arranged to partially overlap with respect to the temporal domain.

In the example as illustrated in FIG. 4, each of multiple UEs (UE #1 and UE #2 in FIG. 4) receives a DL channel/signal in a DL exclusive period.

Also, in period where there is temporal overlapping between DL and UL, a certain UE (UE #1 in the example of FIG. 4) receives a DL channel/signal, and another UE (UE #2 in the example of FIG. 4) transmits an UL channel/signal. A base station performs simultaneous transmission and reception of DL and UL in this period.

Also, each of multiple UEs (UE #1 and UE #2 in FIG. 4) transmits an UL channel/signal in an UL exclusive period.

In the existing NR (defined until Rel. 15/16, for example), each of a DL frequency resource and an UL frequency resource in a carrier for UEs is configured as a DL BWP and an UL BWP. A mechanism for configuration for multiple BWPs and BWP adaptation is needed to switch the DL/UL frequency resource into another DL/UL frequency resource.

Also, in the existing NR, a time resource in a TDD carrier for UEs is configured as at least one of DL, UL and flexible (FR) in the TDD configuration.

An XDD symbol may be a symbol that is indicated or configured as UL (or DL) or is indicated or configured for UL transmission (or DL reception) in certain frequency resources, whereas the XDD symbol may be a symbol that is indicated or configured as DL (or UL) or is indicated or configured for DL reception (or UL transmission) in other frequency resources. Alternatively, an XDD symbol may be a symbol that is indicated or configured as UL (or DL) or is indicated or configured for UL transmission (or DL reception) in a portion of certain frequency resources, whereas the XDD symbol may be a symbol that is indicated or configured as DL (or UL) or is indicated or configured for DL reception (or UL transmission) in a portion of other frequency resources.

A time unit herein may be a symbol level, a slot/subslot level, or a group of symbols/slots/subslots. Namely, an XDD time unit may be an XDD symbol, a slot/subslot including or overlapping with the XDD symbol, or a group of symbols/slots/subslots including or overlapping with the XDD symbol.

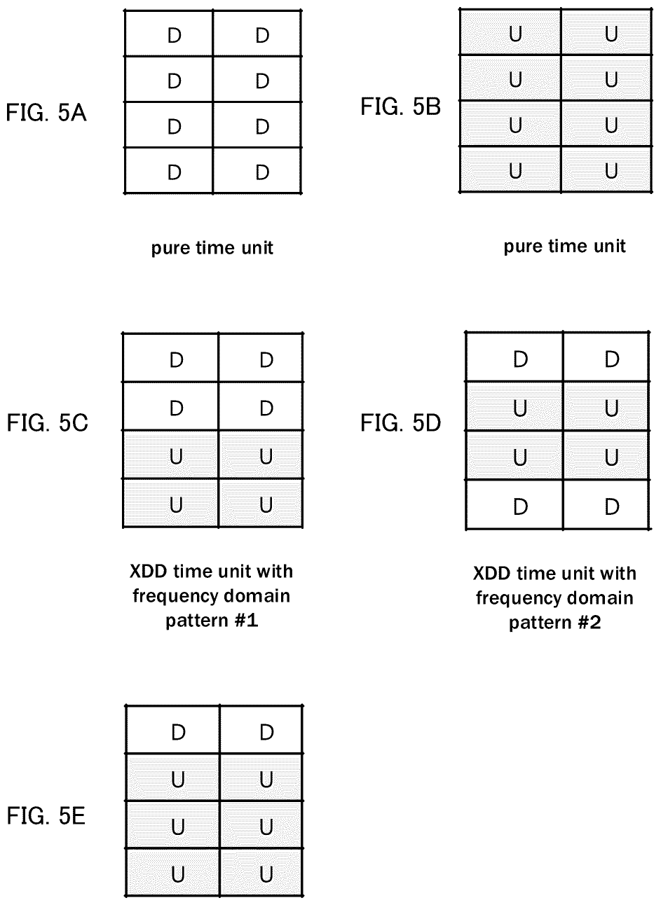

A pure time unit may be a non-XDD symbol (that is, a symbol that is not an XDD symbol), a slot/subslot including or overlapping with no XDD symbol, or a group of symbols/slots/subslots including or overlapping with no XDD symbol, and may be referred to as a non XDD time unit. For example, the pure time unit may be referred to as a time unit consisting of only DL in a frequency resource as illustrated in FIG. 5A or may be referred to as a time unit consisting of only UL in the frequency resource as illustrated in FIG. 5B.

Also, DL resources and UL resources may have various arrangement patterns in a frequency domain with respect to the XDD time unit. For example, the XDD time unit for frequency domain pattern #1 may have an arrangement pattern as illustrated in FIG. 5C. Also, the XDD time unit for frequency domain pattern #2 may have an arrangement pattern as illustrated in FIG. 5D. Also, the XDD time unit for frequency domain pattern #3 may have an arrangement pattern as illustrated in FIG. 5E. These arrangement patterns are merely illustrative, and the XDD time unit may have other arrangement patterns. The frequency domain pattern in the XDD time unit may mean a resource repetition pattern in the frequency domain for the XDD time unit.

### (PDCCH Monitoring)

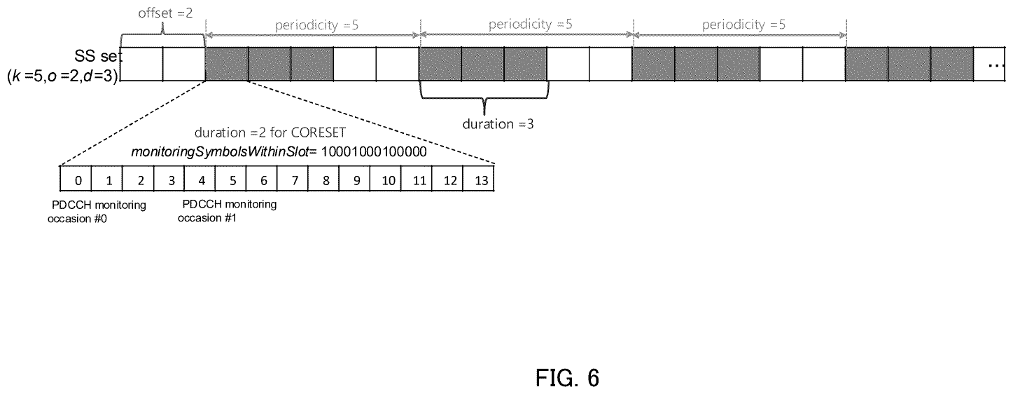

In Rel. 15/16, a UE performs blind decoding (BD) for a set of PDCCH (Physical Downlink Control Channel) candidates for a configured search space (SS) set. Specifically, the UE determines a PDCCH monitoring occasion on an active DL BWP from a PDCCH monitoring cycle, a PDCCH monitoring offset and a PDCCH monitoring pattern in a slot. For example, for PDCCH monitoring cycle k=5, PDCCH monitoring offset o=2 and PDCCH monitoring pattern (duration) d=3, the UE monitors for a PDCCH candidate in a slot of a search space (SS) set as illustrated in FIG. 6.

Specifically, for each to-be-monitored slot, the UE monitors the PDCCH candidate in the PDCCH monitoring occasion as illustrated in FIG. 6. In the illustrated example, if the duration of CORESET is 2 and monitoringSymbolsWithinSlot=10001000100000, the UE monitors the PDCCH candidate at PDCCH monitoring occasion #0 corresponding to the “0”th and “1”th symbols and PDCCH monitoring occasion #1 corresponding to the “4”th and “5”th symbols.

### (PDCCH Monitoring Capability)

Also, a PDCCH monitoring capability can be indicated or configured for each slot in Rel-15, each span in Rel-16 and multiple slots in Rel-17. For the PDCCH monitoring capability per slot in Rel-15, overbooking for configuring the number of PDCCH candidates and/or the number of control channel elements (CCEs) exceeding the UE capability is only allowed on a primary cell (Pcell) or a primary secondary cell (PScell). For the PDCCH monitoring capability per span in Rel-16, the overbooking is only allowed in a first span of a slot on a Pcell/PScell. For the PDCCH monitoring capability for multiple slots in Rel-17, the overbooking is only allowed on a Pcell/PScell.

Also, for a common search space (CSS), the overbooking is not allowed. In other words, a network guarantees that the number of non-overlap CCEs and the number of PDCCH candidates for the CSS in a slot, a span or a group of X slots is smaller than or equal to limits of blind decoding (BD) or control channel elements (CCEs).

Meanwhile, for a UE specific search space (USS), the overbooking is allowed based on USS indices. Specifically, the USS having a smaller search space (SS) index may have a higher priority. Namely, the USS having a larger SS index may be dropped until the number of PDCCH candidates and the number of non-overlap CCEs for the CSS in a slot, a span of a group of X slots become the limits of blind decoding (BD) or control channel elements (CCEs).

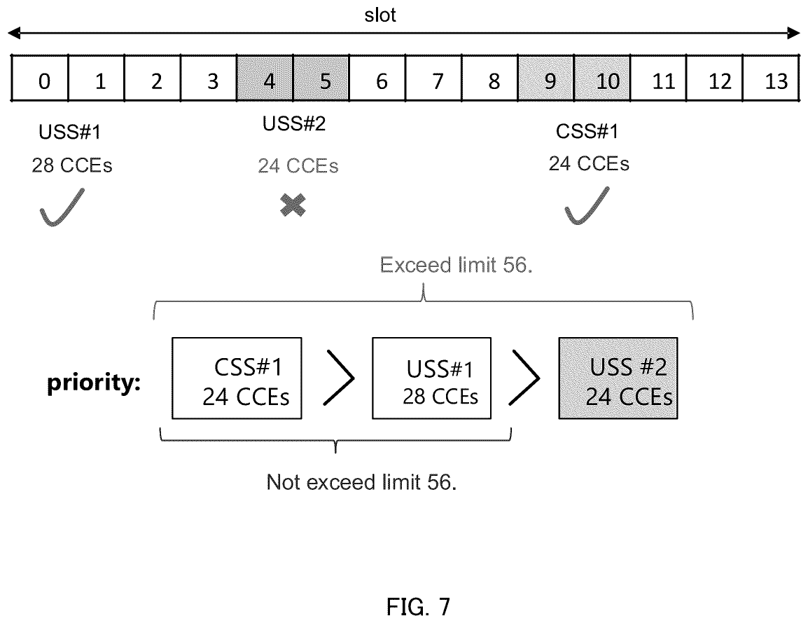

For example, as illustrated in FIG. 7, USS #1 having 28 CCEs, USS #2 having 24 CCEs and CSS #1 having 24 CCEs are in a slot, and if the limit is equal to 56, the PDCCH candidate is monitored for only the CSS #1 and the USS #1 that have higher priorities and do not exceed the limit of 56.

### (PDCCH Monitoring Beam)

For an overlapping PDCCH monitoring occasion, if a TCI (Transmission Configuration Indication) state or a beam is configured in CORESET, a UE monitors a PDCCH candidate having the same TCI state that is included in or overlaps with the PDCCH monitoring occasion. Also, the TCI state is determined by a SS having the highest priority. Here, the CSS has a higher priority that the USS, the SS having a smaller cell index has a higher priority that the SS having a larger cell index, and the SS having a smaller SS index has a higher priority than the SS having a larger SS index.

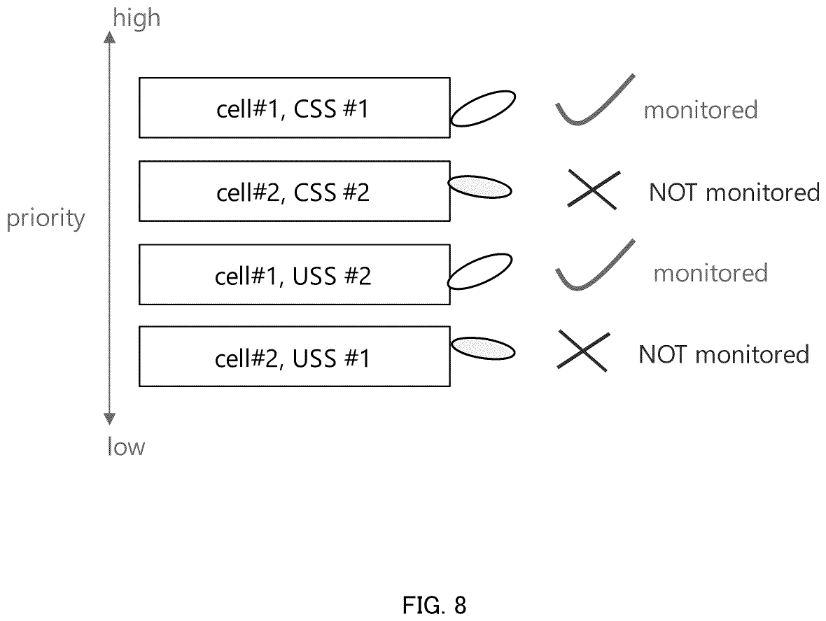

According to the above-stated prioritization, for example, the SS for the CSS #1 in cell #1, the SS for the CSS #2 in cell #2, the SS for the USS #2 in cell #1 and the SS for the USS #1 in cell #2 are prioritized as illustrated in FIG. 8, and the PDCCH candidate is monitored for the SS for the CSS #1 in cell #1 and the SS for the USS #2 in cell #1.

### First Embodiment

No specific limitation to the XDD operation is presently discussed. For example, the XDD operation may not be supported to a certain cell.

In Embodiment 1, a cell or a time resource where the XDD operation can be configured is limited. A UE may not envisage that a Pcell/PScell is indicated or configured for the XDD operation. Also, the UE may not envisage that any cell in a primary/secondary cell group is indicated, configured or applied to the XDD operation. Alternatively, the UE may not envisage that any BWP or cell where a search space (SS) set and/or a CORESET configuration is configured is indicated or configured for the XDD operation. Alternatively, the UE may not envisage that even if the XDD operation is indicated or configured, any BWP or cell where a certain type of SS set and/or a certain type of CORESET configuration is configured is indicated or configured as UL (or DL) in a portion of a frequency resource or is indicated or configured for UL transmission (or DL reception).

Here, the certain type of SS set may be any of:
i) Type0-PDCCH CSS set configured by pdcch-ConfigSIBI in a MIB (Master Information Block), searchSpaceSIB1 in a PDCCH-ConfigCommon and/or searchSpaceZero in a PDCCH-ConfigCommon;
ii) Type0A-PDCCH CSS set configured by a searchSpaceOtherSysyemInformation in a PDCCH-ConfigCommon;
iii) Type1-PDCCH CSS set configured by a ra-SearchSpace in a PDCCH-ConfigCommon;
iv) Type2-PDCCH CSS set configured by a pagingSearchSpace in a PDCCH-ConfigCommon; and
v) USS set configured by a SearchSpace in a PDCCH-Config having searchSpaceType=ue-Specific.

Also, the UE may not envisage that any BWP or cell where a PUCCH resource/transmission is configured is indicated, configured or applied for the XDD operation. Alternatively, the UE may not envisage that any BWP or cell in FR 2-2 is indicated or configured as UL (or DL) or for the XDD operation. Alternatively, the UE may not envisage that any BWP or cell where a SCS (Subcarrier Spacing) value larger than a certain value (for example, the SCS value of 60, 120, 480 or 960 kHz) is indicated or configured for the XDD operation.

In light of these envisions, in the first embodiment, if one or more conditions as stated below is satisfied, the XDD operation may be indicated or configured for a BWP or a cell.

Specifically, the XDD operation may be indicated or configured for a BWP as follows. For example, a certain time unit in the BWP may be indicated or configured as UL (or DL) in a portion of a frequency resource. Alternatively, the certain time unit may be indicated or configured for UL transmission (or DL reception) but may be indicated or configured for DL (or UL) in another frequency resource. Alternatively, the time resource may be indicated or configured for DL reception (or UL transmission). The time unit herein may be a symbol, a slot, a subslot or a group of symbols, slot or subslots. Namely, the XDD operation may be indicated or configured for the BWP in unit of frequency resource for a certain time unit.

As another example, a time unit on a BWP may be indicated or configured for a certain UE as UL (or DL) or for UL transmission (or DL reception) whereas it may be indicated or configured for another UE as DL (or UL) or for DL reception (or UL transmission). In other words, the XDD operation may be indicated or configured for such a time unit per UE.

As another example, a time unit on a BWP may indicated or configured as UL (or DL) or for UL transmission (or DL reception) on a portion of frequency resources, and this portion of frequency resources may be indicated or configured as being unavailable for UL (or DL) for a new slot format configuration/indication or a new rate match pattern configuration/indication. In other words, the XDD operation may be indicated or configured for a time unit in the BWP by using the new slot format configuration/indication or the new rate match pattern configuration/indication.

Also, the XDD operation may be indicated or configured to a cell in a manner below. For example, the XDD operation may be indicated or configured to any cell or an active BWP. As another example, multiple BWPs for the XDD operation may be indicated or configured to the cell.

In this manner, according to the first embodiment, a UE may receive an indication or a configuration regarding the XDD operation to radio resources and control uplink transmission or downlink reception in the radio resources in accordance with the indication or the configuration regarding the XDD operation. Correspondingly, a base station may transmit an indication or a configuration regarding the XDD operation to the radio resources and control uplink transmission or downlink reception in the radio resources in accordance with the indication or the configuration regarding the XDD operation.

Specifically, the UE may receive an indication or a configuration regarding the XDD operation per frequency resource for a time unit on a BWP. Correspondingly, the base station may transmit an indication or a configuration regarding the XDD operation per frequency resource to the time unit on the BWP. Here, the indication or the configuration regarding the XDD operation per frequency resource may indicate or configure a portion of frequency resources on the BWP for uplink transmission or downlink reception and indicate or configure other frequency resources on the BWP for downlink reception or uplink transmission. Also, the portion of frequency resources may be indicated or configured as being available or unavailable as uplink transmission or downlink reception by a slot format configuration or indication or by a rate match pattern configuration or indication.

Also, the UE may receive an indication or a configuration regarding the XDD operation per terminal to a time unit on a BWP. Correspondingly, a base station may transmit an indication or a configuration regarding the XDD operation per terminal to the time unit on the BWP. Here, the indication or the configuration regarding the XDD operation per terminal may indicate or configure the time unit as uplink transmission or downlink reception to a certain terminal and indicate or configure the time unit as downlink reception or uplink transmission to other terminals.

Also, the UE may receive an indication or a configuration indicative of a BWP for a cell where the XDD operation is configured or a BWP for the XDD operation for a cell. Correspondingly, the base station may transmit an indication or a configuration indicative of a BWP for a cell where the XDD operation is configured or a BWP for the XDD operation for a cell.

The above-stated indication or configuration may be transmitted as at least one of a RRC (Radio Resource Control) information element, DCI (Downlink Control Information) and a MAC CE (Medium Access Control Control Element).

Also, in order to implement the above-stated XDD operation, a UE may transmit UE capability information regarding the XDD operation to a base station, and the base station may indicate or configure the XDD operation to the UE based on the received UE capability information. Specifically, the UE capability information as to whether to support the XDD operation applied to a Pcell/PScell is defined, and a UE may transmit the UE capability information as to whether to support the XDD operation applied to a Pcell/PScell to the base station.

Also, the UE capability information as to whether support the XDD operation applied to a cell in a primary/secondary cell group is defined, and a UE may transmit the UE capability information as to whether to support the XDD operation applied to a cell in a primary/secondary cell group to the base station.

Also, the UE capability information as to whether to support the XDD operation applied to a cell/BWP where a (certain SS set type of) SS set is configured is defined and the UE may transmit the UE capability information as to whether to support the XDD operation applied to the cell/BWP where a (certain SS set type of) SS set is configured to the base station.

Also, the UE capability information as to whether to support the XDD operation applied to a cell/BWP where a PUCCH resource/transmission is configured is defined, and a UE may transmit the UE capability information as to whether to support the XDD operation applied to the cell/BWP where the PUCCH resource/transmission is configured to the base station.

Also, the UE capability information as to whether to support the XDD operation applied to a cell/BWP in FR 2-2 is defined, and a UE may transmit the UE capability information as to whether to support the XDD operation applied to the cell/BWP in FR 2-2 to the base station.

Also, the UE capability information as to whether to support the XDD operation applied to a cell/BWP where a SCS larger than a certain value is configured is defined, and a UE may transmit the UE capability information as to whether to support the XDD operation applied to the cell/BWP where the SCS larger than a certain value is configured to the base station.

According to the first embodiment, cells or time resources where the XDD operation can be configured can be limited.

### Second Embodiment

At present, there is no discussion on a search space (SS) set and/or a CORESET configuration in cases of the XDD operation being indicated, configured or applied to a BWP or cell where PDCCH monitoring is configured. Accordingly, a UE operation must be defined to the SS set and/or the CORESET configuration in the cases of the XDD operation being indicated, configured or applied to the BWP/cell where the PDCCH monitoring is configured. In the second embodiment, if the XDD operation can be configured to a PDCCH monitoring resource, a UE may perform the PDCCH monitoring as stated below.

In Option 1 in the second embodiment, an existing configuration may be used for the SS set configuration or the CORESET configuration in cases of the XDD operation being indicated, configured or applied to a BWP/cell where the PDCCH monitoring is configured. In other words, no enhancement may be made to the SS set configuration or the CORESET configuration even in the cases of the XDD operation being indicated, configured or applied to the BWP or cell where the PDCCH monitoring is configured.

On the other hand, it is noted that even in the cases where the SS set configuration or the CORESET configuration is not enhanced in this manner, when the XDD operation is indicated, configured or applied to the BWP or cell where the PDCCH monitoring is configured, the PDCCH monitoring operation by a UE must be enhanced as stated below in conjunction with the subsequent third embodiment.

In Option 2 in the second embodiment, different SS set configurations may be configured to a pure time unit and an XDD time unit. In other words, respective search space sets may be configured to a normal TDD operation and an XDD operation. Here, the time unit may be a symbol level, a slot/subslot level or a group of symbols/slots/subslots. Also, the XDD time unit may be an XDD symbol, a slot/subslot including or overlapping with an XDD symbol, or a group of symbols/slots/subslots including or overlapping with an XDD symbol. The pure time unit may be a non-XDD symbol, that is, a symbol that is not an XDD symbol, or a slot/subslot or a group of symbols/slots/subslots that do not include or overlap with an XDD symbol.

For example, searchSpacesToAddmodList may be used in an SS set configuration for pure time unit (which may be referred to as a non-XDD SS set), and a new information element (IE) such as searchSpacesToAddModListForXDD may be used in an SS set configuration for XDD time unit (which may be referred to as an XDD SS set).

If searchSpacesToAddModList is used in the SS set configuration for the pure time unit, the maximum number N of SS sets configured for the pure time unit in PDCCH-Config may be equal to a predetermined number such as ten (for example, N=10) or smaller than or larger than the predetermined number such as ten (for example, N<10 or N>10).

Also, if a new IE such as searchSpacesToAddModListForXDD is used in the SS set configuration for the XDD time unit, the maximum number M of SS sets configured for the XDD time unit in PDCCH-Config may be equal to a predetermined number such as ten (for example, M=10) or smaller than or larger than the predetermined number such as ten (for example, M<10 or M>10). Also, the M may, without limited to it, be equal to (10−N).

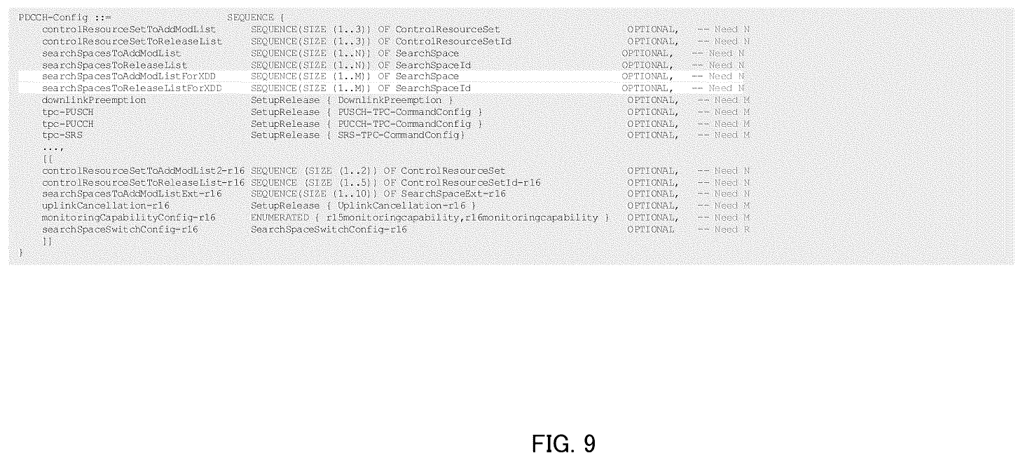

For example, two LEs searchSpacesToAddModList and searchSpacesToAddModListForXDD may be configured in PDCCH-Config, as illustrated in FIG. 9. Similarly, two IEs searchSpacesToReleaseList and searchSpacesToReleaseListForXDD may be also configured.

For each SS set, a UE may determine a PDCCH monitoring occasion similar to Rel-15/16.

Then, for the PDCCH monitoring occasion in non-XDD SS set, as one example, a UE may not envisage that any PDCCH monitoring occasion in non-XDD SS set is included in or overlap with an XDD time unit or an XDD symbol. Alternatively, as another example, if the PDCCH monitoring occasion in the XDD SS set is included in or overlaps with an XDD time unit or an XDD symbol, a UE may not monitor a PDCCH candidate in the PDCCH monitoring occasion included in or overlapping with the XDD time unit or the XDD symbol. On the other hand, if the PDCCH monitoring occasion in the XDD SS set is not included in or does not overlap with the XDD time unit or the XDD symbol, the UE may monitor a PDCCH candidate in the PDCCH monitoring occasion in the same manner as Rel-15/16.

Meanwhile, the PDCCH monitoring occasion in the XDD SS set, as one example, a UE may not envisage that any PDCCH monitoring occasion in the XDD SS set is included in or overlaps with the pure time unit. Alternatively, as another example, if the ODCCH monitoring occasion is included in or overlaps with the pure time unit or the non-XDD symbol, the UE may not monitor a PDCCH candidate in the PDCCH monitoring occasion included in or overlapping with the pure time unit or the non-XDD symbol. On the other hand, if the PDCCH monitoring occasion is not included in or does not overlap with the pure time unit or the non-XDD symbol, the UE may monitor a PDCCH candidate in the PDCCH monitoring occasion.

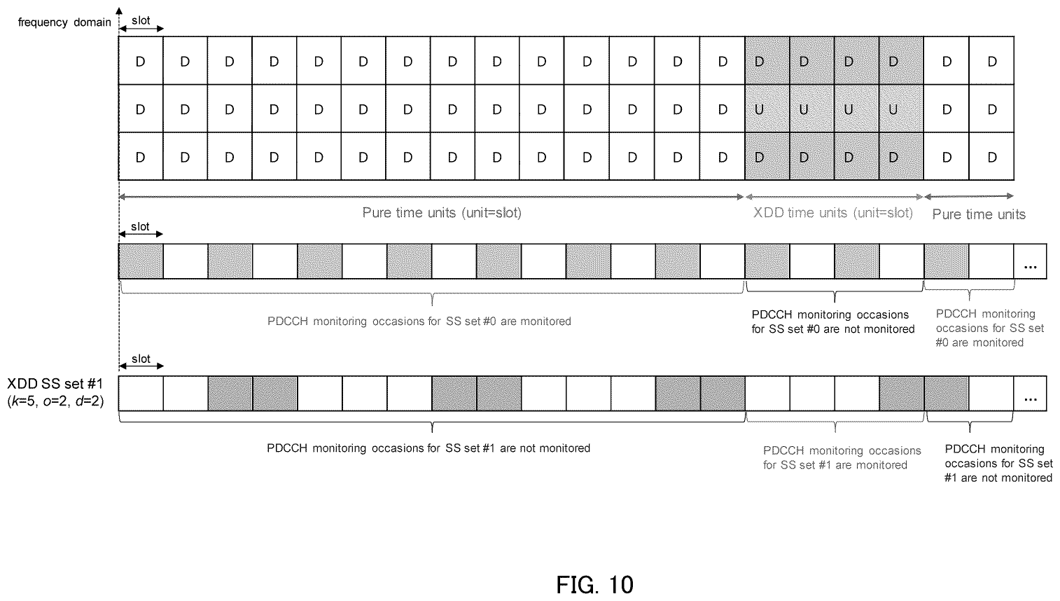

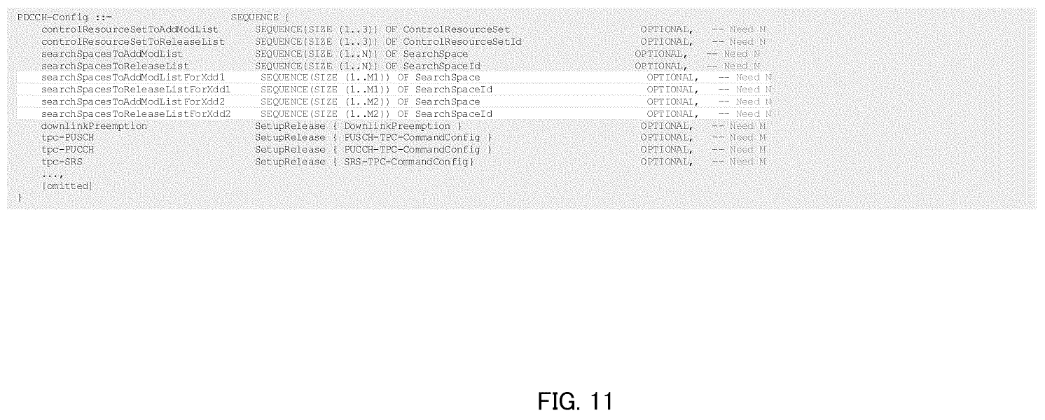

According to the PDCCH monitoring occasion in the non-XDD SS set and the XDD SS set as stated above, a UE monitors the PDCCH candidate in accordance with the non-XDD SS set in the pure time unit and in accordance with the XDD SS set in the XDD time unit in an exemplary arrangement of the pure time units and the XDD time units as illustrated in FIG. 10. Specifically, the UE monitors the PDCCH candidate in the 0th, 2nd, 4th, 6th, 8th, 10th, 12th, 17th and 18th slots.

As one exemplary variation, the XDD SS set may be configured for only a certain SS type. For example, the certain SS type may be Type0-PDCCH CSS set, Type0A-PDCCH CSS set, Type1-PDCCH CSS set, Type2-PDCCH CSS set, Type3-PDCCH CSS set and/or USS set.

Alternatively, as another exemplary variation, the XDD SS set may be configured for only a certain DCI (Downlink Control Information) format. For example, the certain DC format may be DCI 0_0/1_0, DCI 2_0, DCI 2_1, DCI 2_2, DCI 2_3, DCI 0_1/1_1, DCI 2_5, DCI 3_0, DCI 3_1 and/or DC 0_2/1_2.

Also, as one exemplary variation, if several frequency domain patterns are provided for the XDD time unit, a UE may apply the same SS set configuration for arbitrary XDD time units regardless of frequency domain patterns.

Alternatively, as another exemplary variation, if several frequency domain patterns are provided for the XDD time unit, a UE may apply different SS set configurations for the XDD time unit having different frequency domain patterns. For example, in addition to the existing searchSpacesToAddModList, additional X or less SS set configurations may be configured in the PDCCH-Config. Here, the X value may be configured as being smaller than or equal to the number of frequency domain patterns for the configured XDD time unit. Also, the X value may be specified in accordance with specifications or configured in an RRC configuration.

Also, for the PDCCH monitoring occasion in the SS set where frequency domain pattern type #i is configured for an XDD time unit, a UE may not envisage that any of the PDCCH monitoring occasions in the SS set where frequency domain pattern type #i is configured for an XDD time unit is included in or overlap with the XDD time unit having the pure time unit or other frequency domain pattern types. Also, if the PDCCH monitoring occasion in the SS set where frequency domain pattern type #i is configured for the XDD time unit is included in or overlaps with the XDD time unit having the pure time unit or other frequency domain pattern types, the UE may monitor the PDCCH candidate in the PDCCH monitoring occasion included in or overlapping with the XDD time unit having the pure time unit or other frequency domain pattern types.

For example, if two additional SS set configurations are configured, four IEs of searchSpacesToAddModListForXdd1, searchSpacesToReleaseListForXdd1, searchSpacesToAddModListForXdd2 and searchSpacesToReleaseListForXdd2 may be configured in the PDCCH-Config.

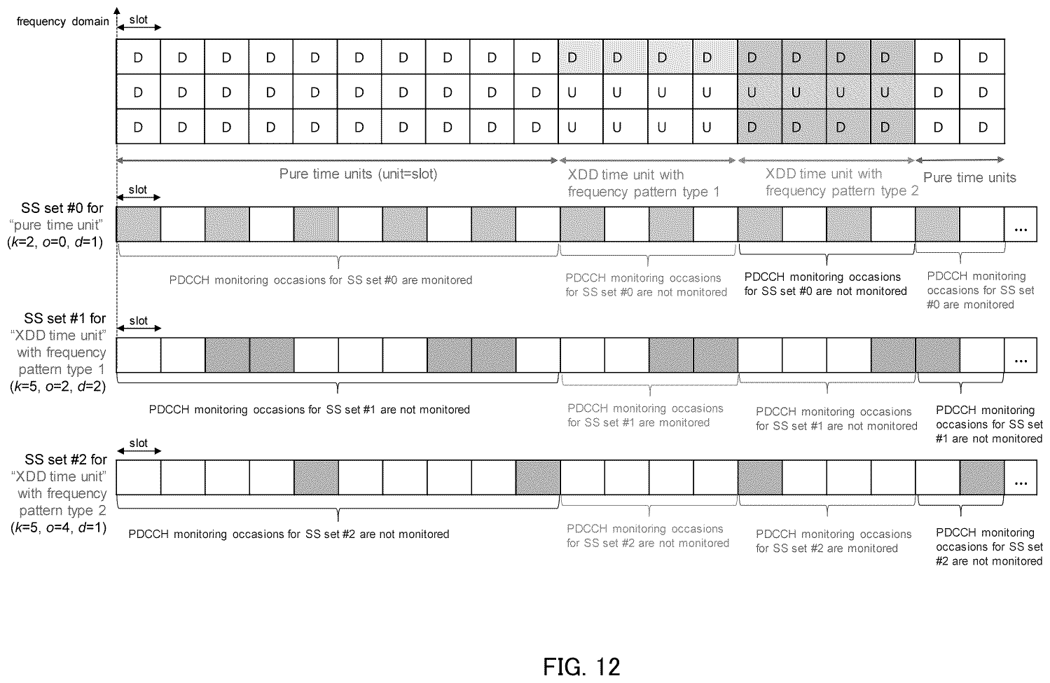

According to the PDCCH monitoring occasion in the non-XDD SS set and the XDD SS set as stated above, in the exemplary arrangement of the pure time units and the XDD time units as illustrated in FIG. 12, a UE monitors the PDCCH candidates in the pure time unit in accordance with the SS set #0 for the pure time unit, in the XDD time unit for frequency domain pattern type 1 in accordance with the XDD SS set #1 for frequency domain pattern type 1, and in the XDD time unit for frequency domain pattern type 2 in accordance with XDD SS set #2 for frequency domain pattern type 2. Specifically, the UE monitors the PDCCH candidates in the 0th, 2nd, 4th, 6th, 8th, 12th, 13th, 14th and 18th slots.

In Option 3 in the second embodiment, multiple controlRespourceSetIds may be configured for an SS set configuration. In other words, multiple CORESETs can be configured. Here, the controlResourceSetId is an IE for identifying the CORESET.

As Option 3-1, association of different CORESETs with the pure time unit and the XDD time unit may be applied. In other words, the respective CORESETs may be configured for the normal TDD operation and the XDD operation. Specifically, an existing controlResourceSetId may be configured for the pure time unit, and a new ControlResourceSetIdForXdd may be configured for the XDD time unit.

For respective monitoring start positions for an SS set, if the monitoring start position is included in or overlaps with the pure time unit, the existing controlResourceSetId may be used to determine the corresponding PDCCH monitoring occasion and PDCCH candidate. On the other hand, if the monitoring start position is included in or overlaps with the XDD time unit, the new controlResourceSetIdForXdd may be used to determine the corresponding PDCCH monitoring occasion and PDCCH candidate.

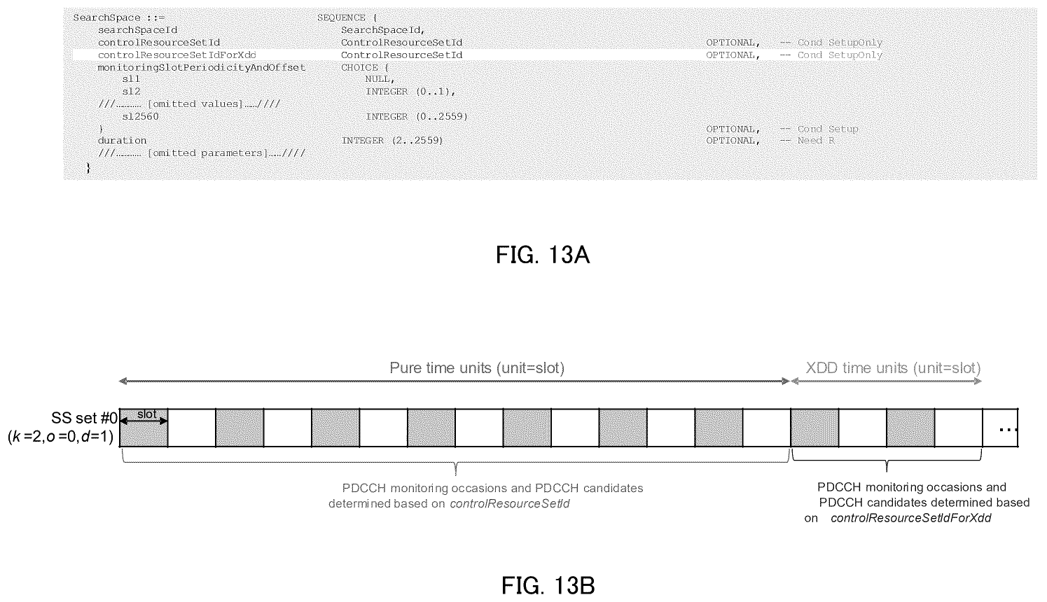

For example, the two IEs controlResourceSetId for the pure time unit and ControlResourceSetIdForXdd for the XDD time unit may be configured in a SearchSpace configuration as illustrated in FIG. 13A.

Also, as illustrated in FIG. 13B, a UE may determine the PDCCH monitoring occasion and the PDCCH candidate in the pure time unit in accordance with controlResourceSetId and determine the PDCCH monitoring occasion and the PDCCH candidate in the XDD time unit in accordance with controlResourceSetIdForXdd.

As one exemplary variation of Option 3-1, multiple frequency domain patterns may be provided for the XDD time unit. As one example, if several frequency domain patterns are provided for the XDD time unit, the single controlResourceSetIdForXdd may be used for arbitrary XDD time units regardless of the frequency domain pattern.

Alternatively, as another example, association of different CORESETs with different XDD time units having different frequency domain patterns may be applied. For example, an additional X or less number of CORESETs may be configured. Here, the X value may be configured as being smaller than or equal to the number of frequency domain patterns for the configured XDD time unit. Also, the X value may be specified by specifications or configured in an RRC configuration.

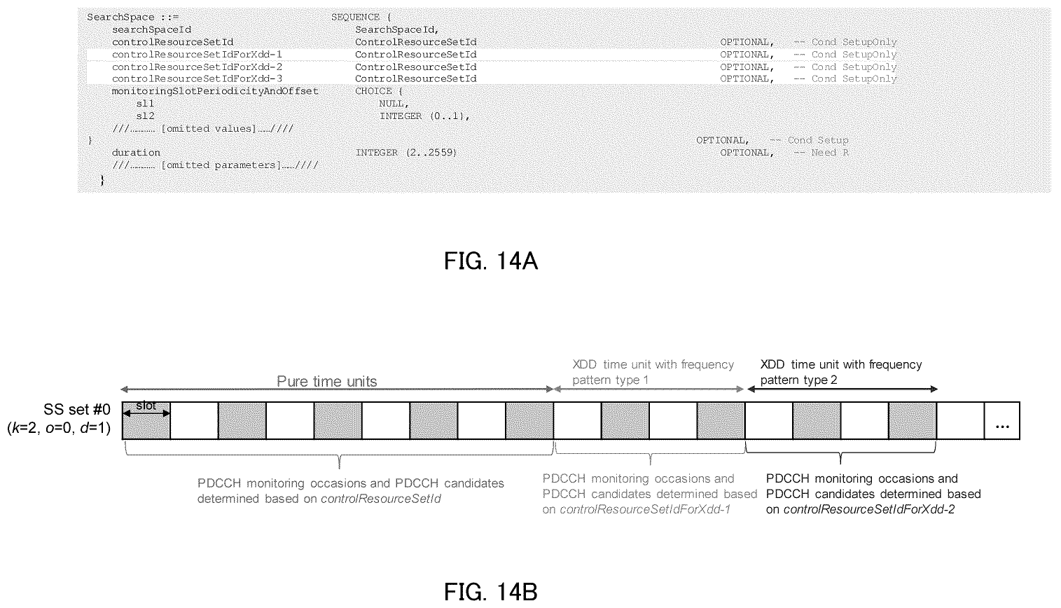

For example, IEs of controlResourceSetIdForXdd-1, controlResourceSetIdForXdd-2 and controlResourceSetIdForXdd-3 for the three additional frequency domain patterns may be configured in a SearchSpace configuration as illustrated in FIG. 14A.

Also, as illustrated in FIG. 14B, a UE may determine a PDCCH monitoring occasion and a PDCCH candidate in the pure time unit in accordance with controlResourceSetId, in the XDD time unit in frequency domain pattern type 1 in accordance with controlResourceSetIdForXdd-1, and in the XDD time unit in frequency domain pattern 2 in accordance with controlResourceSetIdForXdd-2.

Also, in Option 3-2, for respective monitoring start positions in an SS set, a UE may determine a PDCCH monitoring occasion and a PDCCH candidate by trying a list of controlResourceSetIds until proper controlResourceSetId is selected or until all controlResourceSetIds have been tried. In other words, the UE selects a proper one of multiple CORESETs depending on an SS configuration.

For example, for the monitoring start position in the SS set, the UE may first determine the PDCCH monitoring occasion and the PDCCH candidate for the SS set by using a first CORESET ID. If none of the determined PDCCH candidates overlaps with time and frequency domain resources indicated or configured as UL or for UL transmission, the UE may determine to use the CORESET and monitor the determined PDCCH candidate.

If any of the determined PDCCH candidates overlaps with a time and frequency domain resource indicated or configured as UL or for UL transmission, the UE may use the configured next CORESET ID to determine the PDCCH monitoring occasion and the PDCCH candidate until the CORESET ID for which the PDCCH candidate that does not overlap with the time and frequency domain resource indicated or configured as UL or for UL transmission is detected.

In the case where although a UE has attempted all the CORESET IDs configured to the SS set, no CORESET ID for which the PDCCH candidate that does not overlap with the time and frequency domain resource indicated or configured as UL or for UL transmission is detected, a default CORESET, the first CORESET or the last CORESET may be used to determine the PDCCH candidate. Alternatively, the UE may not envisage such a case. Alternatively, the UE may not monitor the PDCCH candidate at the monitoring start position in the SS set.

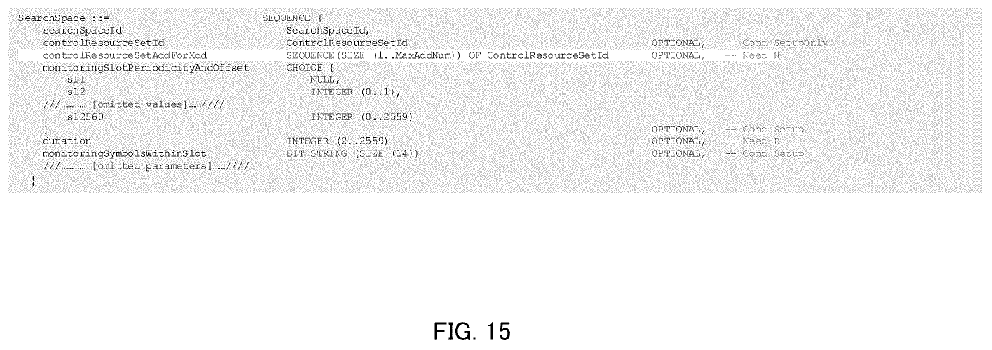

For example, an IE of controlResourceSetAddForXdd to specify a trial order of multiple controlResourceSetIds may be configured in a SearchSpace configuration, as illustrated in FIG. 15.

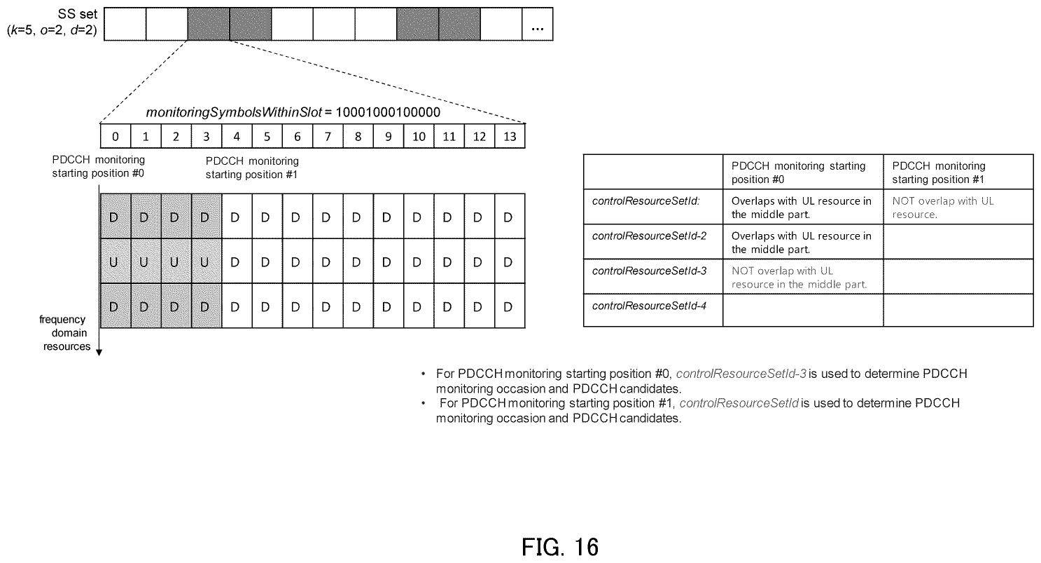

In the example illustrated in FIG. 16, the UE attempts the respective CORESET IDs in the order to controlResourceSetId, controlResourceSetId-2, controlResourceSetId-3 and controlResourceSetId-4 to determine whether the respective CORESET IDs include a PDCCH candidate that does not overlap with a time and frequency domain resource indicated or configured as UL or for UL transmission.

In the illustrated example, for PDCCH monitoring start position #0, controlResourceSetId-3 may be determined as the CORESET including the PDCCH candidate that does not overlap with the time and frequency domain resource indicated or configured as UL or for UL transmission, a UE may determine use controlResourceSetId-3 to determine the PDCCH monitoring occasion and the PDCCH candidate.

Also, for PDCCH monitoring start position #1, controlResourceSetId may be determined as the CORESET including the PDCCH candidate that does not overlap with the time and frequency domain resource indicated or configured as UL or for UL transmission, and a UE may use controlResourceSetId to determine the PDCCH monitoring occasion and the PDCCH candidate.

In Option 4 of the second embodiment, multiple frequencyDomainResources may be configured to a CORESET configuration. Multiple frequency domain patterns are configured for a CORESET. Here, frequencyDomainResources is an IE for specifying a frequency domain resource for the CORESET.

As Option 4-1, different frequencyDomainResources configurations may be applied to the pure time unit and the XDD time unit. In other words, frequency domain patterns are configured depending on the normal TDD operation and the XDD operation. For example, in addition to the existing frequencyDomainResources, a new frequencyDomainResourcesForXdd may be configured to the CORESET. For each PDCCH monitoring occasion for an SS set to a CORESET, if the PDCCH monitoring occasion is not included in or does not overlap with the XDD time unit or XDD symbols, the existing frequencyDomainResources may be used to determine the corresponding PDCCH candidate. On the other hand, if the PDCCH monitoring occasion is included in or overlaps with the XDD time unit or the XDD symbols, a new frequencyDomainResourcesForXdd may be used to determine the corresponding PDCCH candidate.

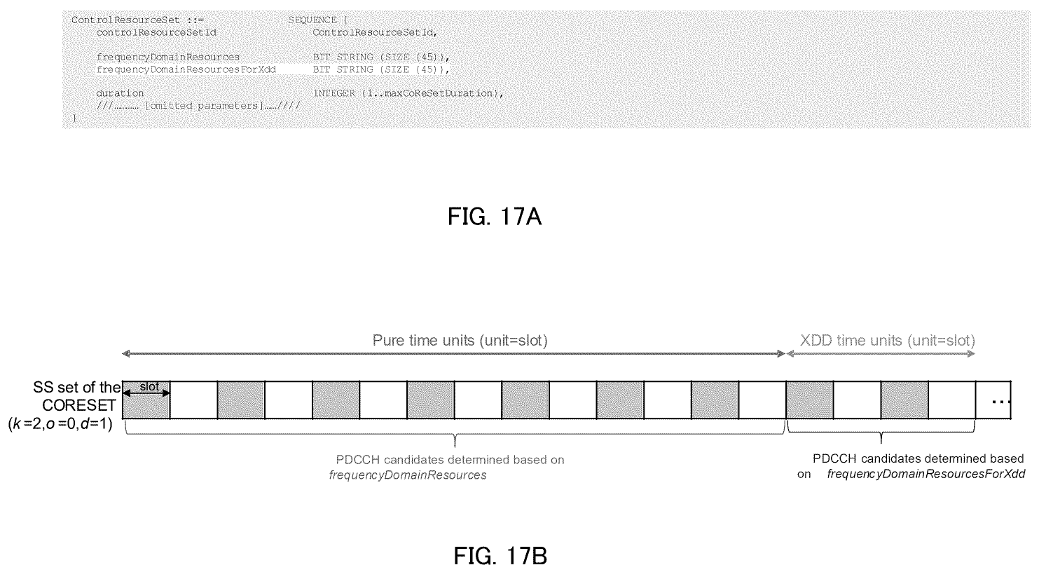

For example, the two IEs of frequencyDomainResources for the pure time unit and frequencyDomainResourcesForXdd for the XDD time unit may be configured in a ControlResourceSet configuration, as illustrated in FIG. 17A.

Also, in the example illustrated in FIG. 17B, a UE may monitor the PDCCH candidate determined based on frequencyDomainResources in the pure time unit and monitor the PDCCH candidate determined based on frequencyDomainResourcesForXdd in the XDD time unit.

As one exemplary variation of Option 4-1, multiple frequency domain patterns may be provided for the XDD time unit. As one example, if the multiple frequency domain patterns are provided for the XDD time unit, the single frequencyDomainResourcesForXdd may be used for arbitrary XDD time units regardless of the frequency domain patterns.

Alternatively, as another example, different frequencyDomainResourcesForXdd configurations may be applied to different XDD time units having different frequency domain patterns. For example, additional X or less number of frequencyDomainResourcesForXdd configurations may be configured. Here, the X value may be configured as being smaller than or equal to the number of frequency domain patterns for the configured XDD time unit. Also, the X value may be specified by specifications or configured in an RRC configuration.

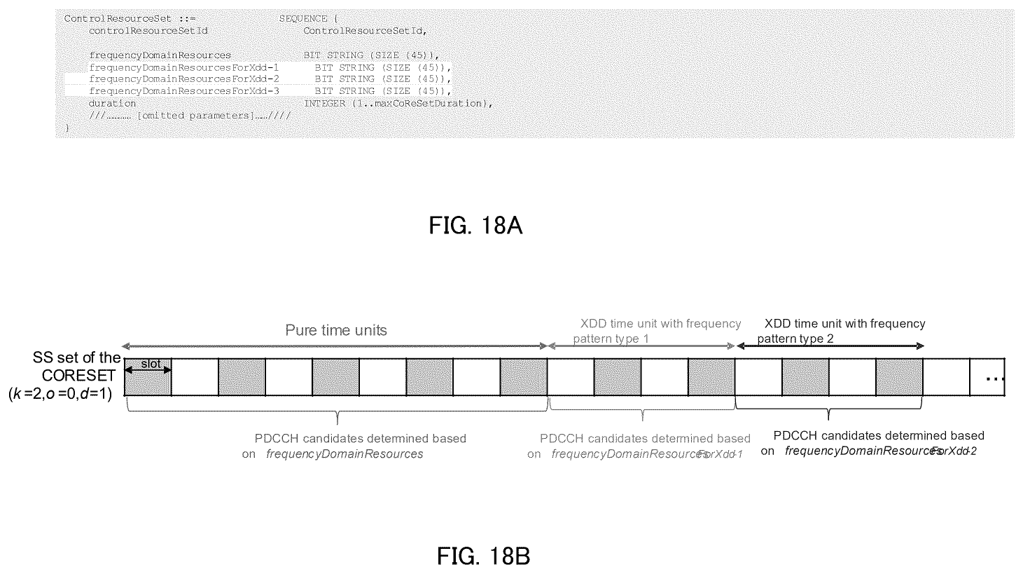

For example, additional three IEs of frequencyDomainResourcesForXdd-1, frequencyDomainResourcesForXdd-2 and frequencyDomainResourcesForXdd-3 for frequency domain patterns may be configured in a ControlResourceSet configuration, as illustrated in FIG. 18A.

Also, as illustrated in FIG. 18B, a UE may determine a PDCCH candidate in the pure time unit in accordance with frequencyDomainResources, a PDCCH candidate in the XDD time unit for frequency domain pattern type 1 in accordance with frequencyDomainResourcesForXdd-1, and a PDCCH candidate in the XDD time unit for frequency domain pattern type 2 in accordance with frequencyDomainResourcesForXdd-2.

As Option 4-2, for each PDCCH monitoring occasion for an SS set to a CORESET, a UE may determine a PDCCH candidate by attempting a list of frequencyDoaminResources until a proper frequencyDomainResources is selected or all the frequencyDomainResources have been attempted. In other words, the UE may select a proper one of multiple CORESETs depending on the SS set.

For example, for each PDCCH monitoring occasion for an SS set to a CORESET, the UE may first determine the PDCCH candidate by using a first frequencyDomainResources. If any of the determined PDCCH candidates does not overlap with time and frequency domain resources indicated or configured as UL or for UL transmission, the UE may determine to use that frequencyDoaminResources and monitor the determined PDCCH candidates.

If any of the determined PDCCH candidates overlaps with time and frequency domain resources indicated or configured as UL or for UL transmission, the UE may determine the PDCCH candidates by using the configured next frequencyDomainResources until the frequencyDomainResources where the PDCCH candidate that does not overlap with the time and frequency domain resources indicated or configured as UL or for UL transmission is acquired is detected.

If the UE has attempted all the frequencyDomainResources but cannot detect the frequencyDomainResources where the PDCCH candidate that does not overlap with the time and frequency domain resources indicated or configured as UL or for UL transmission is acquired, a default frequencyDomainResources, the first frequencyDomainResources or the last frequencyDomainResources may be used to determine the PDCCH candidate. Alternatively, the UE may not envisage such a case. Alternatively, the UE may not monitor the PDCCH candidate in the PDCCH monitoring occasion.

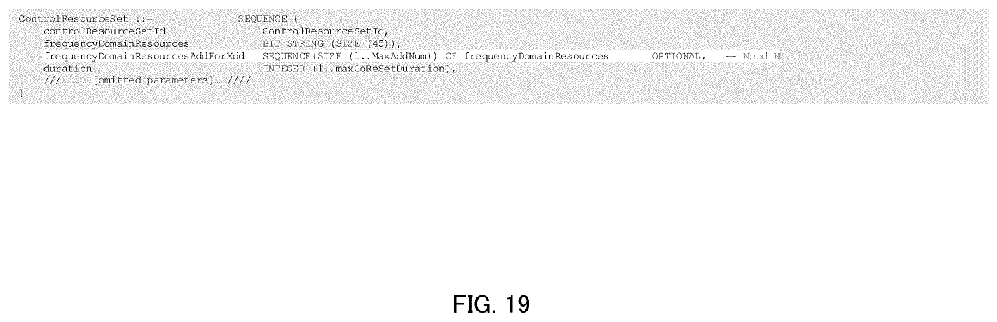

For example, an IE of frequencyDomainResourcesAddForXdd for specifying the trial order of multiple frequencyDomainResources may be configured in a ControlResourceSet configuration, as illustrated in FIG. 19.

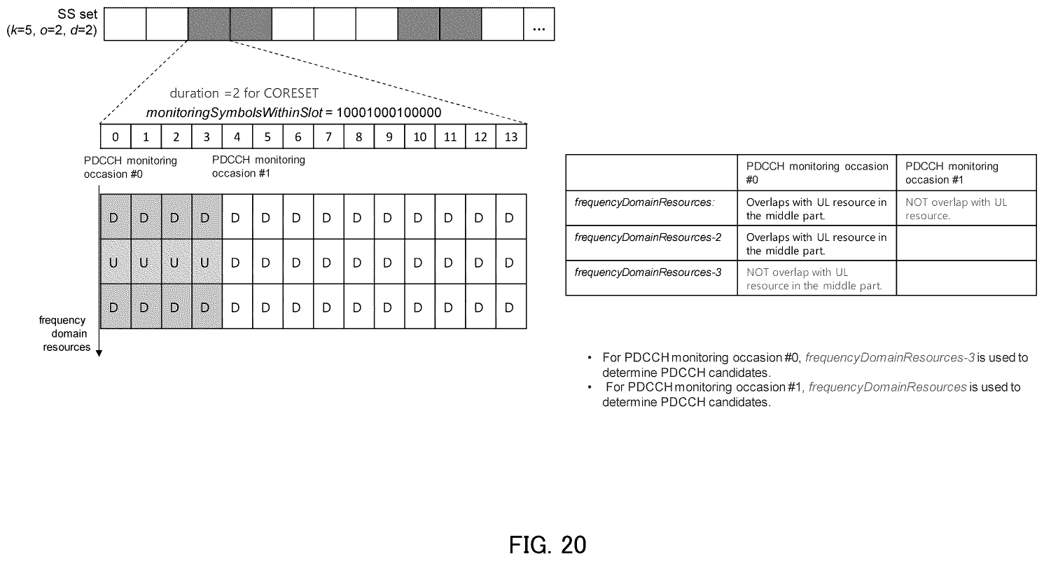

In the example illustrated in FIG. 20, a UE attempts the respective frequencyDomainResources to determine whether the respective frequencyDomainResources include the PDCCH candidate that does not overlap with time and frequency domain resources indicated or configured as UL or for UL transmission in the order of frequencyDomainResources, frequencyDmainResources-2 and frequencyDomainResources-3.

In the illustrated example, for PDCCH monitoring occasion #0, it is determined that frequencyDomainResources-3 is frequencyDomainResources including the PDCCH candidate that does not overlap with the time and frequency domain resources indicated or configured as UL or for UL transmission, and the UE may use frequencyDomainResources-3 to determine the PDCCH candidate.

Also, for PDCCH monitoring occasion #1, it is determined that frequencyDomainResources is frequencyDomainResources including the PDCCH candidate that does not overlap with the time and frequency domain resources indicated or configured as UL or for UL transmission, and the UE may use frequencyDomainResources to determine the PDCCH candidate.

As Option 5 of the second embodiment, multiple bitmaps of freqMonitorLocations may be configured to an SS set configuration. In other words, the bitmaps of multiple freqMonitorLocations are configured for the SS set. Here, freqMonitorLocations is an IE for indicating a frequency monitoring position.

As Option 5-1 of the second embodiment, bitmaps of different freqMonitorLocations may be configured for a pure time unit and an XDD time unit. In other words, a frequency domain pattern is selected depending on the normal TDD operation and the XDD operation. For example, in addition to the bitmaps of the existing freqMonitorLocations, a new freqMonitorLocationsForXdd may be configured for an SS set configuration. For each PDCCH monitoring occasion for the SS set, if the PDCCH monitoring occasion is not included in or does not overlap with the XDD time unit or an XDD symbol, the existing freqMonitorLocations may be used to determine the corresponding PDCCH candidate. On the other hand, if the PDCCH monitoring occasion is included in or overlaps with the XDD time unit or the XDD symbol, the new freqMonitorLocationsForXdd may be used to determine the corresponding PDCCH candidate.

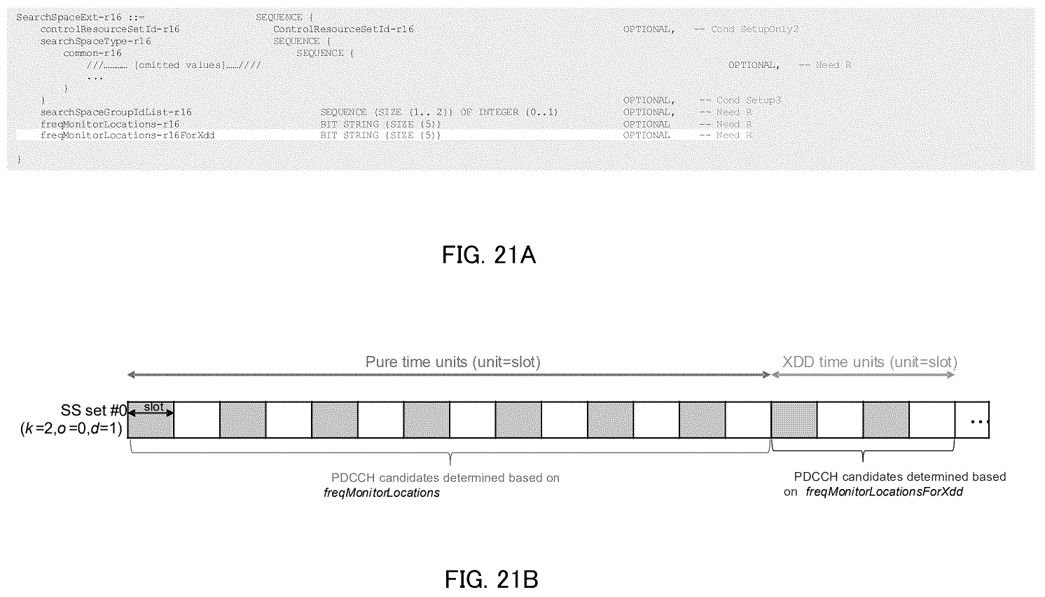

For example, the two IEs of freqMonitorLocations for the pure time unit and freqMonitorLocationsForXdd for the XDD time unit may be configured in a SearchSpaceExt configuration, as illustrated in FIG. 21A.

Also, in the example as illustrated in FIG. 21B, a UE may monitor PDCCH candidates determined based on freqMonitorLocations in the pure time unit and PDCCH candidates determined based on freqMonitorLocationsForXdd in the XDD time unit.

As one exemplary variation of Option 5-1 of the second embodiment, multiple frequency domain patterns may be provided for the XDD time unit. As one example, if the multiple frequency domain patterns are provided for the XDD time unit, a single bitmap of freqMonitorLocationsForXdd may be used for arbitrary XDD time units independent of the frequency domain patterns.

Alternatively, as another example, different bitmaps of freqMonitorLocationsForXdd may be applied to different XDD time units having different frequency domain patterns. For example, additional X or less bitmaps of freqMonitorLocationsForXdd may be configured. Here, the X value may be configured to be smaller than or equal to the number of frequency domain patterns for the configured XDD time unit. Also, the X value may be defined by specifications or configured in n RRC configuration.

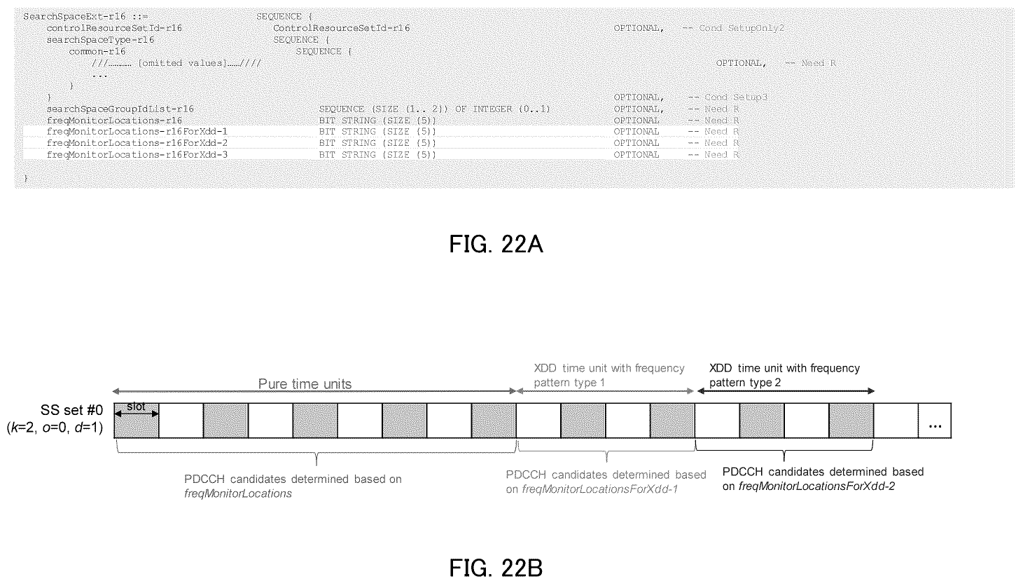

For example, IEs of freqMonitorLocationsForXdd-1, freqMonitorLocationsForXdd-2 and freqMonitorLocationsForXdd-3 for three additional frequency domain patterns may be configured in a SearchSpaceExt configuration, as illustrated in FIG. 22A.

Also, as illustrated in FIG. 22B, a UE may monitor a PDCCH candidate determined based on freqMonitorLocations in the pure time units, a PDCCH candidate determined based on freqMonitorLocationsForXdd-1 in the XDD time units in accordance with frequency domain pattern type 1, and a PDCCH candidate determined based on freqMonitorLocationsForXdd-2 in the XDD time units in accordance with frequency domain pattern type 2.

As Option 5-2 of the second embodiment, for each PDCCH monitoring occasion for an SS set, a UE may determine the PDCCH candidate by attempting a list of freqMonitorLocations until a proper freqMonitorLocations is selected or all the freqMonitorLocations have been attempted. In other words, the UE selects a proper one of multiple bitmaps depending on the SS set.

For example, for each PDCCH monitoring occasion for an SS set, the UE may first determine the PDCCH candidate for the SS set by using a bitmap of a first freqMonitorLocations. If any of the determined PDCCH candidates does not overlap with time and frequency domain resources indicated or configured as UL or for UL transmission, the UE may determine to use that freqMonitorLocations and monitor the determined PDCCH candidates.

If any of the determined PDCCH candidates overlaps with time and frequency domain resources indicated or configured as UL or for UL transmission, the UE may determine the PDCCH candidates by using the configured next freqMonitorLocations until the freqMonitorLocations where the PDCCH candidate that does not overlap with the time and frequency domain resources indicated or configured as UL or for UL transmission is acquired is detected.

If the UE has attempted all the freqMonitorLocations but cannot detect the freqMonitorLocations where the PDCCH candidate that does not overlap with the time and frequency domain resources indicated or configured as UL or for UL transmission is acquired, a default freqMonitorLocations, the first freqMonitorLocations or the last freqMonitorLocations may be used to determine the PDCCH candidate. Alternatively, the UE may not envisage such a case. Alternatively, the UE may not monitor the PDCCH candidate in the PDCCH monitoring occasion.

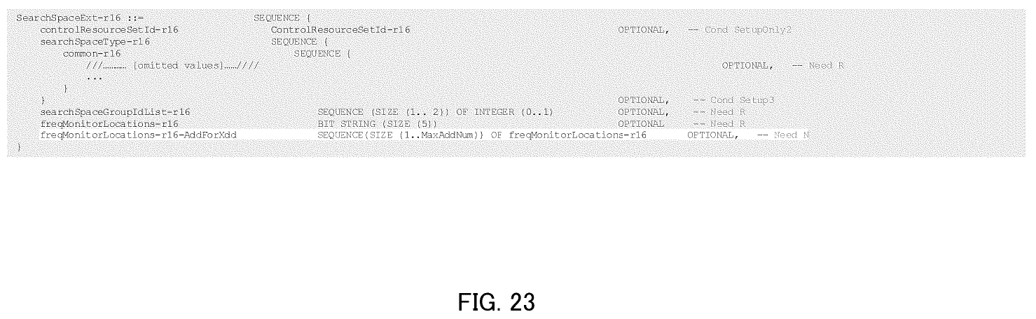

For example, an IE of freqMonitorLocationsAddForXdd for specifying the trial order of multiple freqMonitorLocations may be configured in a SearchSpaceExt configuration, as illustrated in FIG. 23.

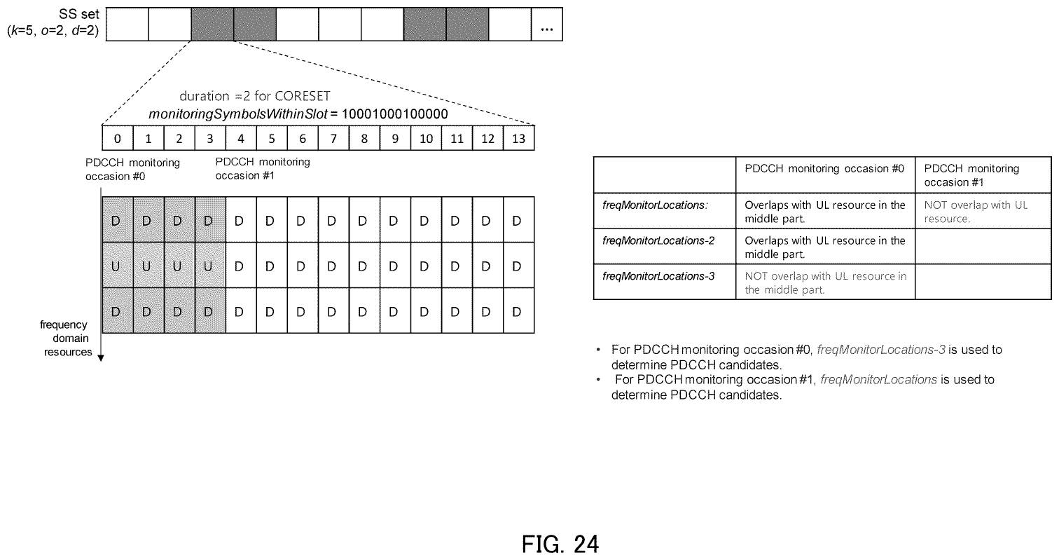

In the example illustrated in FIG. 24, a UE attempts the respective freqMonitorLocations to determine whether the respective freqMonitorLocations include the PDCCH candidate that does not overlap with time and frequency domain resources indicated or configured as UL or for UL transmission in the order of freqMonitorLocations, freqMonitorLocations-2 and freqMonitorLocations-3.

In the illustrated example, for PDCCH monitoring occasion #0, it is determined that freqMonitorLocations-3 is freqMonitorLocations including the PDCCH candidate that does not overlap with the time and frequency domain resources indicated or configured as UL or for UL transmission, and the UE may use freqMonitorLocations-3 to determine the PDCCH candidate.

Also, for PDCCH monitoring occasion #1, it is determined that freqMonitorLocations is freqMonitorLocations including the PDCCH candidate that does not overlap with the time and frequency domain resources indicated or configured as UL or for UL transmission, and the UE may use freqMonitorLocations to determine the PDCCH candidate.

As Option 6 of the second embodiment, at determining PDCCH candidates, different interpretations may be applied to parameters for an SS set and/or a CORESET configuration for a pure time unit and an XDD time unit. In other words, the interpretations for PDCCH monitoring configurations may be switched between the normal TDD operation and the XDD operation.

For example, for the PDCCH monitoring occasion that is not included in or does not overlap with the XDD time units or does not overlap with XDD symbols, freqMonitorLocations for an SS set configuration and/or frequencyDomainResources for a CORESET configuration may be interpreted based on a frequency resource configuration in the pure time unit, that is, similar to the interpretation in Rel-15/16/17.

For the PDCCH monitoring occasion that is included in or overlaps with the XDD time units or overlaps with XDD symbols, freqMonitorLocations for an SS set configuration and/or frequencyDomainResources for a CORESET configuration may be interpreted based on frequency domain resources for the overlapping XDD time unit or XDD symbol. For example, for the PDCCH monitoring occasion that is included in or overlaps with the XDD time units or overlaps with XDD symbols, freqMonitorLocations for the SS set configuration and/or frequencyDomainResources for the CORESET configuration may be replaced with freqMonitorLocationsForXdd and/or frequencyDomainResourcesAddForXdd in a CORESET configuration.

As an exemplary variation of the second embodiment, different options may be applied to different SS set types. For example, these SS set types may be Type0-PDCCH CSS set, Type0A-PDCCH CSS set, Type1-PDCCH CSS set, Type2-PDCCH CSS set, Type3-PDCCH CSS set and/or a USS set.

In this manner, according to the second embodiment, a UE may receive a first PDCCH monitoring configuration for non-XDD time units (for example, pure time units) and a second PDCCH monitoring configuration for XDD time units and control PDCCH monitoring in accordance with the first and second PDCCH monitoring configurations. Correspondingly, a base station may configure the first PDCCH monitoring configuration for the non-XDD time units and the second PDCCH monitoring configuration for the XDD time units and transmit the first and second PDCCH monitoring configurations to terminals.

Specifically, the first PDCCH monitoring configuration may be a search space set configuration (for example, searchSpaceToAddModList) for non-XDD time units, and the second PDCCH monitoring configuration may be one or more search space set configurations for XDD time units (for example, searchSpaceToAddModListForXDD, searchSpaceToAddModListForXDD1, searchSpaceToAddModListForXDD2 or the like).

Also, the first PDCCH monitoring configuration may be a CORESET (for example, controlResourceSetId) configuration for non-XDD time units, and the second PDCCH monitoring configuration may be one or more CORESET configurations for XDD time units (for example, controlResourceSetIdForXdd, controlResourceSetIdForXdd-1, controlResourceSetIdForXdd-2 or the like).

Also, the first PDCCH monitoring configuration may be a frequency domain resource configuration (for example, frequencyDomainResources) for non-XDD time units, and the second PDCCH monitoring configuration may be one or more frequency domain resource configurations for XDD time units (for example, frequencyDomainResourcesForXdd, frequencyDomainResourcesForXdd-1, frequencyDomainResourcesForXdd-2 or the like).

Also, the first PDCCH monitoring configuration may be a frequency monitoring position configuration (for example, freqMonitorLocations) for non-XDD time units, and the second PDCCH monitoring configuration may be one or more frequency monitoring position configurations for XDD time units (for example, freqMonitorLocationsForXdd, freqMonitorLocationsForXdd-1, freqMonitorLocationsForXdd-2 or the like).

Also, the above-stated second PDCCH monitoring configuration may indicate a prioritization corresponding to multiple frequency domain patterns.

Also, the second PDCCH monitoring configuration may be interpreted from the first PDCCH monitoring configuration.

The above-stated configuration or indication may be transmitted based on at least one of a RRC (Radio Resource Control) information element, a DCI (Downlink Control Information) and a MAC CE (Medium Access Control Control Element), for example. Also, the present disclosure is not limited to monitoring the PDCCH and may be applied to other types of control signals transmitted from base stations to UEs or other base stations (for example, an IAB node or the like).

In order to implement the above-stated XDD operation, a UE may transmit UE capability information regarding the XDD operation to a base station, and the base station may indicate or configure the XDD operation to the UE based on the received UE capability information. Specifically, the UE capability information as to whether to support different SS set configurations for XDD time units and pure time units may be defined. The UE may transmit the UE capability information as to whether to support different SS set configurations for XDD time units and pure time units to the base station.

Also, UE capability information as to whether to support multiple controlResourceSetIds configured for an SS set configuration may be defined. A UE may transmit the UE capability information as to whether to support multiple controlResourceSetIds configured for an SS set configuration to a base station.

Also, UE capability information as to whether to support multiple frequencyDomainResources configured for a CORESET configuration may be defined. A UE may transmit the UE capability information as to whether to support multiple frequencyDomainResources configured for a CORESET configuration to a base station.

Also, UE capability information as to whether to support bitmaps of multiple freqMonitorLocations configured for an SS set configuration may be defined. A UE may transmit the UE capability information as to whether to support bitmaps of multiple freqMonitorLocations configured for an SS set configuration to a base station.

According to the second embodiment, if the XDD operation is indicated, configured or applied to a cell where the PDCCH monitoring is configured, a UE operation regarding an SS set and/or a CORESET configuration can be defined.

### Third Embodiment

Presently, there is no discussion on PDCCH monitoring operations in cases where the XDD operation is indicated, configured or applied to a cell where PDCCH monitoring is configured. To this end, there is a need of definition of the PDCCH monitoring operations in the cases where the XDD operation is indicated, configured or applied to a cell where PDCCH monitoring is configured. In other words, a UE may conduct operations below for the PDCCH monitoring.

Note that the third embodiment is separate from the second embodiment. In other words, any option of the third embodiment may be applied together with any option of the second embodiment.

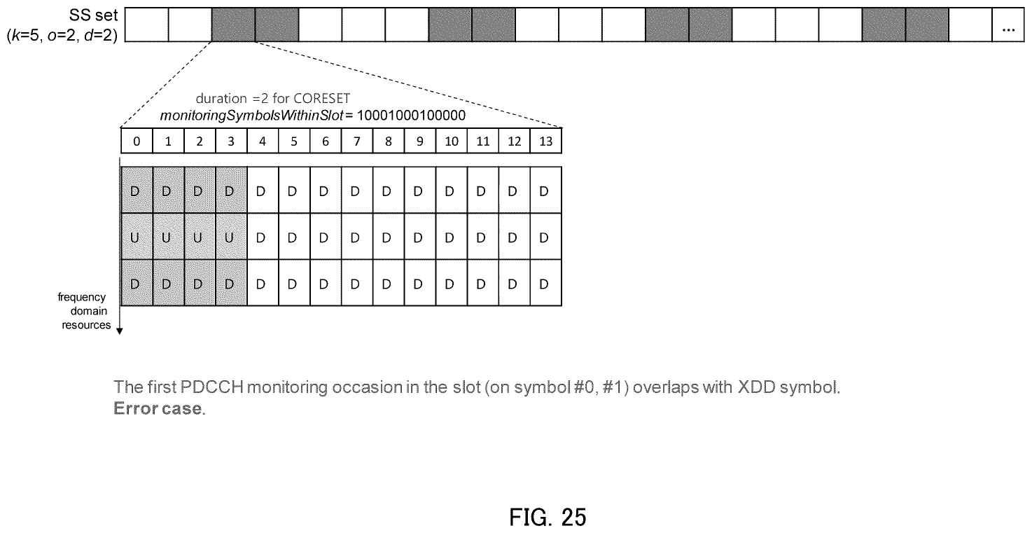

As Option 1 of the third embodiment, a UE may envisage that a PDCCH monitoring occasion for a PDCCH SS set does not overlap with XDD symbols. In other words, the UE may envisage that the PDCCH monitoring does not overlap with the XDD symbols. In this case, for example, in the example illustrated in FIG. 25, the first PDCCH monitoring occasion (symbols #0, #1) in a slot overlaps with the XDD symbol, which may lead to an error case.

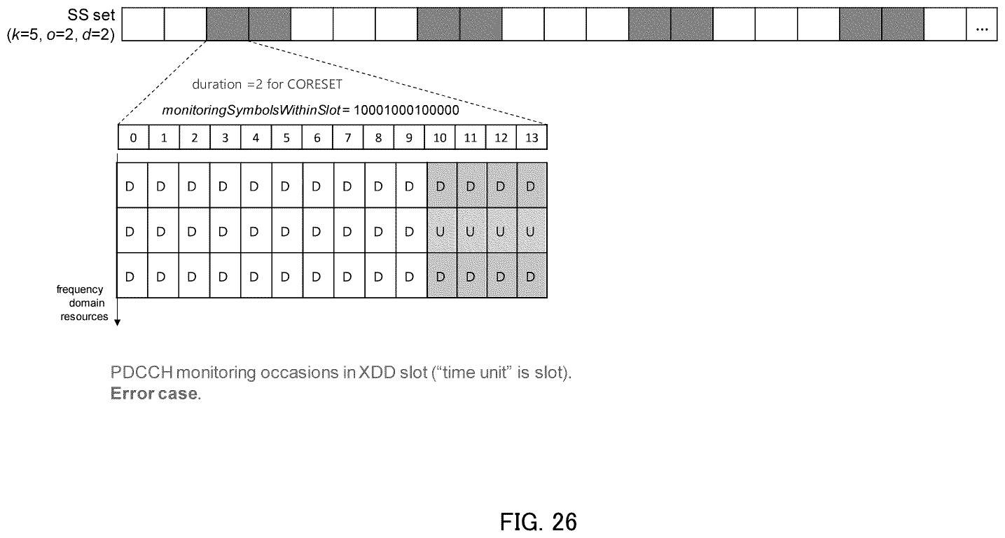

As Option 2 of the third embodiment, a UE may envisage that a PDCCH monitoring occasion for a PDCCH SS set is not included in or does not overlap with XDD time units. In other words, the UE may envisage that the PDCCH monitoring does not overlap with the XDD time units. In this case, for example, in the example illustrated in FIG. 26, the time unit is a slot, and the PDCCH monitoring occasion is included in an XDD slot, which may lead to an error case.

As Option 3 of the third embodiment, a case where a PDCCH monitoring occasion for a PDCCH SS set is included in or overlaps with XDD time units is considered. In other words, if the PDCCH monitoring overlaps with XDD resources, a UE may conduct operations below.

As Option 3-1 of the third embodiment, if the PDCCH monitoring occasion for the PDCCH SS set is included in or overlaps with the XDD time units, a UE may not monitor PDCCH candidates in the PDCCH monitoring occasion regardless of whether the PDCCH monitoring occasion overlaps with XDD symbols. In other words, the UE avoids the PDCCH monitoring.

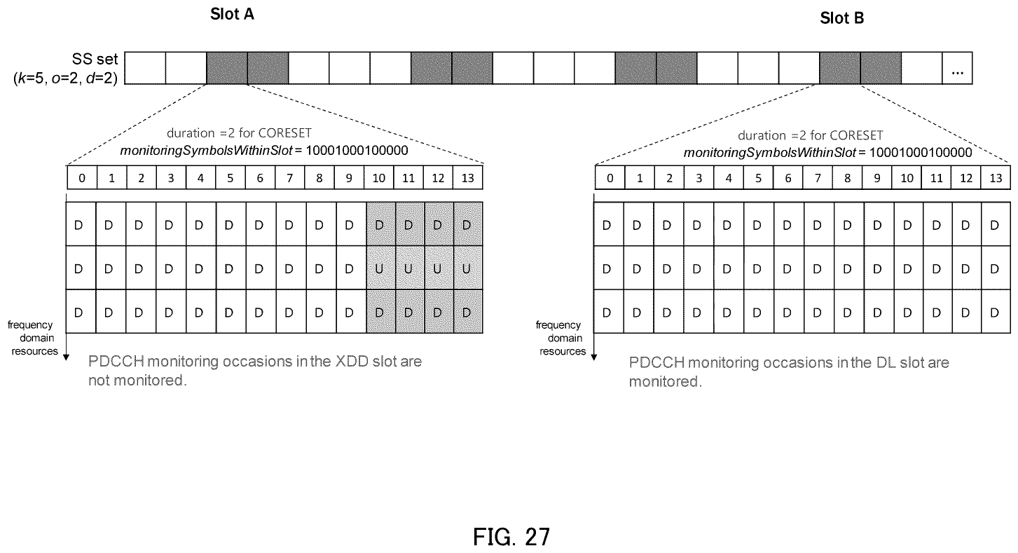

For example, in the example as illustrated in FIG. 27, slot A is an XDD slot, and accordingly a UE may not monitor PDCCH candidates in slot A. On the other hand, slot B is a pure DL slot, and accordingly the UE may monitor PDCCH candidates in slot B.

As Option 3-2 of the third embodiment, if a PDCCH monitoring occasion for a PDCCH SS set is included in or overlaps with XDD time units, a UE determines whether to monitor a PDCCH candidate in the PDCCH monitoring occasion based on whether the PDCCH monitoring occasion overlaps with XDD symbols. In other words, the UE may determine whether the monitoring can be performed depending on whether XDD resources can overlap. If the PDCCH monitoring occasion for a PDCCH SS set overlaps with XDD symbols, the UE may not monitor PDCCH candidates in the PDCCH monitoring occasion. On the other hand, if the PDCCH monitoring occasion for the PDCCH SS set does not overlap with the XDD symbols, the UE may monitor the PDCCH candidates in the PDCCH monitoring occasion.

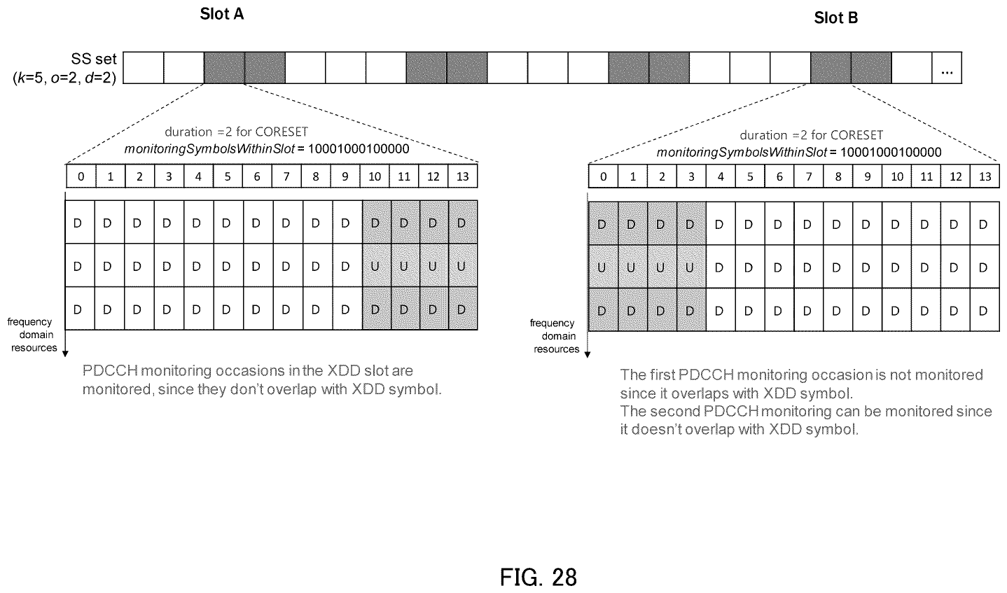

For example, in the example as illustrated in FIG. 28, the PDCCH monitoring occasion (symbols #0, #1, #4 and #5) in slot A does not overlap with the XDD symbols, the UE may monitor the PDCCH candidates in the PDCCH monitoring occasion (symbols #0, #1, #4 and #5) in slot A. On the other hand, the first PDCCH monitoring occasion (symbols #0 and #1) in slot B overlaps with the XDD symbols, the UE may not monitor the PDCCH candidates in the first PDCCH monitoring occasion (symbols #0 and #1) in slot B. Since the second PDCCH monitoring occasion (symbols #4 and #5) in slot B does not overlap with the XDD symbols, the UE may monitor the PDCCH candidates in the second PDCCH monitoring occasion (symbols #4 and #5) in slot B.

As Option 3-3 of the third embodiment, if the PDCCH monitoring occasion for a PDCCH SS set is included in or overlaps with XDD time units, a UE may determine whether to monitor PDCCH candidates in the PDCCH monitoring occasion overlapping with XDD symbols based on whether the PDCCH candidates overlap with time and frequency domain resources indicated or configured as UL or for UL transmission. In other words, the UE may make the determination depending on whether UL is configured for XDD resources.

As Option 3-3A of the third embodiment, if the PDCCH monitoring occasion for a PDCCH SS set is included in or overlaps with XDD time units, a UE envisages that for PDCCH candidates in the PDCCH monitoring occasion for the PDCCH SS set, any of the PDCCH candidates does not overlap with the time and frequency domain resources indicated or configured as UL or for UL transmission. In other words, the UE may monitor the PDCCH candidates in the PDCCH monitoring occasion similar to Rel-15/16.

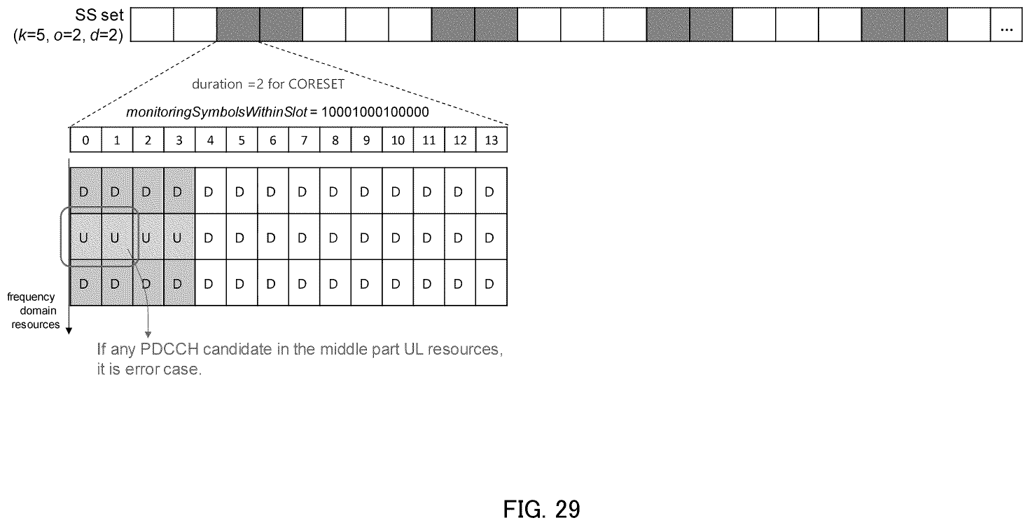

For example, in the example as illustrated in FIG. 29, the first PDCCH monitoring occasion (symbols #0 and #1) overlaps with the time and frequency domain resources configured as UL, which may lead to an error case.

As Option 3-3B of the third embodiment, if the PDCCH monitoring occasion for a PDCCH SS set is included in or overlaps with XDD time units, for PDCCH candidates in the PDCCH monitoring occasion for the PDCCH SS set, if the PDCCH candidates do not overlap with the time and frequency domain resources indicated or configured as UL or for UL transmission, the UE may monitor the PDCCH candidates. On the other hand, if the PDCCH candidates overlap with the time and frequency domain resources indicated or configured as UL or for UL transmission, the UE may not monitor the PDCCH candidates.

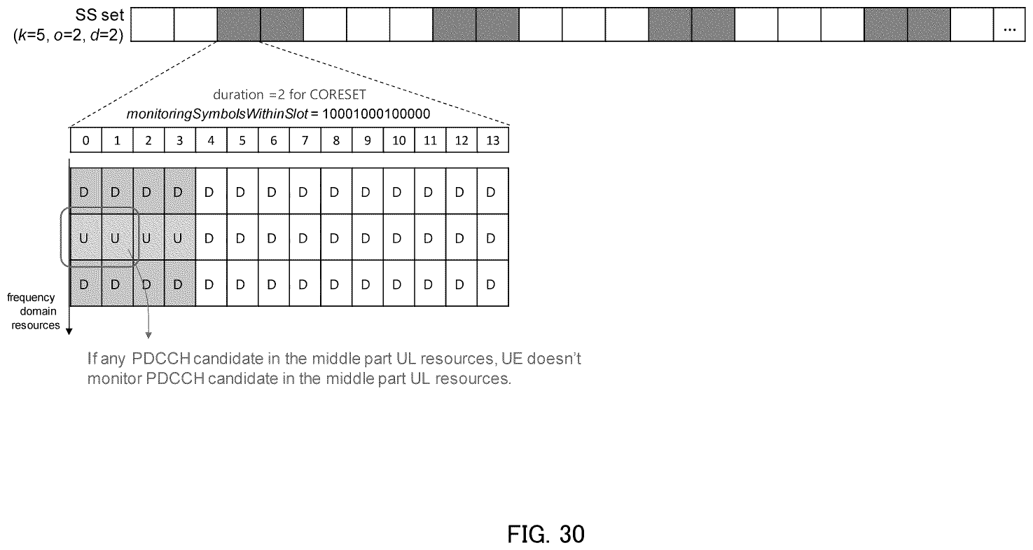

For example, in the example as illustrated in FIG. 30, the first PDCCH monitoring occasion (symbols #0 and #1) overlaps with the time and frequency domain resources configured as UL, and accordingly the UE may not monitor the PDCCH candidates in the first PDCCH monitoring occasion. On the other hand, the second PDCCH monitoring occasion (symbols #4 and #5) does not overlap with the time and frequency domain resources configured as UL, and accordingly the UE may monitor the PDCCH candidates in the second PDCCH monitoring occasion.

As one exemplary variation of the third embodiment, for each option of the third embodiment, the PDCCH SS set may be limited to a certain SS type. For example, the certain SS type may be any of:
i) Type0-PDCCH CSS set configured by pdcch-ConfigSIBI in MIB, by searchSpaceSIB1 in PDCCH-ConfigCommon or by searchSpaceZero in PDCCH-ConfigCommon;
ii) Type0A-PDCCH CSS set configured by searchSpaceOtherSystemInformation in PDCCH-ConfigCommon;
iii) Tyep1-PDCCH CSS set configured by ra-SearchSpace in PDCCH-ConfigCommon;
iv) Type2-PDCCH CSS set configured by pagingSearchSpace in PDCCH-ConfigCommon;
v) Type3-PDCCH CSS set configured by SearchSpace in PDCCH-Config having searchSpaceType=common; and/or
vi) USS set configured by SearchSpace in PDCCH-Config having searchSpaceType=ue-Specific.

Also, different options may be applied to different PDCCH SS set types. For example, Option 1/2 may be applied to Type0-PDCCH CSS set, and Option 3 may be applied to USS set.

As another exemplary variation of the third embodiment, for each option of the third embodiment, a PDCCH SS set may be limited to an SS set where a certain DCI format is configured. For example, the SS set may be the USS set where dci-Formats=formats0-0-And-1-0 or formats0-1-And-1-1, dci-Formats-MT-r16=formats2-5, dci-FormatsExt-r16=formats0-0-And-1-0, formats0-1-And-1-1, formats3-0, formats3-1 or formats3-0-And-3-1, and/or dci-FormatsExt-r16=formats0-2-And-1-2, formats0-1-And-1-1 or formats0-2-And-1-2 are configured.

Also, different options may be applied to a PDCCH SS set where different DCI formats are configured.

In this manner, according to the third embodiment, a UE may receive a PDCCH search space configuration and control PDCCH monitoring in the XDD operation based on the PDCCH search space configuration. Correspondingly, a base station may configure the PDCCH search space configuration in the XDD operation and transmit the PDCCH search space configuration.

Specifically, the UE may envisage that the PDCCH monitoring occasion indicated by the PDCCH search space configuration does not overlap with XDD time units (for example, XDD symbols XDD slots or the like).

Also, if the PDCCH monitoring occasion indicated by the PDCCH search space configuration overlaps with XDD time units, the UE may avoid PDCCH monitoring in the PDCCH monitoring occasion.

Also, if the PDCCH monitoring occasion indicated by the PDCCH search space configuration overlaps with XDD time units (for example, an XDD slot), the UE may control PDCCH monitoring depending on whether the PDCCH monitoring occasion overlaps with a first time unit (for example, an XDD symbol) in the XDD time unit.

Also, if the PDCCH monitoring occasion indicated by the PDCCH search space configuration overlaps with XDD time units, the UE may control PDCCH monitoring in the PDCCH monitoring occasion based on whether a PDCCH candidate overlaps with a radio resource (that is, a time and frequency resource) for uplink transmission.

The above-stated configuration or indication may be transmitted based on at least one of a RRC (Radio Resource Control) information element, a DCI (Downlink Control Information) and a MAC CE (Medium Access Control Control Element), for example. Also, the present disclosure is not limited to monitoring the PDCCH and may be applied to other types of control signals transmitted from base stations to UEs or other base stations (for example, an IAB node or the like).

In order to implement the above-stated XDD operation, a UE may transmit UE capability information regarding the XDD operation to a base station, and the base station may indicate or configure the XDD operation to the UE based on the received UE capability information. Specifically, the UE capability information as to whether to support cases where a PDCCH monitoring occasion overlaps with XDD time units or XDD symbols may be defined. The UE may transmit the UE capability information as to whether to support cases where a PDCCH monitoring occasion overlaps with XDD time units or XDD symbols to a base station.

Also, UE capability information as to whether to support monitoring PDCCH candidates in a PDCCH monitoring occasion including or overlapping with XDD time units or XDD symbols may be defined. The UE may transmit the UE capability information as to whether to support monitoring PDCCH candidates in a PDCCH monitoring occasion including or overlapping with XDD time units or XDD symbols to a base station.

According to the third embodiment, if the XDD operation is indicated, configured or applied to a cell where PDCCH monitoring is configured, UE operations regarding the PDCCH monitoring can be defined.

### Fourth Embodiment

Presently, there is no discussion on PDCCH monitoring capabilities and BD/CCE limitations in cases where the XDD operation is indicated, configured or applied to a cell where the PDCCH monitoring is configured. To this end, there is a need of definition of the UE operations regarding the PDCCH monitoring capabilities and BD/CCE limitations in the cases where the XDD operation is indicated, configured or applied to the cell where the PDCCH monitoring is configured.

In the fourth embodiment—1, the PDCCH monitoring capabilities for an XDD SS set or an XDD PDCCH monitoring occasion may be the same as an existing PDCCH monitoring indication or configuration or different from them. In other words, the PDCCH monitoring capabilities may be configured in any manner as follows.

As Option 1 of the fourth embodiment—1, capability indication, configuration or definition for the PDCCH monitoring on a BWP or a cell may be the same. In other words, the PDCCH monitoring capabilities common to the normal TDD operation and the XDD operation may be configured. The capability indication, configuration or definition for the PDCCH monitoring on a BWP or a cell may be based on a configuration in accordance with monitoringCapabilityConfig-r16 or monitoringCapabilityConfig-r17.

As one exemplary variation of Option 1, if a BWP or a cell is indicated or configured for the XDD operation, it is envisaged that a PDCCH-Config for the BWP or the cell may not be indicated or configured as PDCCH monitoring capabilities per slot in Rel-15, PDCCH monitoring capabilities per span in Rel-16 and/or PDCCH monitoring capabilities for multiple slots in Rel-17.

As one example, if a BWP or a cell is indicated or configured for the XDD operation, a UE may not envisage that monitoringCapabilityConfig-r16=r15monitoringcapability or monitoringCapabilityConfig-r17=r15monitoringcapability is configured on the BWP or the cell for a PDCCH-Config. Alternatively, any of monitoringCapabilityConfig-r16 and monitoringCapabilityConfig-r17 may not be configured on the BWP or the cell for a PDCCH-Config.

As another example, if a BWP or a cell is indicated or configured for the XDD operation, a UE may not envisage that monitoringCapabilityConfig-r16=r16monitoringcapability or monitoringCapabilityConfig-r17=r16monitoringcapability is configured on the BWP or the cell for a PDCCH-Config.

As another example, if a BWP or a cell is indicated or configured for the XDD operation, a UE may not envisage that monitoringCapabilityConfig-r17=r17monitoringcapability is configured on the BWP or the cell for a PDCCH-Config.

Here, an XDD SS set means an SS set configured for XDD time units. Also, a non-XDD SS set means an SS set configured for pure time units. Also, an XDD PDCCH monitoring occasion means a PDCCH monitoring occasion including or overlapping with XDD time units or XDD symbols. Also, a non-XDD PDCCH monitoring occasion means a PDCCH monitoring occasion that does not include or overlap with XDD time units or XDD symbols.

As Option 2 of the fourth embodiment—1, an indication, a configuration or a definition of different PDCCH monitoring capabilities for monitoring an XDD SS set and a non-XDD SS set on a BWP or a cell, or an indication, a configuration or a definition of different PDCCH monitoring capabilities for monitoring an XDD PDCCH monitoring occasion and a non-XDD PDCCH monitoring occasion on a BWP or a cell may be used. In other words, the PDCCH monitoring capabilities may be configured for each of the normal TDD operation and the XDD operation.

For the non-XDD SS set or the non-XDD PDCCH monitoring occasion, monitoringCapabilityConfig-r16 or monitoringCapabilityConfig-r17 may be reused to indicate or configure the PDCCH monitoring capabilities in Rel-15/16/17.

Also, a new RRC parameter of monitoringCapabilityConfigForXdd may be reused to indicate or configure the PDCCH monitoring capabilities in Rel-15/16/17 to monitor an XDD SS set or an XDD PDCCH monitoring occasion.

For example, for candidate values of the new RRC parameter of monitoringCapabilityConfigForXdd, r15monitoringcapability, r16monitoringcapability and/or r17monitoringcapability may be available. Specifically, monitoringCapabilityConfigForXdd may have the following values.
monitoringCapabilityConfigForXdd={r15monitoringcapability, r16monitoringcapability, r17monitoringcapability};
monitoringCapabilityConfigForXdd={r15monitoringcapability, r16monitoringcapability};
monitoringCapabilityConfigForXdd={r15monitoringcapability, r17monitoringcapability}; and
monitoringCapabilityConfigForXdd={r16monitoringcapability, r17monitoringcapability}.

Also, if the new RRC parameter is not configured for monitoring an XDD SS set or an XDD PDCCH monitoring occasion, a UE may perform operations below.

As a first operation, if the new RRC parameter is not configured for monitoring an XDD SS set or an XDD PDCCH monitoring occasion, a UE may follow the same PDCCH monitoring capabilities as ones indicated or configured by monitoringCapabilityConfig-r16 or monitoringCapabilityConfig-r17 to monitor the XDD SS set or the XDD PDCCH monitoring occasion.

As a second operation, if the new RRC parameter is not configured for monitoring an XDD SS set or an XDD PDCCH monitoring occasion, a UE may apply default PDCCH monitoring capabilities to monitor the XDD SS set or the XDD PDCCH monitoring occasion. For example, the default PDCCH monitoring capabilities may be applied as PDCCH monitoring capabilities per slot in Rel-15, PDCCH monitoring capabilities per span in Rel-16, or PDCCH monitoring capabilities for multiple slots in Rel-17.

As a third operation, if certain PDCCH monitoring capabilities are indicated or configured by monitoringCapabilityConfig-r16 or monitoringCapabilityConfig-r17, the default PDCCH monitoring capabilities for monitoring an XDD SS set or an XDD PDCCH monitoring occasion may be always the PDCCH monitoring capabilities per slot in Rel-15, the PDCCH monitoring capabilities per pan in Rel-16 or the PDCCH monitoring capabilities for multiple slots in Rel-17. Otherwise, the UE may follow the same PDCCH monitoring capabilities as ones indicated or configured by monitoringCapabilityConfig-r16 or monitoringCapabilityConfig-r17 to monitor the XDD SS set or the XDD PDCCH monitoring occasion.

As one exemplary variation of Option 2 of the fourth embodiment—1, a UE does not envisage that certain PDCCH monitoring capabilities (for example, monitoring capabilities in Rel-15/16/17) for a non-XDD SS set or a non-XDD PDCCH monitoring occasion are indicated by monitoringCapabilityConfig-r16 or monitoringCapabilityConfig-r17 and certain PDCCH monitoring capabilities (for example, monitoring capabilities in Rel-15/16/17) for a non-XDD SS set or a non-XDD PDCCH monitoring occasion are simultaneously configured or defined.

In the four embodiment—2, for the maximum number of limits of blind decoding (BD) or control channel elements (CCE), PDCCH candidates or non-overlap CCEs for a to-be-monitored XDD SS set and a to-be-monitored non-XDD SS set or PDCCH candidates or non-overlap CCEs for a to-be-monitored XDD PDCCH monitoring occasion and a to-be-monitored non-XDD PDCCH monitoring occasion may be counted separately or in combination. In other words, the upper limit of BD/CCE may be counted in any manner below. The term “to-be-monitored” herein is intended to include a possibility that the PDCCH candidates determined not to be monitored may or may not be counted for limitations of BD/CCE (for example, in accordance with Embodiment 3 and/or rules in Rel-15/16).

A first operation, for the maximum number of BD or CCE, a UE may count the number of PDCCH candidates or non-overlap CCEs for a to-be-monitored XDD SS set and a to-be-monitored non-XDD SS set or the number of PDCCH candidates or non-overlap CCEs for a to-be-monitored XDD PDCCH monitoring occasion and a to-be-monitored non-XDD PDCCH monitoring occasion separately (separate counting). In other words, the number of PDCCH candidates or non-overlap CCEs for each of the normal TDD operation and the XDD operation may be separately counted.

For the XDD SS set or the non-XDD PDCCH monitoring occasion, the number of PDCCH candidates or non-overlap CCEs for a to-be-monitored non-XDD SS set or a to-be-monitored non-XDD PDCCH monitoring occasion may be counted per slot, per span or per group of X slots. Here, per slot, per span or per group of X slots may be based on a configuration by monitoringCapabilityConfig-r16 or monitoringCapabilityConfig-r17. Also, the maximum number of BD or CCE limit per slot, per span or per group of X slots may be {M1_{PDCCM}^{max, slot, μ}, C1_{PDCCH}^{max, slot, μ}}, {M1_{PDCCH}^{max, (X, Y), μ}, C1_{PDCCH}^{max, X, Y), μ}} or {M1_{PDCCH}^{max, Xsslot, μ}, C1_{PDCCH}^{max, Xslot, μ}}, and these values may be equal to, greater than or less than values defined in Rel-15/16/17.

For example, if monitoring capabilities per slot in Rel-15 are indicated (for example, monitoringCapabilityConfig-r16=r15monitoringcapability or monitoringCapabilityConfig-r17=r15monitoringcapability is provided to a UE, or none of monitoringCapabilityConfig-r16 and monitoringCapabilityConfig-r17 is configured), the number of PDCCH candidates or non-overlap CCEs for a to-be-monitored non-XDD SS set or a to-be-monitored non-XDD PDCCH monitoring occasion is counted for each slot, and the maximum number of BD or CCE limits is configured as {M1_{PDCCH}^{max, slot, μ}, C1_{PDCCH}^{max, slot, μ}}.

For an XDD SS set or an XDD PDCCH monitoring occasion, the number of PDCCH candidates or non-overlap CCEs for a to-be-monitored XDD SS set or a to-be-monitored XDD PDCCH monitoring occasion may be counted per slot, per span or per group of X slots. Here, per slot, per span or per group of X slots may be based on Embodiment 4-1. Also, the maximum number of BD or CCE limits per slot, per span or per group of X slots may be {M2_{PDCCH}^{max, slot, μ}, C2_{PDCCH}^{max, slot, μ}}, {M2_{PDCCH}^{max, (X, Y), μ}, C2_{PDCCH}^{max, (X, Y), μ}} or {M2_{PDCCH}^{max, Xslot, μ}, C2_{PDCCH}^{max, Xslot, μ}}, and these values may be equal to, greater than or less than values defined in Rel-15/16/17.

For example, if monitoring capabilities per slot in Rel-15 are indicated (for example, monitoringCapabilityConfigForXdd=r16monitoringcapability is provided to a UE), the number of PDCCH candidates or non-overlap CCEs for a to-be-monitored XDD SS set or a to-be-monitored XDD PDCCH monitoring occasion may be counted for each slot, and the maximum number of BD or CCE limits may be {M2_{PDCCH}^{max, (X, Y), μ}, C2_{PDCCH}^{max, (X, Y), μ}}.

As one exemplary variation, (M1_{PDCCH}^{max, slot, μ}+M2_{PDCCH}^{max, slot, μ}) may be equal to, greater than or less than M_{PDCCH}^{max, slot, μ} defined in Rel-15. Also, (C1_{PDCCH}^{max, slot, μ}+C2_{PDCCH}^{max, slot, μ}) may be equal to, greater than or less than M_{PDCCH}^{max, slot, μ} defined in Rel-15.

As another exemplary variation, (M1_{PDCCH}^{max, (X, Y), μ}+M2_{PDCCH}^{max, (X, Y), μ}) may be equal to, greater than or less than M_{PDCCH}^{max, (X, Y), μ} defined in Rel-16. Also, (C1_{PDCCH}^{max, (X, Y), μ}+C2_{PDCCH}^{max, (X, Y), μ}), may be equal to, greater than or less than M_{PDCCH}^{max, (X, Y), μ} defined in Rel-16.

As another exemplary variation, (M1_{PDCCH}^{max, Xslot, μ}+M2_{PDCCH}^{max, Xslot, μ}) may be equal to, greater than or less than M_{PDCCH}^{max, Xslot, μ} defined in Rel-17. Also, (C1_{PDCCH}^{max, Xslot, μ}+C2_{PDCCH}^{max, Xslot, μ}) may be equal to, greater than or less than M_{PDCCH}^{max, slot, μ} defined in Rel-17.

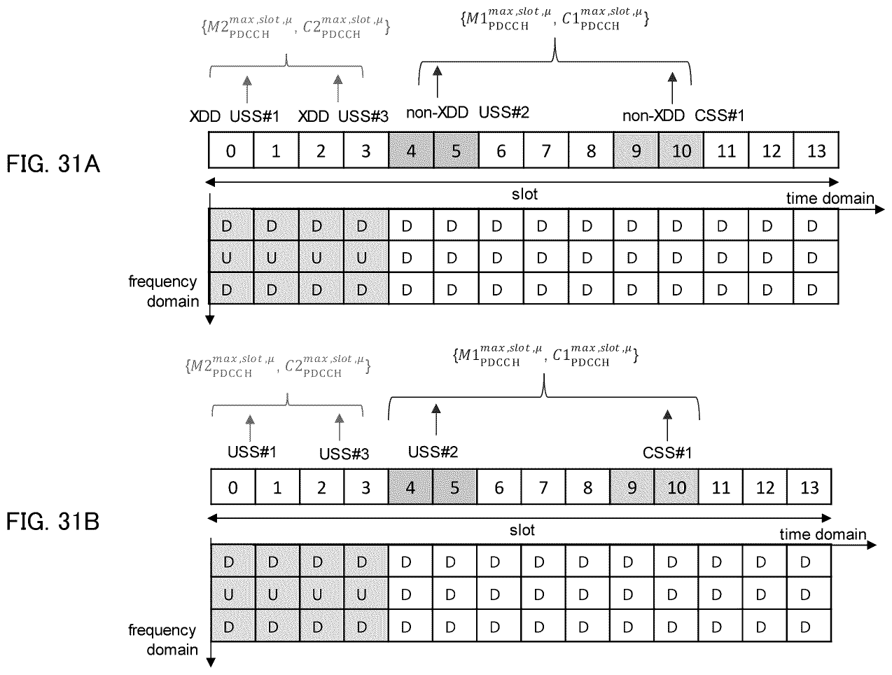

For example, the example as illustrated in FIG. 31A relates to PDCCH monitoring capabilities per slot in Rel-15. XDD USS #1 and XDD USS #3 are to-be-monitored XDD PDCCH monitoring occasions, and the maximum number of BD or CCE limits is {M2_{PDCCH}^{max, slot, μ}, C2_{PDCCH}^{max, slot, μ}}. Also, non-XDD USS #2 and non-XDD CSS #1 are to-be-monitored non-XDD PDCCH monitoring occasions, and the maximum number of BD or CCE limits is {M1_{PDCCH}^{max, slot, μ}, C1_{PDCCH}^{max, slot, μ}}.

For example, the example as illustrated in FIG. 31B also relates to PDCCH monitoring capabilities per slot in Rel-15. USS #1 and USS #3 are to-be-monitored non-XDD PDCCH monitoring occasions, and the maximum number of BD or CCE limits is {M2_{PDCCH}^{max, slot, μ}, C2_{PDCCH}^{max, slot, μ}}. Also, USS #2 and CSS #1 are to-be-monitored non-XDD PDCCH monitoring occasions, and the maximum number of BD or CCE limits is {M1_{PDCCH}^{max, slot, μ}, C1_{PDCCH}^{max, slot, μ}}.

As a second operation, for the maximum number of BDs or CCEs, a UE may count PDCCH candidates or non-overlap CCEs for a to-be-monitored XDD SS set and a to-be-monitored non-XDD SS set or PDCCH candidates or non-overlap CCEs for a to-be-monitored XDD PDCCH monitoring occasion or a to-be-monitored non-XDD PDCCH monitoring occasion jointly (joint counting). In other words, the PDCCH candidates or the non-overlap CCEs may be jointly counted for the normal TDD operation and the XDD operation.

The number of PDCCH candidates or non-overlap CCEs for a to-be-monitored XDD SS set and a to-be-monitored non-XDD SS set or the number of PDCCH candidates or non-overlap CCEs for a to-be-monitored XDD PDCCH monitoring occasion and a to-be-monitored non-XDD PDCCH monitoring occasion may be jointly counted per slot, per span or per group of X slots.

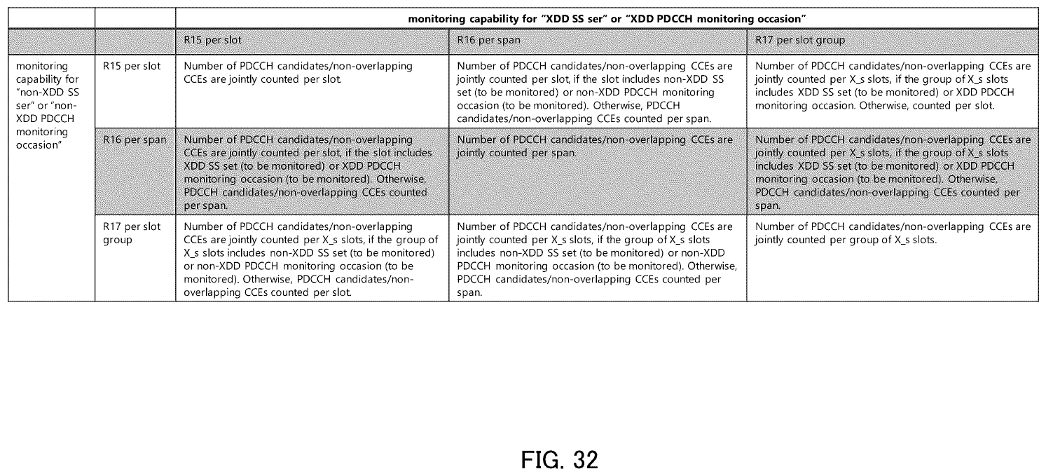

Determination as to which of per slot, per span or per group of X slots is used may be based on the granularity or unit (that is, a slot level, a span level or a slot group level) of monitoring capabilities indicated or configured for a non-XDD SS set or a non-XDD PDCCH monitoring occasion (for example, by monitoringCapabilityConfig-r16 and/or monitoringCapabilityConfig-r17) and monitoring capabilities indicated, configured or defined for an XDD SS set or an XDD PDCCH monitoring occasion (for example, according to Embodiment 4-1). For example, a relationship between Rel-15/16/17 and PDCCH monitoring capabilities is summarized in the table illustrated in FIG. 32.

If the granularity/unit for a non-XDD SS set or a non-XDD PDCCH monitoring occasion (that is, a slot level, a span level or a slot group level) and the granularity/unit for an XDD SS set or an XDD PDCCH monitoring occasion (that is, a slot level, a span level or a slot group level) are the same, this granularity or unit may be used to count the number of PDCCH candidates or non-overlap CCEs. On the other hand, if the granularity/unit for a non-XDD SS set or a non-XDD PDCCH monitoring occasion (that is, a slot level, a span level or a slot group level) and the granularity/unit for an XDD SS set or an XDD PDCCH monitoring occasion (that is, a slot level, a span level or a slot group level) are different each other, the larger granularity or unit may be used to count the number of PDCCH candidates or non-overlap CCEs.

For PDCCH monitoring on a BWP or a cell, the maximum number of BD or CCE limits per slot, per span or per group of X slots, such as {M′_{PDCCH}^{max, slot, μ}, C′_{PDCCH}^{max, (X, Y), μ}}, {M′_{PDCCH}^{max, slot, μ}, C′_{PDCCH}^{max, (X, Y), μ}} or {M′_{PDCCH}^{max, Xslot, μ}, C′_{PDCCH}^{max, Xslot, μ}}, may be fixed or variable.

For example, the maximum number of BD or CCE limits per slot, per span or per group of X slots may be changed depending on whether slots, spans or groups of X slots include or overlap with an XDD time unit or an XDD symbol, whether slots, spans or groups of X slots include any to-be-monitored XDD PDCCH monitoring occasion, or whether slots, spans or groups of X slots include any of PDCCH candidates for a to-be-monitored XDD SS set.

As one example, {M2′_{PDCCH}^{max, slot, μ}, C2′_{PDCCH}^{max, slot, μ}} for an XDD slot may be different from {M1′_{PDCCH}^{max, slot, μ}, C1′_{PDCCH}^{max, slot, μ}} for a non-XDD slot.

As another example, {M2′_{PDCCH}^{max, (X, Y), μ}, C2′_{PDCCH}^{max, (X, Y), μ}} for an XDD span may be different from {M1′_{PDCCH}^{max, (X, Y), μ}, C1′_{PDCCH}^{max, (X, Y), μ}} for a non-XDD span.

As another example, {M2′_{PDCCH}^{max, Xslot, μ}, C2′_{PDCCH}^{max, Xslot, μ}} for an XDD slot group may be different from {M1′_{PDCCH}^{max, Sslot, μ}, C1′_{PDCCH}^{max, Xslot, μ}} for a non-XDD slot group.

As one exemplary variation, the maximum number of BD or CCE limits for a non-XDD slot, a non-XDD span or a non-XDD slot group may be equal to, greater than or less than the maximum number of BD or CCE limits defined in Rel-15/16/17.

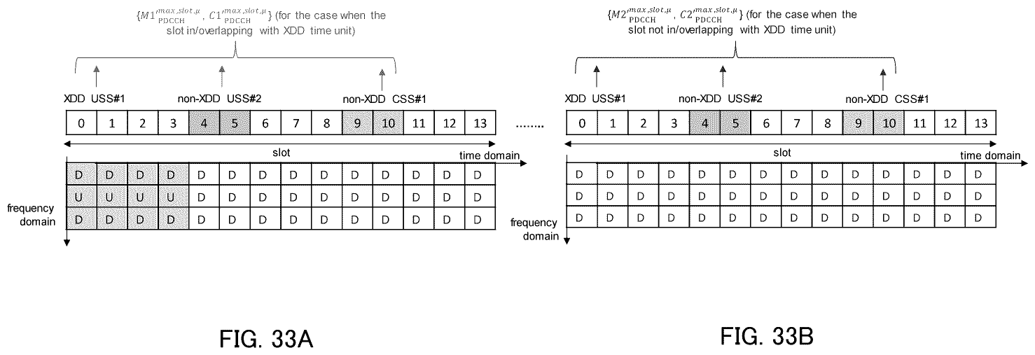

For example, the example as illustrated in FIG. 33A relates to PDCCH monitoring capabilities per slot in Rel-15. XDD USS #1, non-XDD USS #2 and non-XDD CSS #1 are to-be-monitored XDD PDCCH monitoring occasions, and the maximum number of BD or CCE limits is {M1′_{PDCCH}^{max, slot, μ}, C1′_{PDCCH}^{max, slot, μ}}.

For example, the example as illustrated in FIG. 33B also relates to PDCCH monitoring capabilities per slot in Rel-15. XDD USS #1, XDD USS #2 and non-XDD CSS #1 are to-be-monitored XDD PDCCH monitoring occasions, and the maximum number of BD or CCE limits is {M2′_{PDCCH}^{max, slot, μ}, C2_{PDCCH}^{max, slot, μ}}.

Also, for example, the maximum number of BD or CCE limits per slot, per span or per slot group may be a constant value on a BWP or a cell, and values for the BWP or the cell indicated or configured for the XDD operation may be equal to, greater than or less than the maximum number of BD or CCE limits defined in Rel-15/16/17.

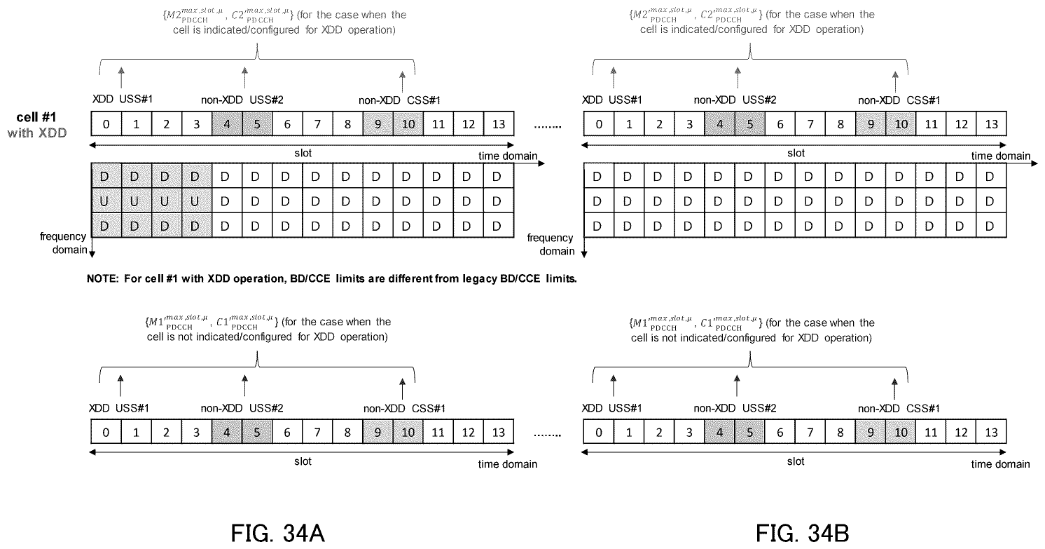

For example, the example as illustrated in FIG. 34A relates to PDCCH monitoring capabilities per slot in Rel-15, where the XDD operation is configured to cell #1 and is not configured to cell #2. XDD USS #1, non-XDD USS #2 and non-XDD CSS #1 are to-be-monitored XDD PDCCH monitoring occasions, and the maximum number of BD or CCE limits for cell #1 is {M2′_{PDCCH}^{max, slot, μ}, C2′_{PDCCH}^{max, slot, μ}}, and the maximum number of BD or CCE limits for cell #2 is {M1′_{PDCCH}^{max, slot, μ}, C1′_{PDCCH}^{max, slot, μ}}.

Also, for example, the example as illustrated in FIG. 34B also relates to PDCCH monitoring capabilities per slot in Rel-15, where the XDD operation is configured to cell #1 and is not configured to cell #2. XDD USS #1, non-XDD USS #2 and non-XDD CSS #1 are to-be-monitored XDD PDCCH monitoring occasions, and the maximum number of BD or CCE limits for cell #1 is {M2′_{PDCCH}^{max, slot, μ}, C2′_{PDCCH}^{max, slot, μ}}, and the maximum number of BD or CCE limits for cell #2 is {M1′_{PDCCH}^{max, slot, μ}, C1′_{PDCCH}^{max, slot, μ}}.

In this manner, according to the fourth embodiment, a UE may receive the PDCCH monitoring capabilities (for example, monitoringCapabilityConfig) regarding the XDD operation to radio resources (for example, a cell, a BWP or the like) and control the PDCCH monitoring in accordance with the PDCCH monitoring capabilities. Correspondingly, a base station may configure the PDCCH monitoring capabilities regarding the XDD operation to radio resources and transmit the PDCCH monitoring capabilities.

Specifically, the PDCCH monitoring capabilities may be configured to the XDD operation and the non-XDD operation in common.

Also, the PDCCH monitoring capabilities may be configured to the XDD operation and the non-XDD operation separately.

Also, a UE may count PDCCH candidates or non-overlap control channel elements in the XDD operation and PDCCH candidates or non-overlap control channel elements in the non-XDD operation separately or jointly.

The above-stated indication or configuration may be transmitted based on at least one of a RRC (Radio Resource Control) information element, a DCI (Downlink Control Information) and a MAC CE (Medium Access Control Control Element). Also, the present disclosure is not limited to the PDCCH monitoring and may be applied to other types of control signals transmitted from a base station to a UE or other base stations (for example, an IAB node).

In order to implement the above-stated XDD operation, a UE may transmit UE capability information regarding the XDD operation to a base station, and the base station may indicate or configure the XDD operation for the UE based on the received UE capability information. Specifically, the UE capability information regarding whether to support a capability indication, a configuration and a definition that are unified for monitoring an XDD SS set (or an XDD PDCCH monitoring occasion) and a non-XDD SS set (or an XDD PDCCH monitoring occasion) may be defined. A UE may transmit the UE capability information regarding whether to support the unified capability indication, configuration or definition for monitoring an XDD SS set (or an XDD PDCCH monitoring occasion) and a non-XDD SS set (or an XDD PDCCH monitoring occasion) to a base station.

Also, the UE capability information regarding whether to support a capability information, a configuration and a definition that are different for monitoring an XDD SS set (or an XDD PDCCH monitoring occasion) may be defined. A UE may transmit the UE capability information regarding whether to support a capability information, a configuration and a definition that are different for monitoring an XDD SS set (or an XDD PDCCH monitoring occasion) to a base station.

Also, the UE capability information regarding whether to support different PDCCH candidate and non-overlap CCE counts for monitoring an XDD SS set (or an XDD PDCCH monitoring occasion) and a non-XDD SS set (or an XDD PDCCH monitoring occasion) may be defined. A UE may transmit the UE capability information regarding whether to support different PDCCH candidate and non-overlap CCE counts for monitoring an XDD SS set (or an XDD PDCCH monitoring occasion) and a non-XDD SS set (or an XDD PDCCH monitoring occasion) to a base station.

Also, the UE capability information regarding whether to support a common PDCCH candidate and non-overlap CCE count for monitoring an XDD SS set (or an XDD PDCCH monitoring occasion) and a non-XDD SS set (or an XDD PDCCH monitoring occasion) may be defined. A UE may transmit the UE capability information regarding whether to support a common PDCCH candidate and non-overlap CCE count for monitoring an XDD SS set (or an XDD PDCCH monitoring occasion) and a non-XDD SS set (or an XDD PDCCH monitoring occasion) to a base station.

According to the fourth embodiment, if the XDD operation is indicated, configured or applied to a cell where the PDCCH monitoring is configured, UE operations regarding the PDCCH monitoring capabilities and BD/CCE limits can be defined.

### Fifth Embodiment

Presently, there is no discussion on PDCCH overbooking in cases where the XDD operation is indicated, configured or applied to a cell where PDCCH monitoring is configured. To this end, a UE operation regarding the PDCCH overbooking in the cases where the XDD operation is indicated, configured or applied to a cell where PDCCH monitoring is configured. must be defined. In other words, the PDCCH overbooking is defined for the XDD operation.

In the fifth embodiment, the overbooking is accepted or not accepted for a cell where the XDD operation is indicated or configured, for a slot, a span or a group of X slots including or overlapping with an XDD time unit or an XDD symbol, for a slot, a span or a group of X slots including a to-be-monitored XDD SS set, or for a slot, a span or a group of X slots including a to-be-monitored XDD PDCCH monitoring occasion.

In Example 1, the overbooking may be accepted or not accepted as follows for the PDCCH monitoring capabilities per slot in Rel-15. Here, an XDD slot may mean a slot including or overlapping with an XDD time unit or an XDD symbol, a slot including a to-be-monitored XDD SS set, and/or a slot including a to-be-monitored XDD PDCCH monitoring occasion.

As Example 1-1, if the XDD operation is indicated or configured to a cell, a UE may not envisage that a greater number of PDCCH candidates than the BD or CCE limits for the cell are monitored in a slot. In other words, differently from Rel-15, if the XDD operation is indicated or configured for a Pcell or a PScell, the overbooking on the Pcell or the PScell may not be envisaged.

As Example 1-2, if a slot is an XDD slot, a UE may not envisage that a greater number of PDCCH candidates than the BD or CCE limits for the cell are monitored in the slot.

As Example 1-3, if a greater number of PDCCH candidates than the BD or CCE limits are monitored in a slot, a UE may drop certain PDCCH candidates in the slot while the BD or CCE limits do not exceed for the cell. In other words, differently from Rel-15, if the XDD operation is indicated or configured for a Scell, the overbooking may be accepted in the Scell.

As Example 1-4, if a greater number of PDCCH candidates than the BD or CCE limits are monitored in a slot and the slot is an XDD slot, a UE may drop certain PDCCH candidates in the slot while the BD or CCE limits do not exceed for the cell.

As one exemplary variation, the value of the BD or CCE limits for a Scell may be the same as or different from the value of the BD or CCE limits defined for monitoring capabilities in Rel-15 for a Pcell or a PScell.

As another exemplary variation, the value of the BD or CCE limits for a cell having the XDD operation may be the same as or different from the value of the BD or CCE limits defined for monitoring capabilities in Rel-15 for a Pcell or a PScell.

As another exemplary variation, the value of the BD or CCE limits for an XDD slot may be the same as or different from the value of the BD or CCE limits defined for monitoring capabilities in Rel-15 for a Pcell or a PScell.

In Example 2, the overbooking may be accepted or not accepted as follows for the PDCCH monitoring capabilities per span in Rel-16. Here, an XDD span may mean a span including or overlapping with an XDD time unit or an XDD symbol, a span including a to-be-monitored XDD SS set, and/or a span including a to-be-monitored XDD PDCCH monitoring occasion.

As Example 2-1, if the XDD operation is indicated or configured to a cell, a UE may not envisage that a greater number of PDCCH candidates than the BD or CCE limits for the cell are monitored in a span. In other words, differently from Rel-16, if the XDD operation is indicated or configured for a Pcell or a PScell, the overbooking on the Pcell or the PScell may not be envisaged.

As Example 2-2, if a span is an XDD span, a UE may not envisage that a greater number of PDCCH candidates than the BD or CCE limits for the cell are monitored in the span.

As Example 2-3, if a greater number of PDCCH candidates than the BD or CCE limits are monitored in a span (or a first span in a slot) and the XDD operation is indicated or configured for a cell (or a Pcell/PScell), a UE may drop certain PDCCH candidates in the span while the BD or CCE limits do not exceed for the cell (or the Pcell/PScell). In other words, differently from Rel-16, if the XDD operation is indicated or configured for a Scell, the overbooking may be accepted in the Scell. Also, if the XDD operation is indicated or configured for the cell, the overbooking may be accepted in spans other than the first span in the slot.

As Example 2-4, if a greater number of PDCCH candidates than the BD or CCE limits are monitored in a span (or a first span in a slot) and a span on a cell (or a Pcell/PScell) is an XDD span, a UE may drop certain PDCCH candidates in the span while the BD or CCE limits do not exceed for the cell (or the Pcell/PScell).

As one exemplary variation, the value of the BD or CCE limits for spans other than the first span in a slot on a Pcell/PScell may be the same as or different from the value of the BD or CCE limits defined for monitoring capabilities in Rel-16 for the first span in the slot on the Pcell or a PScell.

As another exemplary variation, the value of the BD or CCE limits for a cell having the XDD operation may be the same as or different from the value of the BD or CCE limits defined for monitoring capabilities in Rel-16 for a Pcell or a PScell.

As another exemplary variation, the value of the BD or CCE limits for the first span in a slot on a Scell may be the same as or different from the value of the BD or CCE limits defined for monitoring capabilities in Rel-16 for a Pcell or a PScell.

As another exemplary variation, the value of BD or CCE limits for spans other than a first span in a slot on a Scell may be the same as or different from the value of BD or CCE limits defined in Rel-16 for the first span in the slot on the Pcell or the PScell.

As another example variation, the value of BD or CCE limits for an XDD span may be the same as or different from the value of BD or CCE limits defined in Rel-16 for a Pcell or a PScell.

In Example 3, the overbooking may be accepted or not accepted as follows for the PDCCH monitoring capabilities per multiple slots in Rel-17. Here, an XDD slot group may mean a group of X slots (group of X_s slots) including or overlapping with an XDD time unit or an XDD symbol, a group of X slots including a to-be-monitored XDD SS set, and/or a group of X slots including a to-be-monitored XDD PDCCH monitoring occasion.

As Example 3-1, if the XDD operation is indicated or configured to a cell, a UE may not envisage that a greater number of PDCCH candidates than the BD or CCE limits for the cell are monitored in a group of X slots. In other words, differently from Rel-17, if the XDD operation is indicated or configured for a Pcell, the overbooking on the Pcell may not be envisaged.

As Example 3-2, if a group of X slots is an XDD slot group, a UE may not envisage that a greater number of PDCCH candidates than the BD or CCE limits for the cell are monitored in the group of X slots.

As Example 3-3, if a greater number of PDCCH candidates than the BD or CCE limits are monitored in a group of X slots and the XDD operation is indicated or configured for a (primary) cell, a UE may drop certain PDCCH candidates in the group of X slots while the BD or CCE limits do not exceed for the cell. In other words, differently from Rel-17, if the XDD operation is indicated or configured for a Scell, the overbooking may be accepted in the Scell.

As Example 3-4, if a greater number of PDCCH candidates than the BD or CCE limits are monitored in a group of X slots and a group of X slots is an XDD slot group, a UE may drop certain PDCCH candidates in the slot group while the BD or CCE limits do not exceed for the (primary) cell.

As one exemplary variation, the value of BD or CCE limits for a Scell may be the same as or different from the value of BD or CCE limits defined in monitoring capabilities in Rel-17 for a primary cell.

As another exemplary variation, the value of BD or CCE limits for a cell having the XDD operation may be the same as or different from the value of BD or CCE limits defined in monitoring capabilities in Rel-17 for a Pcell or PScell.

As another exemplary variation, the value of BD or CCE limits for an XDD slot group may be the same as or different from the value of BD or CCE limits defined in monitoring capabilities in Rel-17 for a primary cell.

In this manner, according to the fifth embodiment, a UE may control the PDCCH overbooking in an XDD time unit where the PDCCH monitoring is configured and perform the PDCCH monitoring in a PDCCH monitoring occasion selected in the controlled PDCCH overbooking. In other words, the UE may drop a portion of PDCCH monitoring occasions from the overbooking ODCCH monitoring occasions. Correspondingly, a base station may configure the overbooking PDCCH monitoring occasions in an XDD time unit where the PDCCH monitoring is configured and transmit control information in the PDCCH monitoring occasions.

The above-stated indication or configuration may be transmitted based on at least one of a RRC (Radio Resource Control) information element, a DCI (Downlink Control Information) and a MAC CE (Medium Access Control Control Element), for example. Also, the present disclosure is not limited to the PDCCH monitoring and may be applied to other types of control signals transmitted from a base station to a UE or other base stations (for example, an IAB node).

In order to implement the above-stated XDD operation, a UE may transmit UE capability information regarding the XDD operation to a base station, and the base station may indicate or configure the XDD operation for the UE based on the received UE capability information. Specifically, if the XDD operation is indicated or configured to a cell, the UE capability information regarding whether to support the PDCCH overbooking on the cell may be defined. If the XDD operation is indicated or configured to a cell, a UE may transmit the UE capability information regarding whether to support the PDCCH overbooking on the cell to a base station.

Also, the UE capability information regarding whether to support the PDCCH overbooking in an XDD slot, an XDD span or an XDD slot group may be defined. A UE may transmit the UE capability information regarding whether to support the PDCCH overbooking in an XDD slot, an XDD span or an XDD slot group to a base station.

Also, the UE capability information regarding whether to support the PDCCH overbooking in consideration of an XDD SS set (or an XDD PDCCH monitoring occasion) and a non-XDD SS set (or an XDD PDCCH monitoring occasion) may be defined. A UE may transmit the UE capability information regarding whether to support the PDCCH overbooking in consideration of an XDD SS set (or an XDD PDCCH monitoring occasion) and a non-XDD SS set (or an XDD PDCCH monitoring occasion) to a base station.

According to the fifth embodiment, if the XDD operation is indicated, configured or applied to a cell where the PDCCH monitoring is configured, the UE operations regarding the PDCCH overbooking can be defined.

### Sixth Embodiment

Presently, there is no discussion on the PDCCH overbooking in cases where the XDD operation is indicated, configured or applied to a cell where the PDCCH monitoring is configured. To this end, a UE operation regarding the PDCCH overbooking in the cases where the XDD operation is indicated, configured or applied to a cell where the PDCCH monitoring is configured must be defined. In other words, a rule of the PDCCH overbooking for the XDD operation may be defined. Specifically, a UE operation to select a to-be-monitored/dropped PDCCH monitoring occasion from the overbooking PDCCH monitoring occasions is defined from the PDCCH overbooking accepted in Embodiment 5.

In the sixth embodiment, if a slot, a span or a group of X slots includes or overlaps with an XDD time unit or an XDD symbol, includes any to-be-monitored XDD SS set or includes any to-be-monitored XDD PDCCH monitoring occasion, the overbooking may be accepted for the slot, the span or the group of X slots.

As Option 0 of the sixth embodiment, existing PDCCH overbooking rule in Rel-15/16/17 may be reused. In other words, the rule in Rel-15/16/17 is applied.

As Option 1 of the sixth embodiment, it may be considered which an XDD SS set or a non-XDD SS set is for the overbooking.

As Option 1-1 of the sixth embodiment, the prioritization of “a CSS has a higher priority than a USS”→“a non-XDD SS set has a higher or lower priority than an XDD SS set”→“a smaller SS index has a higher priority than a greater SS index” may be applied.

As Option 1-A of the sixth embodiment, it may not be envisaged that a non-XDD CSS is dropped. An XDD CSS, a non-XDD USS and an XDD USS may be dropped based on priorities. For example, a UE may not envisage that the number of PDCCH candidates or non-overlap CCEs for the non-XDD CSS in any slot, span or group of X slots exceeds BD or CCE limits. Also, as one exemplary variation, it may not be envisaged that the XDD CSS is dropped. A non-XDD CSS, an XDD USS and a non-XDD USS may be dropped based on priorities.

As Option 1-1B of the sixth embodiment, it may not be dropped that a non-XDD CSS and an XDD CSS are dropped. A non-XDD USS and an XDD USS are dropped based on priorities. For example, a UE may not envisage that the number of PDCCH candidates or non-overlap CCEs for the non-XDD CSS and the XDD CSS in any slot, span or group of X slots exceeds BD or CCE limits. Also, as one exemplary variation, it may not be envisaged that the XDD CSS and the non-XDD CSS are dropped. An XDD USS and a non-XDD USS may be dropped based on priorities.

As Option 1-C of the sixth embodiment, it may not be envisaged that a non-XDD CSS, an XDD CSS and a non-XDD USS are dropped. The XDD USS may be dropped based on priorities. For example, a UE may not envisage that the number of PDCCH candidates or non-overlap CCEs for the non-XDD CSS, the XDD CSS and the non-XDD USS in any slot, span or group of X slots exceeds BD or CCE limits. Also, as one exemplary variation, it may not be envisaged that the non-XDD CSS, the XDD CSS and the non-XDD USS are dropped. A non-XDD USS may be dropped based on priorities.

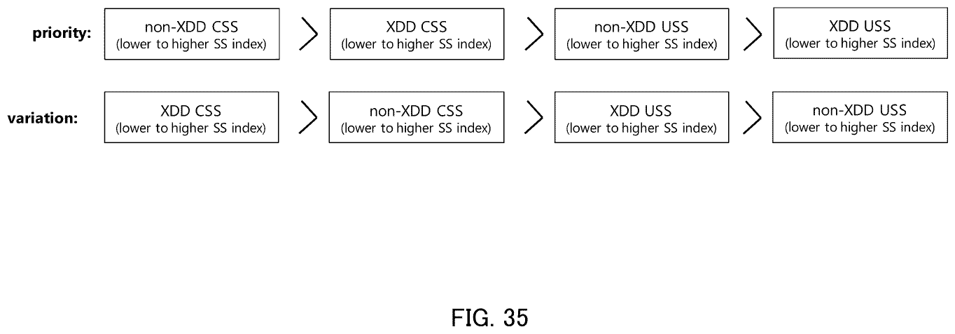

According to the priorities of Option 1-1 of the sixth embodiment and the exemplary variations, the XDD CSS, the non-XDD CSS, the XDD USS and the non-XDD USS may be prioritized as illustrated in FIG. 35.

In Option 1-2 of the sixth embodiment, the prioritization of “a non-XDD SS set has a higher or lower priority than an XDD SS set”→“a CSS set has a higher priority than a USS”→“a smaller SS index has a higher priority than a greater SS index” may be applied.

As Option 1-2A of the sixth embodiment, it may not be envisaged that a non-XDD CSS is dropped. A non-XDD USS, an XDD CSS and an XDD USS may be dropped based on priorities. For example, a UE may not envisage that the number of PDCCH candidates or non-overlap CCEs for the non-XDD CSS in any slot, span or group of X slots exceeds BD or CCE limits. Also, as one exemplary variation, it may not be envisaged that the XDD CSS is dropped. An XDD USS, a non-XDD CSS and a non-XDD USS may be dropped based on priorities.

As Option 1-2B of the sixth embodiment, it may not be dropped that a non-XDD CSS and a non-XDD USS are dropped. Anon-XDD CSS and an XDD USS are dropped based on priorities. For example, a UE may not envisage that the number of PDCCH candidates or non-overlap CCEs for the non-XDD CSS and the non-XDD USS in any slot, span or group of X slots exceeds BD or CCE limits. Also, as one exemplary variation, it may not be envisaged that the XDD CSS and the XDD USS are dropped. A non-XDD CSS and a non-XDD USS may be dropped based on priorities.

As Option 1-2C of the sixth embodiment, it may not be envisaged that a non-XDD CSS, a non-XDD USS and an XDD CSS are dropped. The XDD USS may be dropped based on priorities. For example, a UE may not envisage that the number of PDCCH candidates or non-overlap CCEs for the non-XDD CSS, the non-XDD USS and the XDD CSS in any slot, span or group of X slots exceeds BD or CCE limits. Also, as one exemplary variation, it may not be envisaged that an XDD CSS, an XDD USS and a non-XDD USS are dropped. A non-XDD USS may be dropped based on priorities.

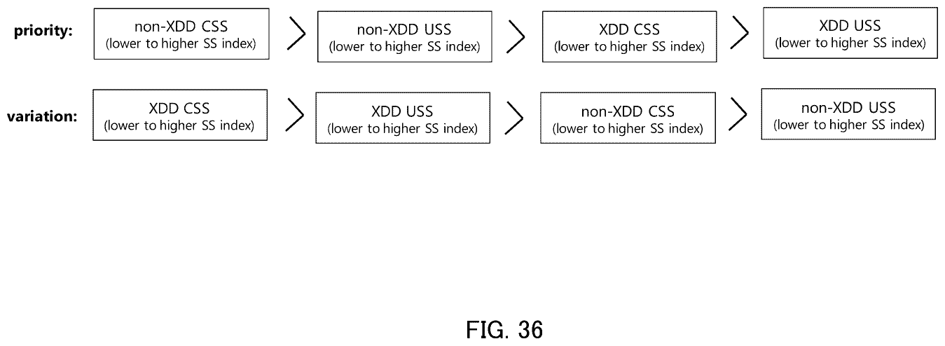

According to the priorities of Option 1-2 of the sixth embodiment and the exemplary variations, an XDD CSS, a non-XDD CSS and a non-XDD USS may be prioritized as illustrated in FIG. 36.

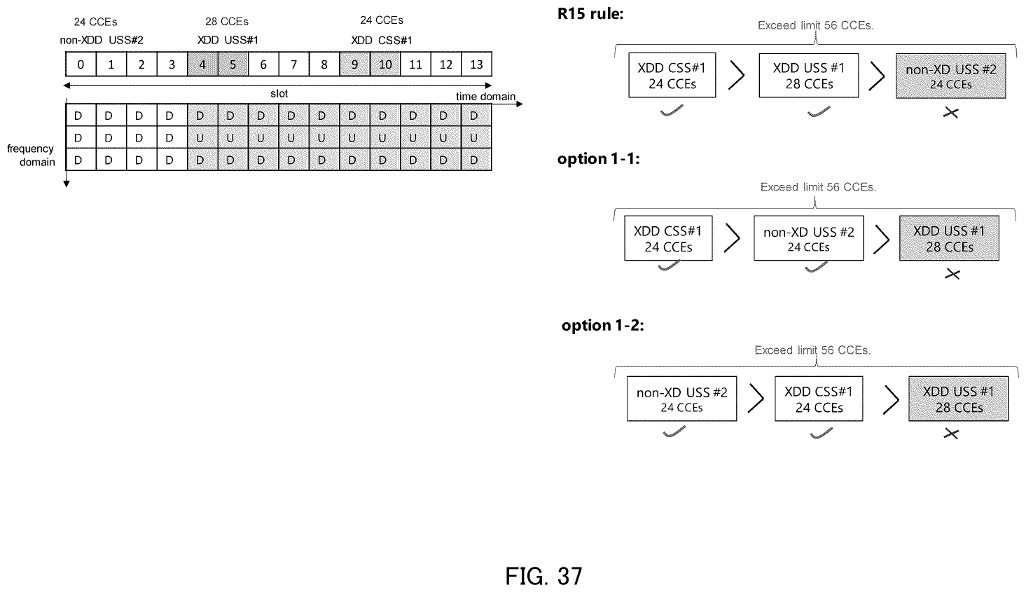

For example, in the symbol arrangement as illustrated in FIG. 37, according to rules in Rel-15, XDD CSS #1 and XDD USS #1 may be monitored, and non-XDD USS #2 may be dropped. Also, according to Option 1-1, XDD CSS #1 and non-XDD USS #2 may be monitored, and XDD USS #1 may be dropped. Also, according to Option 1-2, non-XDD USS #2 and XDD CSS #1 may be monitored, and XDD USS #1 may be dropped.

As Option 2 of the sixth embodiment, it may be considered whether an XDD PDCCH monitoring occasion or a non-XDD PDCCH monitoring occasion is for overbooking. Here, the XDD PDCCH monitoring occasion means a PDCCH monitoring occasion including or overlapping with an XDD time unit or an XDD symbol. Also, the non-XDD PDCCH monitoring occasion means a PDCCH monitoring occasion that does not include or overlap with an XDD time unit or an XDD symbol.

In Option 2-1 of the sixth embodiment, the prioritization of “a CSS has a higher priority than a USS”→“a non-XDD PDCCH monitoring occasion has a higher or lower priority than an XDD PDCCH monitoring occasion”→“a smaller SS index has a higher priority than a greater SS index” may be applied.

As Option 2-1A of the sixth embodiment, it may not be envisaged that a PDCCH candidate in a non-XDD PDCCH monitoring occasion in a CSS set is dropped. The PDCCH candidates in an XDD PDCCH monitoring occasion in a CSS set, a non-XDD PDCCH monitoring occasion in a USS set and an XDD PDCCH monitoring occasion in a USS set may be dropped based on priorities. For example, a UE may not envisage that the number of PDCCH candidates or non-overlap CCEs in the non-XDD PDCCH monitoring occasion in the CSS set in any slot, span or group of X slots exceeds BD or CCE limits. Also, as one exemplary variation, it may not be envisaged that a PDCCH candidate in an XDD PDCCH monitoring occasion in a CSS set is dropped. The PDCCH candidates in a non-XDD PDCCH monitoring occasion in a CSS set, an XDD PDCCH monitoring occasion in a USS set and a non-XDD PDCCH monitoring occasion in a USS set may be dropped based on priorities.

As Option 2-1B of the sixth embodiment, it may not be envisaged that PDCCH candidates in a non-XDD PDCCH monitoring occasion in a CSS set and an XDD PDCCH monitoring occasion in a CSS set are dropped. The PDCCH candidates in a non-XDD PDCCH monitoring occasion in a USS set and an XDD PDCCH monitoring occasion in a USS set may be dropped based on priorities. For example, a UE may not envisage that the number of PDCCH candidates or non-overlap CCEs in the non-XDD PDCCH monitoring occasion in the CSS set and the XDD PDCCH monitoring occasion in the CSS set in any slot, span or group of X slots exceeds BD or CCE limits. Also, as one exemplary variation, it may not be envisaged that a PDCCH candidate in an XDD PDCCH monitoring occasion in a CSS set and a non-XDD PDCCH monitoring occasion in a CSS set is dropped. The PDCCH candidates in an XDD PDCCH monitoring occasion in a USS set and a non-XDD PDCCH monitoring occasion in a USS set may be dropped based on priorities.

As Option 2-1C of the sixth embodiment, it may not be envisaged that PDCCH candidates in a non-XDD PDCCH monitoring occasion in a CSS set, an XDD PDCCH monitoring occasion in a CSS set and a non-XDD PDCCH monitoring occasion in a USS set are dropped. The PDCCH candidates in a non-XDD PDCCH monitoring occasion in a USS set may be dropped based on priorities. For example, a UE may not envisage that the number of PDCCH candidates or non-overlap CCEs in the non-XDD PDCCH monitoring occasion in the CSS set, the XDD PDCCH monitoring occasion in the CSS set and the non XDD PDCCH monitoring occasion in the USS set in any slot, span or group of X slots exceeds BD or CCE limits. Also, as one exemplary variation, it may not be envisaged that a PDCCH candidate in an XDD PDCCH monitoring occasion in a CSS set, a non-XDD PDCCH monitoring occasion in a CSS set and an XDD PDCCH monitoring occasion in a USS set is dropped. The PDCCH candidates in a non-XDD PDCCH monitoring occasion in a USS set may be dropped based on priorities.

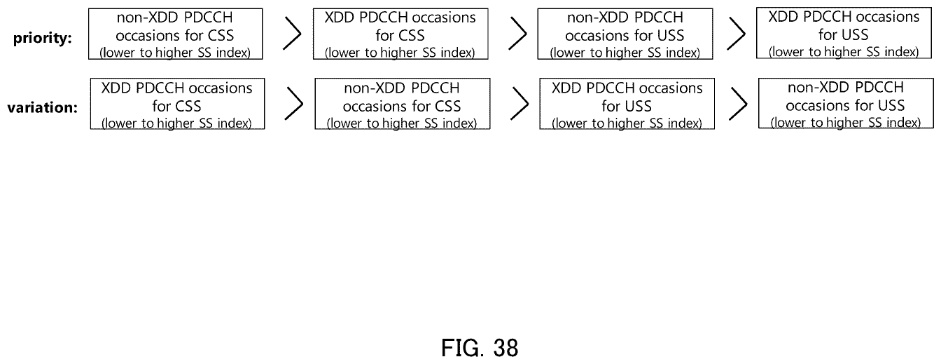

According to the priorities of Option 2-1 of the sixth embodiment and the exemplary variations, an XDD PDCCH monitoring occasion in a CSS set, a non-XDD PDCCH monitoring occasion in a CSS set, an XDD PDCCH monitoring occasion in a USS set and a non-XDD PDCCH monitoring occasion in a USS set may be prioritized as illustrated in FIG. 38.

In Option 2-2 of the sixth embodiment, the prioritization of “a non-XDD PDCCH monitoring occasion has a higher or lower priority than an XDD PDCCH monitoring occasion”→“a CSS has a higher priority than a USS”→“a smaller SS index has a higher priority than a greater SS index” may be applied.

As Option 2-2A of the sixth embodiment, it may not be envisaged that a PDCCH candidate in a non-XDD PDCCH monitoring occasion in a CSS set is dropped. The PDCCH candidates in a non-XDD PDCCH monitoring occasion in a USS set, an XDD PDCCH monitoring occasion in a CSS set and an XDD PDCCH monitoring occasion in a USS set may be dropped based on priorities. For example, a UE may not envisage that the number of PDCCH candidates or non-overlap CCEs in the non-XDD PDCCH monitoring occasion in the CSS set in any slot, span or group of X slots exceeds BD or CCE limits. Also, as one exemplary variation, it may not be envisaged that a PDCCH candidate in an XDD PDCCH monitoring occasion in a CSS set is dropped. The PDCCH candidates in an XDD PDCCH monitoring occasion in a USS set, a non-XDD PDCCH monitoring occasion in a CSS set and a non-XDD PDCCH monitoring occasion in a USS set may be dropped based on priorities.

As Option 2-2B of the sixth embodiment, it may not be envisaged that PDCCH candidates in a non-XDD PDCCH monitoring occasion in a CSS set and a non-XDD PDCCH monitoring occasion in a USS set are dropped. The PDCCH candidates in an XDD PDCCH monitoring occasion in a CSS set and an XDD PDCCH monitoring occasion in a USS set may be dropped based on priorities. For example, a UE may not envisage that the number of PDCCH candidates or non-overlap CCEs in the non-XDD PDCCH monitoring occasion in the CSS set, the non-XDD PDCCH monitoring occasion in the USS set and the XDD PDCCH monitoring occasion in the CSS set in any slot, span or group of X slots exceeds BD or CCE limits. Also, as one exemplary variation, it may not be envisaged that a PDCCH candidate in an XDD PDCCH monitoring occasion in a CSS set and an XDD PDCCH monitoring occasion in a USS set is dropped. The PDCCH candidates in a non-XDD PDCCH monitoring occasion in a CSS set and a non-XDD PDCCH monitoring occasion in a USS set may be dropped based on priorities.

As Option 2-2C of the sixth embodiment, it may not be envisaged that PDCCH candidates in a non-XDD PDCCH monitoring occasion in a CSS set, a non-XDD PDCCH monitoring occasion in a USS set and an XDD PDCCH monitoring occasion in a CSS set are dropped. The PDCCH candidates in an XDD PDCCH monitoring occasion in a USS set may be dropped based on priorities. For example, a UE may not envisage that the number of PDCCH candidates or non-overlap CCEs in the non-XDD PDCCH monitoring occasion in the CSS set, the non-XDD PDCCH monitoring occasion in the USS set and the XDD PDCCH monitoring occasion in the CSS set in any slot, span or group of X slots exceeds BD or CCE limits. Also, as one exemplary variation, it may not be envisaged that a PDCCH candidate in an XDD PDCCH monitoring occasion in a CSS set, an XDD PDCCH monitoring occasion in a USS set and a non-XDD PDCCH monitoring occasion in a CSS set is dropped. The PDCCH candidates in a non-XDD PDCCH monitoring occasion in a USS set may be dropped based on priorities.

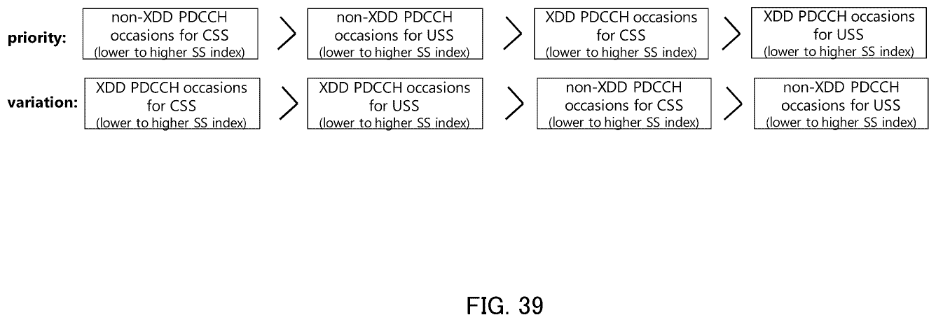

According to the priorities of Option 2-2 of the sixth embodiment and the exemplary variations, the XDD PDCCH monitoring occasion in the CSS set, the non-XDD PDCCH monitoring occasion of the CSS set, the XDD PDCCH monitoring occasion of the USS set and the non-XDD PDCCH monitoring occasion in the USS set may be prioritized as illustrated in FIG. 39.

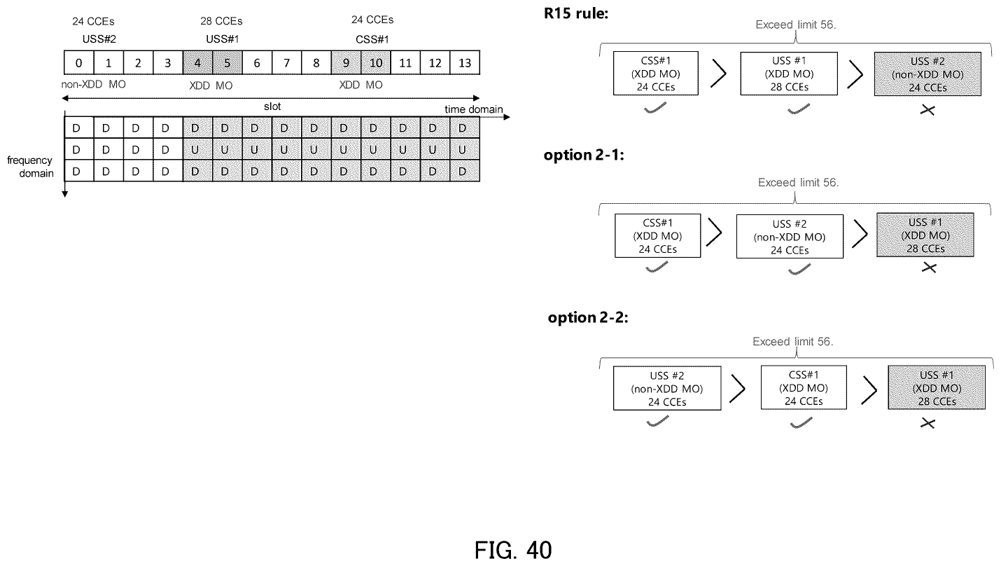

For example, in the symbol arrangement as illustrated in FIG. 40, according to rules in Rel-15, CSS #1 (XDD MO) and USS #1 (XDD MO) may be monitored, and USS #2 (non-XDD MO) may be dropped. Also, according to Option 2-1, CSS #1 (XDD MO) and USS #2 (non-XDD MO) may be monitored, and USS #1 (XDD MO) may be dropped. Also, according to Option 2-2, USS #1 (XDD MO) and CSS #1 (XDD MO) may be monitored, and USS #1 (XDD MO) may be dropped.

In this manner, according to the sixth embodiment, a UE may control the PDCCH overbooking in an XDD time unit where the PDCCH monitoring is configured and select the PDCCH monitoring occasion in accordance with a prioritization at conducting the PDCCH monitoring in the PDCCH monitoring occasion selected in the controlled PDCCH overbooking. In other words, the UE may drop a portion of PDCCH monitoring occasions from the overbooking PDCCH monitoring occasions in accordance with the prioritization.

Specifically, the PDCCH monitoring occasion may be selected based on the first prioritization between a common search space (CSS) and a user specific search space (USS), the second prioritization between a non-XDD search space set (non-XDD SS) and an XDD search space set (XDD SS), and the third prioritization between search space indices (SS index).

Also, the PDCCH monitoring occasion may be selected further based on the fourth prioritization between a non-XDD PDCCH monitoring occasion and an XDD PDCCH monitoring occasion.

The above-stated indication or configuration may be transmitted based on at least one of a RRC (Radio Resource Control) information element, a DCI (Downlink Control Information) and a MAC CE (Medium Access Control Control Element), for example. Also, the present disclosure is not limited to the PDCCH monitoring and may be applied to other types of control signals transmitted from a base station to a UE or other base stations (for example, an IAB node).

In order to implement the above-stated XDD operation, a UE may transmit UE capability information regarding the XDD operation to a base station, and the base station may indicate or configure the XDD operation for the UE based on the received UE capability information. Specifically, if the XDD operation is indicated or configured to a cell, the UE capability information regarding whether to support the PDCCH overbooking on the cell may be defined. If the XDD operation is indicated or configured to a cell, a UE may transmit the UE capability information regarding whether to support the PDCCH overbooking on the cell to a base station.

Also, the UE capability information regarding whether to support the PDCCH overbooking in an XDD slot, an XDD span or an XDD slot group may be defined. A UE may transmit the UE capability information regarding whether to support the PDCCH overbooking in an XDD slot, an XDD span or an XDD slot group to a base station.

Also, the UE capability information regarding whether to support the PDCCH overbooking by considering an XDD SS set (or an XDD PDCCH monitoring occasion) and a non-XDD SS set (or an XDD PDCCH monitoring occasion) may be defined. A UE may transmit the UE capability information regarding whether to support the PDCCH overbooking by considering an XDD SS set (or an XDD PDCCH monitoring occasion) and a non-XDD SS set (or an XDD PDCCH monitoring occasion) to a base station.

According to the sixth embodiment, if the XDD operation is indicated, configured or applied to a cell where the PDCCH monitoring is configured, a UE operation regarding the PDCCH overbooking may be defined.

### Seventh Embodiment

Presently, there is no discussion on a PDCCH monitoring beam in cases where the XDD operation is indicated, configured or applied to a cell where the PDCCH monitoring is configured. To this end, a UE operation regarding the PDCCH monitoring beam in the cases where the XDD operation is indicated, configured or applied to the cell where the PDCCH monitoring is configured must be defined. In other words, the UE may perform operations below for the PDCCH monitoring beam.

In the seventh embodiment, if a UE is configured with a carrier aggregation (CA) operation in a single cell operation or a single frequency band and monitors PDCCH candidates including or overlapping with PDCCH monitoring occasions in multiple CORESETs where the same or different qcl-Types configured to “typeD” property regarding active DL BWPs in one or more cells are configured, the UE may monitor a PDCCH only in a certain CORESET and any other CORESETs from the multiple CORESETs where qcl-Type configured to the same “typeD” property as the certain CORESET on an active DL BWP in a certain one of the one or more cells. If the XDD operation is indicated or configured for any cell, the CORESET may be determined as the CORESET for the SS having the highest priority.

In Option 1 of the seventh embodiment, rules in existing Rel-15/16 may be reused for a prioritization. In other words, the prioritization of “a CSS has a higher priority than a USS”→“a smaller cell index has a higher priority than a greater cell index”→“a smaller SS index has a higher priority than a greater SS index” may be applied. If exists, this CORESET may correspond to the CSS set having the smallest index in a cell having the smallest index and including a CSS, and otherwise may correspond to a USS set having the smallest index in a cell having the smallest index.

In Option 2 of the seventh embodiment, presence of a cell indicated or configured for the XDD operation may be considered for determination.

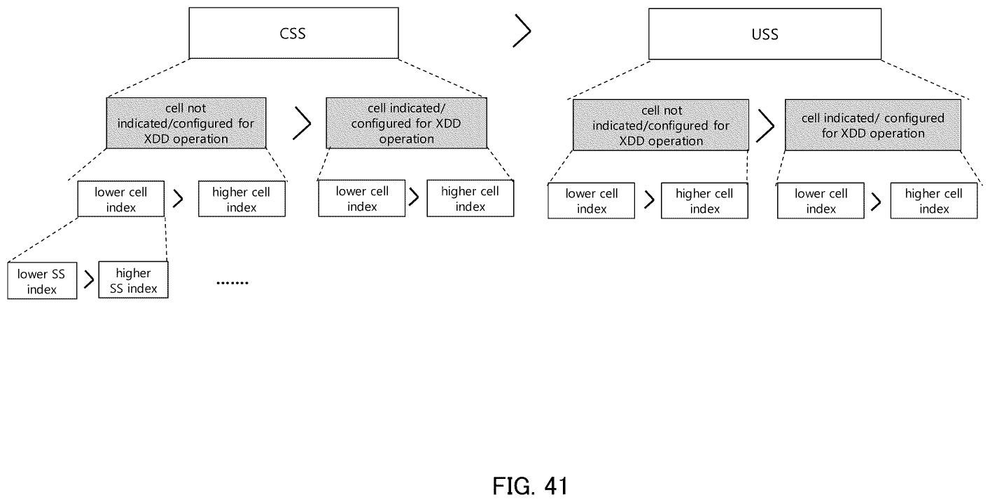

As Option 2-1 of the seventh embodiment, the prioritization of “a CSS has a higher priority than a USS”→“a cell where the XDD operation is not indicated or configured has a higher or lower priority than a cell where the XDD operation is indicated or configured”→“a smaller cell index has a higher priority than a greater cell index” “a smaller SS index has a higher priority than a greater SS index” may be applied as illustrated in FIG. 41.

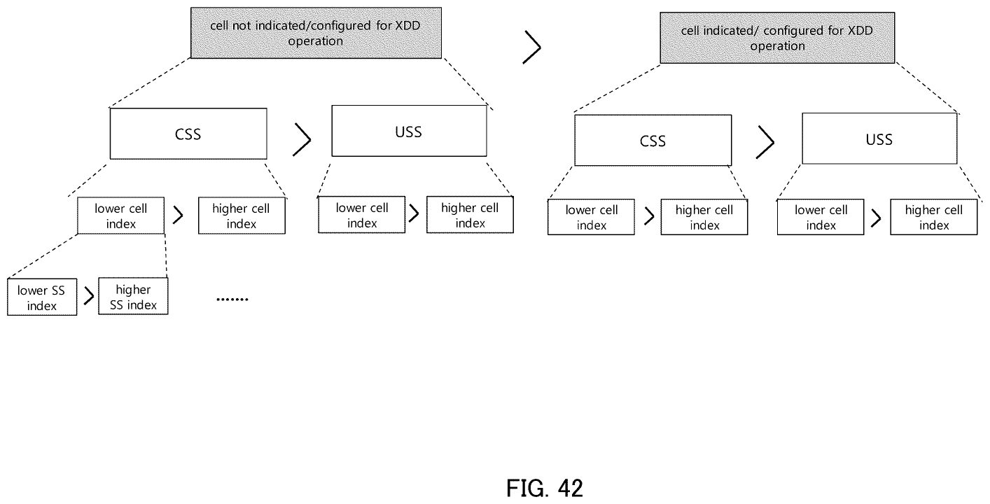

As Option 2-2 of the seventh embodiment, the prioritization of “a cell where the XDD operation is not indicated or configured has a higher or lower priority than a cell where the XDD operation is indicated or configured”→“a CSS has a higher priority than a USS”→“a smaller cell index has a higher priority than a greater cell index”→“a smaller SS index has a higher priority than a greater SS index” may be applied as illustrated in FIG. 42.

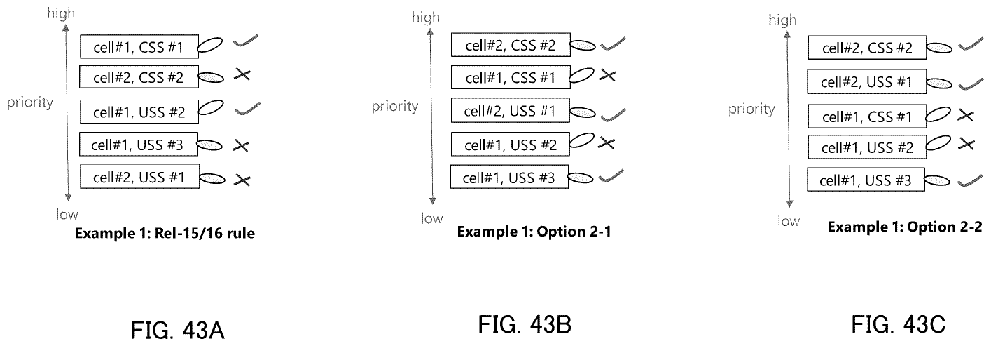

According to the prioritizations of Option 1, Option 2-1 and Option 2-2, five PDCCH monitoring beams of CSS #1 of cell #1, USS #2 of cell #1, USS #3 of cell #1, USS #1 of cell #2 and CSS #2 of cell #2 may be prioritized as illustrated in FIGS. 43A to 43C, for example. Note that the XDD operation is indicated or configured for cell #1 and the XDD operation is not indicated or configured for cell #2.

In FIG. 43A, existing rules in Rel15/16 are applied, and CSS #1 of cell #1, CSS #2 of cell #2, USS #2 of cell #1, USS #3 of cell #1 and USS #1 of cell #2 are prioritized in the descending order of priorities.

In FIG. 43B, the prioritization of Option 2-1 is applied, and CSS #2 of cell #2, CSS #1 of cell #1, USS #1 of cell #2, USS #2 of cell #1 and USS #3 of cell #1 are prioritized in the descending order of priorities.

In FIG. 43C, the prioritization of Option 2-2 is applied, and CSS #2 of cell #2, USS #1 of cell #2, CSS #1 of cell #1, USS #2 of cell #1 and USS #3 of cell #1 are prioritized in the descending order of priorities.

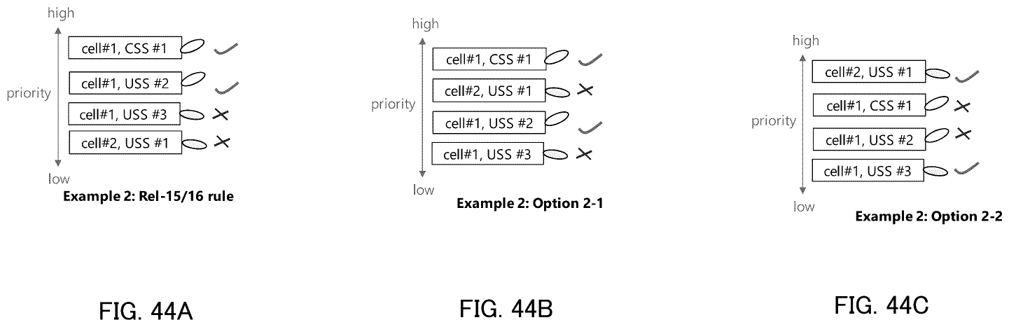

Similarly, according to the prioritizations of Option 1, Option 2-1 and Option 2-2, four PDCCH monitoring beams of CSS #1 of cell #1, USS #2 of cell #1, USS #3 of cell #1 and USS #1 of cell #2 may be prioritized as illustrated in FIGS. 44A to 44C, for example. Note that the XDD operation is indicated or configured for cell #1 and the XDD operation is not indicated or configured for cell #2.

In FIG. 44A, existing rules in Rel-15/16 are applied, and CSS #1 of cell #1, USS #2 of cell #1, USS #3 of cell #1 and USS #1 of cell #2 are prioritized in the descending order of priorities.

In FIG. 44B, the prioritization of Option 2-1 is applied, and CSS #1 of cell #1, USS #1 of cell #2, USS #2 of cell #1 and USS #3 of cell #1 are prioritized in the descending order of priorities.

In FIG. 44C, the prioritization of Option 2-2 is applied, and USS #1 of cell #2, CSS #1 of cell #1, USS #2 of cell #1 and USS #3 of cell #1 are prioritized in the descending order of priorities.

In Option 3 of the seventh embodiment, presence of an XDD SS set or a non-XDD SS set may be considered for determination. Here, the XDD SS set means an SS set where an XDD time unit is configured. Also, the non-XDD SS set means an SS set where a pure time unit is configured.

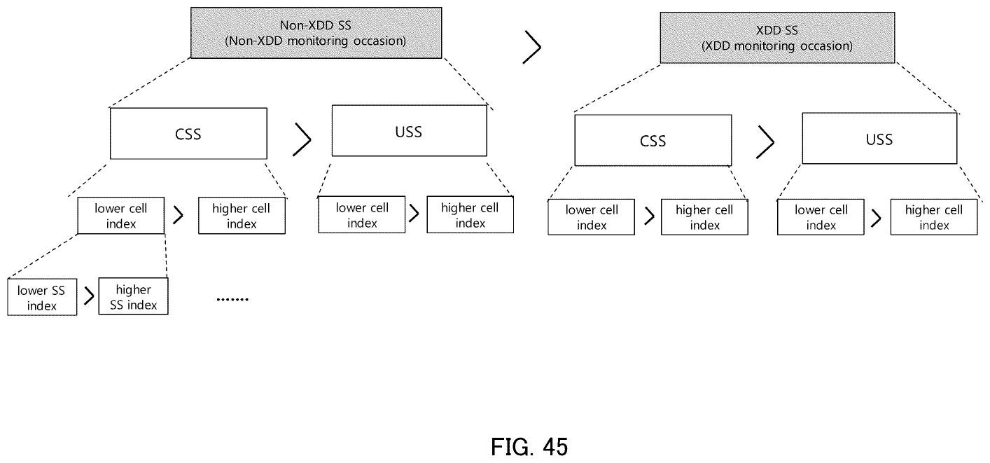

As Option 3-1 of the seventh embodiment, the prioritization of “a non-XDD SS set has a higher or lower priority than an XDD SS set”→“a CSS has a higher priority than a USS”→“a smaller cell index has a higher priority than a greater cell index”→“a smaller SS index has a higher priority than a greater SS index” may be applied as illustrated in FIG. 45.

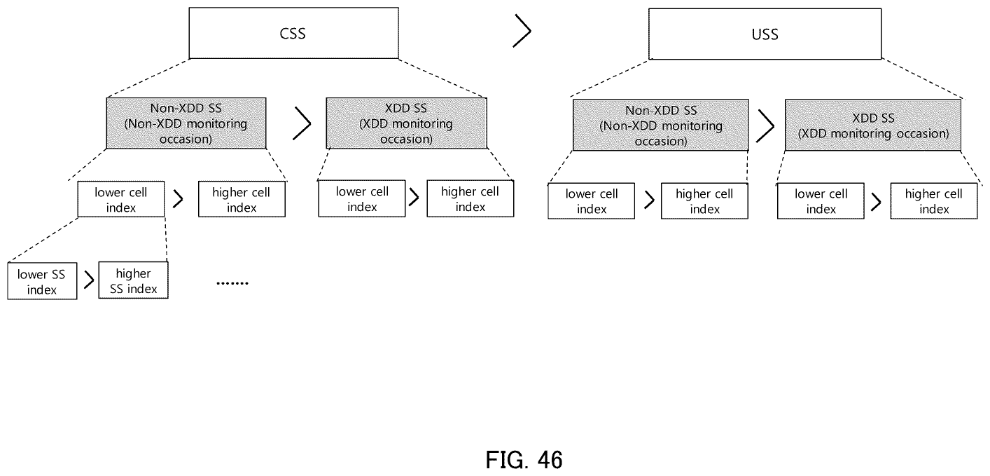

As Option 3-2 of the seventh embodiment, the prioritization of “a CSS has a higher priority than a USS”→“a non-XDD SS set has a higher or lower priority than an XDD SS set”→“a smaller cell index has a higher priority than a greater cell index”→“a smaller SS index has a higher priority than a greater SS index” may be applied as illustrated in FIG. 46.

As one exemplary variation of Option 3-2 of the seventh embodiment, the prioritization of “a CSS has a higher priority than a USS”→“a non-XDD CSS set has a higher or lower priority than an XDD CSS set”→“a smaller cell index has a higher priority than a greater cell index”→“a smaller SS index has a higher priority than a greater SS index” may be applied.

As another exemplary variation of Option 3-2 of the seventh embodiment, the prioritization of “a CSS has a higher priority than a USS”→“a non-XDD USS set has a higher or lower priority than an XDD USS set”→“a smaller cell index has a higher priority than a greater cell index”→“a smaller SS index has a higher priority than a greater SS index” may be applied.

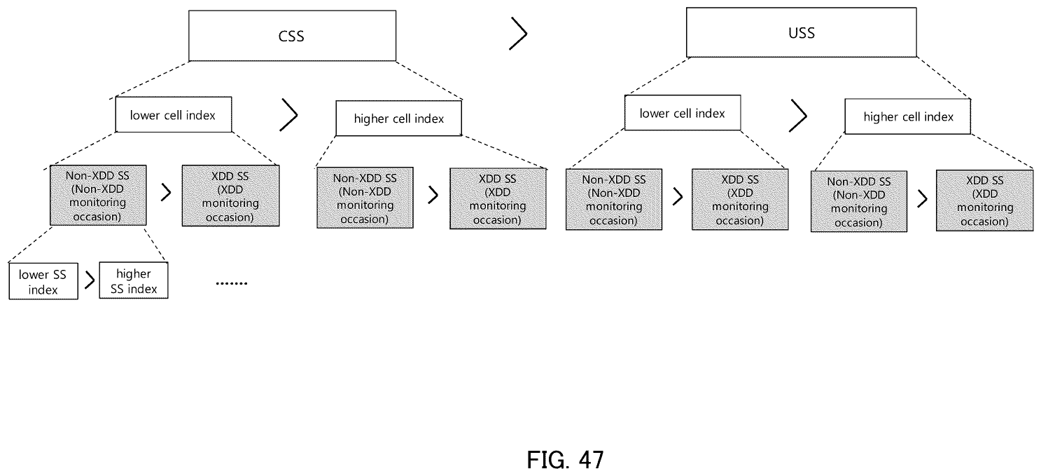

As Option 3-3 of the seventh embodiment, the prioritization of “a CSS has a higher priority than a USS”→“a smaller cell index has a higher priority than a greater cell index”→“a non-XDD SS set has a higher or lower priority than an XDD SS set”→“a smaller SS index has a higher priority than a greater SS index” may be applied as illustrated in FIG. 47.

As one exemplary variation of Option 3-3 of the seventh embodiment, the prioritization of “a CSS has a higher priority than a USS”→“a smaller cell index has a higher priority than a greater cell index”→“a non-XDD CSS set has a higher or lower priority than an XDD CSS set”→“a smaller SS index has a higher priority than a greater SS index” may be applied.

As another exemplary variation of Option 3-3 of the seventh embodiment, the prioritization of “a CSS has a higher priority than a USS”→“a smaller cell index has a higher priority than a greater cell index”→“a non-XDD USS set has a higher or lower priority than an XDD USS set”→“a smaller SS index has a higher priority than a greater SS index” may be applied.

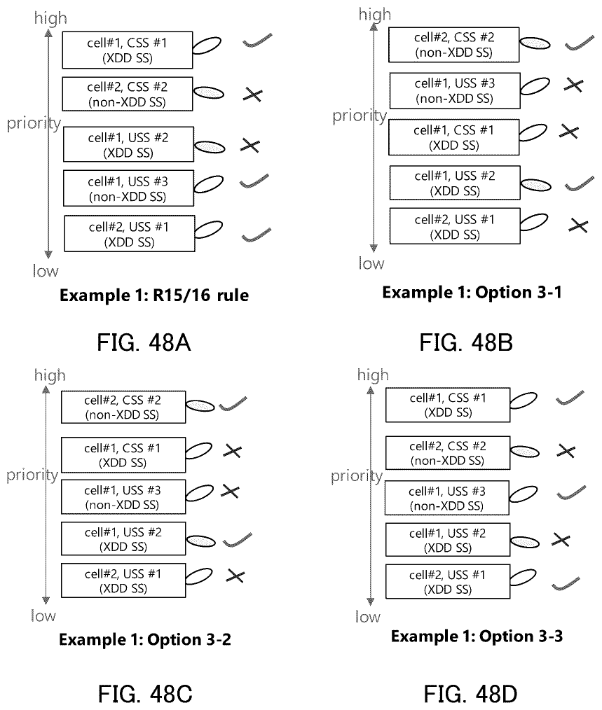

According to the prioritizations of Option 1-1, Option 3-1, 3-2 and 3-3 of the seventh embodiment, five PDCCH monitoring beams of CSS #1 of cell #1, USS #2 of cell #1, USS #3 of cell #1, USS #1 of cell #2 and CSS #2 of cell #2 may be prioritized as illustrated in FIGS. 48A to 48D, for example. Note that CSS #1 of cell #1, USS #2 of cell #1 and USS #1 of cell #2 are XDD SS sets and USS #3 of cell #1 and CSS #2 of cell #2 are non-XDD SS sets.

In FIG. 48A, existing rules in Rel-15/16 are applied, and CSS #1 of cell #1, CSS #2 of cell #2, USS #2 of cell #1, USS #3 of cell #1 and USS #1 of cell #2 are prioritized in the descending order of priorities.

In FIG. 48B, the prioritization of Option 3-1 is applied, and CSS #2 of cell #2, USS #3 of cell #1, CSS #1 of cell #1, USS #2 of cell #1 and USS #1 of cell #2 are prioritized in the descending order of priorities.

In FIG. 48C, the prioritization of Option 3-2 is applied, and CSS #2 of cell #2, CSS #1 of cell #1, USS #3 of cell #1, USS #2 of cell #1 and USS #1 of cell #2 are prioritized in the descending order of priorities.

In FIG. 48D, the prioritization of Option 3-3 is applied, and CSS #1 of cell #1, CSS #2 of cell #2, USS #3 of cell #1, USS #2 of cell #1 and USS #1 of cell #2 are prioritized in the descending order of priorities.

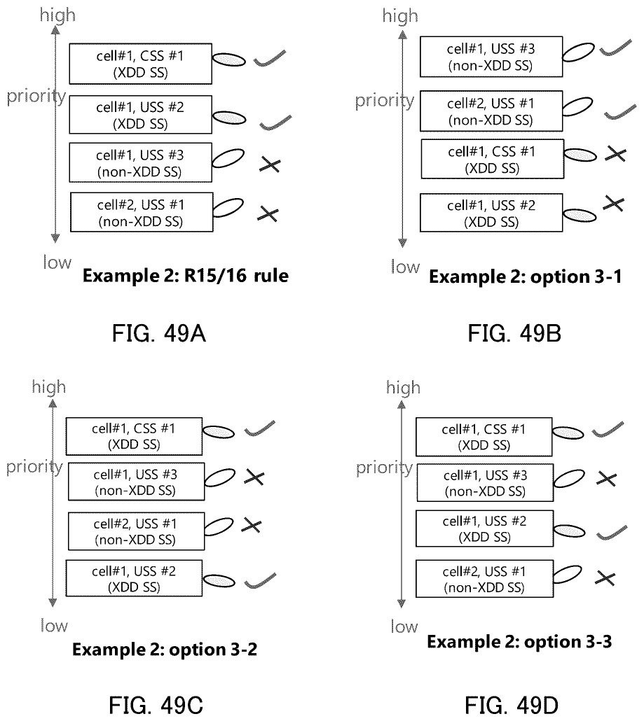

According to the prioritizations of Option 1 and Options 3-1, 3-2 and 3-3 of the seventh embodiment, four PDCCH monitoring beams of CSS #1 of cell #1, USS #2 of cell #1, USS #3 of cell #1 and USS #1 of cell #2 may be prioritized as illustrated in FIGS. 49A to 49D, for example. Note that CSS #1 if cell #1 and USS #2 of cell #1 are XDD SS sets and USS #3 of cell #1 and USS #1 of cell #2 are non-XDD SS sets.

In FIG. 49A, existing rules in Rel-15/16 are applied, and CSS #1 of cell #1, USS #2 of cell #1, USS #3 of cell #1 and USS #1 of cell #2 are prioritized in the descending order of priorities.

In FIG. 49B, the prioritization of Option 3-1 is applied, and USS #3 of cell #1, USS #1 of cell #2, CSS #1 of cell #1 and USS #2 of cell #1 are prioritized in the descending order of priorities.

In FIG. 49C, the prioritization of Option 3-2 is applied, and CSS #1 of cell #1, USS #3 of cell #1, USS #1 of cell #2 and USS #2 of cell #1 are prioritized in the descending order of priorities.

In FIG. 49D, the prioritization of Option 3-3 is applied, and CSS #1 of cell #1, USS #3 of cell #1, USS #2 of cell #1 and USS #1 of cell #2 are prioritized in the descending order of priorities.

In Option 4 of the seventh embodiment, presence of an XDD PDCCH monitoring occasion or a non-XDD PDCCH monitoring occasion may be considered for determination. Here, the XDD PDCCH monitoring occasion means a PDCCH monitoring occasion including or overlapping with an XDD time unit or an XDD symbol. Also, the non-XDD PDCCH monitoring occasion means a PDCCH monitoring occasion that does not include or overlap with an XDD time unit or an XDD symbol.

As Option 4-1 of the seventh embodiment, the prioritization of “a non-XDD PDCCH monitoring occasion has a higher or lower priority than an XDD PDCCH monitoring occasion”→“a CSS has a higher priority than a USS”→“a smaller cell index has a higher priority than a greater cell index”→“a smaller SS index has a higher priority than a greater SS index” may be applied as illustrated in FIG. 45.

As Option 4-2 of the seventh embodiment, the prioritization of “a CSS has a higher priority than a USS”→“a non-XDD PDCCH monitoring occasion has a higher or lower priority than an XDD PDCCH monitoring occasion”→“a smaller cell index has a higher priority than a greater cell index”→“a smaller SS index has a higher priority than a greater SS index” may be applied as illustrated in FIG. 46.

As Option 4-3 of the seventh embodiment, the prioritization of “a CSS has a higher priority than a USS”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied as illustrated in FIG. 47.

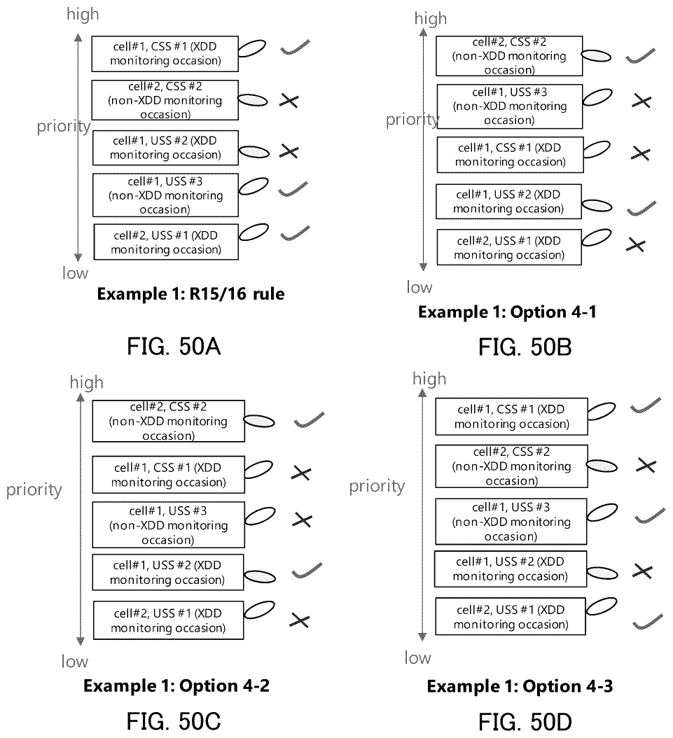

According to the prioritizations of Option 1 and Options 4-1, 4-2 and 4-3 of the seventh embodiment, five PDCCH monitoring beams of CSS #1 of cell #1, USS #2 of cell #1, USS #3 of cell #1, USS #1 of cell #2 and CSS #2 of cell #2 may be prioritized as illustrated in FIGS. 50A to 50D, for example. Note that CSS #1 of cell #1, USS #2 of cell #1 and USS #1 of cell #2 are XDD PDCCH monitoring occasions and USS #3 of cell #1 and CSS #2 of cell #2 are non-XDD PDCCH monitoring occasions.

In FIG. 50A, existing rules in Rel-15/16 are applied, and CSS #1 of cell #1, CSS #2 of cell #2, USS #2 of cell #1, USS #3 of cell #1 and USS #1 of cell #2 are prioritized in the descending order of priorities.

In FIG. 50B, the prioritization of Option 4-1 is applied, and CSS #2 of cell #2, USS #3 of cell #1, CSS #1 of cell #1, USS #2 of cell #1 and USS #1 of cell #2 are prioritized in the descending order of priorities.

In FIG. 50C, the prioritization of Option 4-2 is applied, and CSS #2 of cell #2, CSS #1 of cell #1, USS #3 of cell #1, USS #2 of cell #1 and USS #1 of cell #2 are prioritized in the descending order of priorities.

In FIG. 50D, the prioritization of Option 4-3 is applied, and CSS #1 of cell #1, CSS #2 of cell #2, USS #3 of cell #1, USS #2 of cell #1 and USS #1 of cell #2 are prioritized in the descending order of priorities.

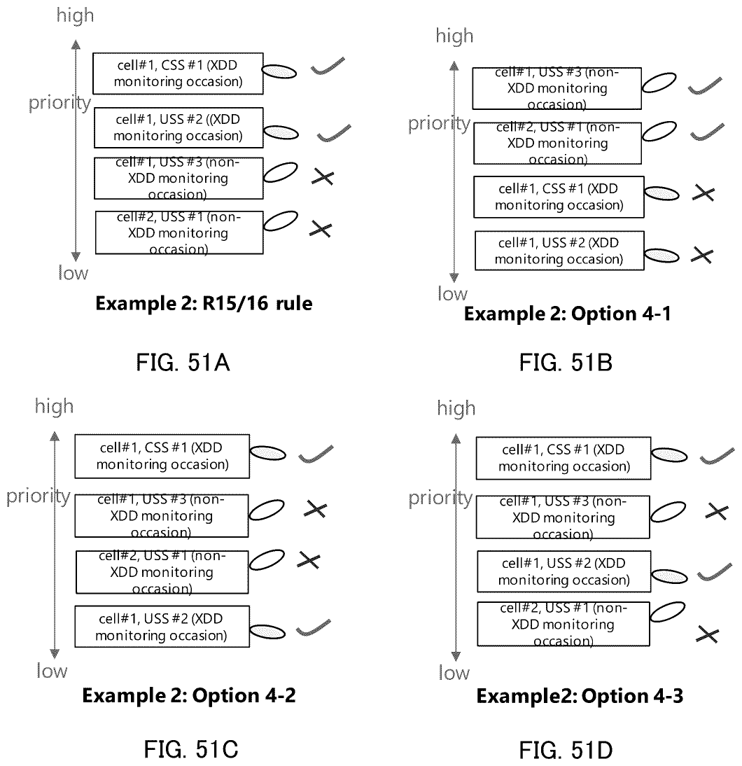

According to the prioritizations of Option 1 and Options 4-1, 4-2 and 4-3 of the seventh embodiment, four PDCCH monitoring beams of CSS #1 of cell #1, USS #2 of cell #1, USS #3 of cell #1 and USS #1 of cell #2 may be prioritized as illustrated in FIGS. 51A to 51D, for example. Note that CSS #1 of cell #1 and USS #2 of cell #1 are XDD PDCCH monitoring occasions and USS #3 of cell #1 and USS #1 of cell #2 are non-XDD PDCCH monitoring occasions.

In FIG. 51A, existing rules in Rel-15/16 are applied, and CSS #1 of cell #1, USS #2 of cell #1, USS #3 of cell #1 and USS #1 of cell #2 are prioritized in the descending order of priorities.

In FIG. 51B, the prioritization of Option 4-1 is applied, and USS #3 of cell #1, USS #1 of cell #2, CSS #1 of cell #1 and USS #2 of cell #1 are prioritized in the descending order of priorities.

In FIG. 51C, the prioritization of Option 4-2 is applied, and CSS #1 of cell #1, USS #3 of cell #1, USS #1 of cell #2 and USS #2 of cell #1 are prioritized in the descending order of priorities.

In FIG. 51D, the prioritization of Option 4-3 is applied, and CSS #1 of cell #1, USS #3 of cell #1, USS #2 of cell #1 and USS #1 of cell #2 are prioritized in the descending order of priorities.

In Option 5 of the seventh embodiment, presence of a cell where the XDD operation is indicated or configured and presence of an XDD SS set or a non-XDD SS set may be considered for determination. In other words, Option 5 is a combination of Option 2 and Option 3.

As Option 5-1 of the seventh embodiment, the prioritization of “a cell where the XDD operation is not indicated or configured has a higher or lower priority than a cell where the XDD operation is indicated or configured”→“a non-XDD SS set has a higher or lower priority than an XDD SS set”→“a CSS has a higher priority than a USS”-“a smaller cell index has a higher priority than a greater cell index”→“a smaller SS index has a higher priority than a greater SS index” may be applied.

As Option 5-2 of the seventh embodiment, the prioritization of “a cell where the XDD operation is not indicated or configured has a higher or lower priority than a cell where the XDD operation is indicated or configured”→“a CSS has a higher priority than a USS”→“a non-XDD SS set has a higher or lower priority than an XDD SS set”→“a smaller cell index has a higher priority than a greater cell index”→“a smaller SS index has a higher priority than a greater SS index” may be applied.

As one exemplary variation of Option 5-2 of the seventh embodiment, the prioritization of “a cell where the XDD operation is not indicated or configured has a higher or lower priority than a cell where the XDD operation is indicated or configured”→“a CSS has a higher priority than a USS”→“a non-XDD CSS/USS set has a higher or lower priority than an XDD CSS/USS set”→“a smaller cell index has a higher priority than a greater cell index”→“a smaller SS index has a higher priority than a greater SS index” may be applied.

As Option 5-3 of the seventh embodiment, the prioritization of “a cell where the XDD operation is not indicated or configured has a higher or lower priority than a cell where the XDD operation is indicated or configured”→“a CSS has a higher priority than a USS”→“a smaller cell index has a higher priority than a greater cell index”→“a non-XDD SS set has a higher or lower priority than an XDD SS set”→“a smaller SS index has a higher priority than a greater SS index” may be applied.

As one exemplary variation of Option 5-3 of the seventh embodiment, the prioritization of “a cell where the XDD operation is not indicated or configured has a higher or lower priority than a cell where the XDD operation is indicated or configured”→“a CSS has a higher priority than a USS”→“a smaller cell index has a higher priority than a greater cell index”→“a non-XDD CSS/USS set has a higher or lower priority than an XDD CSS/USS set”→“a smaller SS index has a higher priority than a greater SS index” may be applied.

As Option 5-4 of the seventh embodiment, the prioritization of “a CSS has a higher priority than a USS”→“a cell where the XDD operation is not indicated or configured has a higher or lower priority than a cell where the XDD operation is indicated or configured”→“a non-XDD SS set has a higher or lower priority than an XDD SS set”→“a smaller cell index has a higher priority than a greater cell index”→“a smaller SS index has a higher priority than a greater SS index” may be applied.

As one exemplary variation of Option 5-4 of the seventh embodiment, the prioritization of “a CSS has a higher priority than a USS”→“a cell where the XDD operation is not indicated or configured has a higher or lower priority than a cell where the XDD operation is indicated or configured”→“a non-XDD CSS/USS set has a higher or lower priority than an XDD CSS/USS set”→“a smaller cell index has a higher priority than a greater cell index”→“a smaller SS index has a higher priority than a greater SS index” may be applied.

As Option 5-5 of the seventh embodiment, the prioritization of “a CSS has a higher priority than a USS”→“a cell where the XDD operation is not indicated or configured has a higher or lower priority than a cell where the XDD operation is indicated or configured”→“a smaller cell index has a higher priority than a greater cell index”→“a non-XDD SS set has a higher or lower priority than an XDD SS set”→“a smaller SS index has a higher priority than a greater SS index” may be applied.

As one exemplary variation of Option 5-5 of the seventh embodiment, the prioritization of “a CSS has a higher priority than a USS”→“a cell where the XDD operation is not indicated or configured has a higher or lower priority than a cell where the XDD operation is indicated or configured”→“a smaller cell index has a higher priority than a greater cell index”→“a non-XDD CSS/USS set has a higher or lower priority than an XDD CSS/USS set”→“a smaller SS index has a higher priority than a greater SS index” may be applied.

In Option 6 of the seventh embodiment, presence of an XDD SS set or a non-XDD SS set and presence of an XDD PDCCH monitoring occasion or a non-XDD PDCCH monitoring occasion may be considered for determination. In other words, Option 6 is a combination of Option 3 and Option 4.

As Option 6-1 of the seventh embodiment, the prioritization of “a non-XDD SS set has a higher or lower priority than an XDD SS set”→“a non-XDD PDCCH monitoring occasion has a higher or lower priority than an XDD PDCCH monitoring occasion”→“a CSS has a higher priority than a USS”→“a smaller cell index has a higher priority than a greater cell index”→“a smaller SS index has a higher priority than a greater SS index” may be applied.

As Option 6-2 of the seventh embodiment, the prioritization of “a non-XDD SS set has a higher or lower priority than an XDD SS set”→“a CSS has a higher priority than a USS”→“a smaller cell index has a higher priority than a greater cell index”→“a smaller SS index has a higher priority than a greater SS index” may be applied.

As Option 6-3 of the seventh embodiment, the prioritization of “a non-XDD SS set has a higher or lower priority than an XDD SS set”→“a CSS has a higher priority than a USS”→“a smaller cell index has a higher priority than a greater cell index”-“a non-XDD PDCCH monitoring occasion has a higher or lower priority than an XDD PDCCH monitoring occasion”→“a smaller SS index has a higher priority than a greater SS index” may be applied.

As Option 6-4 of the seventh embodiment, the prioritization of “a CSS has a higher priority than a USS”→“a non-XDD SS set has a higher or lower priority than an XDD SS set”→“a non-XDD PDCCH monitoring occasion has a higher or lower priority than an XDD PDCCH monitoring occasion”→“a smaller cell index has a higher priority than a greater cell index”→“a smaller SS index has a higher priority than a greater SS index” may be applied.

As one exemplary variation of Option 6-4 of the seventh embodiment, the prioritization of “a CSS has a higher priority than a USS”→“a non-XDD CSS/USS set has a higher or lower priority than an XDD CSS/USS set”→“a non-XDD PDCCH monitoring occasion has a higher or lower priority than an XDD PDCCH monitoring occasion”→“a smaller cell index has a higher priority than a greater cell index”→“a smaller SS index has a higher priority than a greater SS index” may be applied.

As Option 6-5 of the seventh embodiment, the prioritization of “a CSS has a higher priority than a USS”→“a non-XDD SS set has a higher or lower priority than an XDD SS set”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied.

As one exemplary variation of Option 6-5 of the seventh embodiment, the prioritization of “a CSS has a higher priority than a USS”→“a non-XDD CSS/USS set has a higher or lower priority than an XDD CSS/USS set”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied.

As Option 6-6 of the seventh embodiment, the prioritization of “a CSS has a higher priority than a USS”→“a smaller cell index has a higher priority than a greater cell index”→“a non-XDD SS set has a higher or lower priority than an XDD SS set”→“a non-XDD PDCCH monitoring occasion has a higher or lower priority than an XDD PDCCH monitoring occasion”→“a smaller SS index has a higher priority than a greater SS index” may be applied.

As one exemplary variation of Option 6-6 of the seventh embodiment, the prioritization of “a CSS has a higher priority than a USS”→“a smaller cell index has a higher priority than a greater cell index”→“a non-XDD CSS/USS set has a higher or lower priority than an XDD CSS/USS set”→“a non-XDD PDCCH monitoring occasion has a higher or lower priority than an XDD PDCCH monitoring occasion”→“a smaller SS index has a higher priority than a greater SS index” may be applied.

In Option 7 of the seventh embodiment, presence of a cell where the XDD operation is indicated or configured and presence of an XDD PDCCH monitoring occasion or a non-XDD PDCCH monitoring occasion may be considered for determination. In other words, Option 7 is a combination of Option 2 and Option 4.

As Option 7-1 of the seventh embodiment, the prioritization of “a cell where the XDD operation is not indicated or configured has a higher or lower priority than a cell where the XDD operation is indicated or configured”→“a non-XDD PDCCH monitoring occasion has a higher or lower priority than an XDD PDCCH monitoring occasion”→“a CSS has a higher priority than a USS”→“a smaller cell index has a higher priority than a greater cell index”→“a smaller SS index has a higher priority than a greater SS index” may be applied.

As Option 7-2 of the seventh embodiment, the prioritization of “a cell where the XDD operation is not indicated or configured has a higher or lower priority than a cell where the XDD operation is indicated or configured”→“a CSS has a higher priority than a USS”→“a non-XDD PDCCH monitoring occasion has a higher or lower priority than an XDD PDCCH monitoring occasion”→“a smaller cell index has a higher priority than a greater cell index”→“a smaller SS index has a higher priority than a greater SS index” may be applied.

As Option 7-3 of the seventh embodiment, the prioritization of “a cell where the XDD operation is not indicated or configured has a higher or lower priority than a cell where the XDD operation is indicated or configured”→“a CSS has a higher priority than a USS”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied.

As Option 7-4 of the seventh embodiment, the prioritization of “a CSS has a higher priority than a USS”→“a cell where the XDD operation is not indicated or configured has a higher or lower priority than a cell where the XDD operation is indicated or configured”→“a non-XDD PDCCH monitoring occasion has a higher or lower priority than an XDD PDCCH monitoring occasion”→“a smaller cell index has a higher priority than a greater cell index”→“a smaller SS index has a higher priority than a greater SS index” may be applied.

As Option 7-5 of the seventh embodiment, the prioritization of “a CSS has a higher priority than a USS”→“a cell where the XDD operation is not indicated or configured has a higher or lower priority than a cell where the XDD operation is indicated or configured”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied.

In Option 8 of the seventh embodiment, presence of a cell where the XDD operation is indicated or configured, presence of an XDD SS set or a non-XDD SS set, and presence of an XDD PDCCH monitoring occasion or a non-XDD PDCCH monitoring occasion may be considered for determination. In other words, Option 8 is a combination of Option 2, Option 3 and Option 4.

As Option 8-1 of the seventh embodiment, the prioritization of “a cell where the XDD operation is not indicated or configured has a higher or lower priority than a cell where the XDD operation is indicated or configured”→“a non-XDD SS set has a higher or lower priority than an XDD SS set”→“a non-XDD PDCCH monitoring occasion has a higher or lower priority than an XDD PDCCH monitoring occasion”→“a CSS has a higher priority than a USS”→“a smaller cell index has a higher priority than a greater cell index”→“a smaller SS index has a higher priority than a greater SS index” may be applied.

As Option 8-2 of the seventh embodiment, the prioritization of “a cell where the XDD operation is not indicated or configured has a higher or lower priority than a cell where the XDD operation is indicated or configured”→“a non-XDD SS set has a higher or lower priority than an XDD SS set”→“a CSS has a higher priority than a USS”→“a smaller cell index has a higher priority than a greater cell index”→“a smaller SS index has a higher priority than a greater SS index” may be applied.

As Option 8-3 of the seventh embodiment, the prioritization of “a cell where the XDD operation is not indicated or configured has a higher or lower priority than a cell where the XDD operation is indicated or configured”→“a non-XDD SS set has a higher or lower priority than an XDD SS set”→“a CSS has a higher priority than a USS”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied.

As Option 8-4 of the seventh embodiment, the prioritization of “a cell where the XDD operation is not indicated or configured has a higher or lower priority than a cell where the XDD operation is indicated or configured”→“a CSS has a higher priority than a USS”→“a non-XDD SS set has a higher or lower priority than an XDD SS set”→“a non-XDD PDCCH monitoring occasion has a higher or lower priority than an XDD PDCCH monitoring occasion”→“a smaller cell index has a higher priority than a greater cell index”→“a smaller SS index has a higher priority than a greater SS index” may be applied.

As Option 8-5 of the seventh embodiment, the prioritization of “a CSS has a higher priority than a USS”→“a cell where the XDD operation is not indicated or configured has a higher or lower priority than a cell where the XDD operation is indicated or configured”→“a smaller cell index has a higher priority than a greater cell index”→“a non-XDD SS set has a higher or lower priority than an XDD SS set”→“a non-XDD PDCCH monitoring occasion has a higher or lower priority than an XDD PDCCH monitoring occasion”→“a smaller SS index has a higher priority than a greater SS index” may be applied.

As Option 8-6 of the seventh embodiment, the prioritization of “a cell where the XDD operation is not indicated or configured has a higher or lower priority than a cell where the XDD operation is indicated or configured”→“a CSS has a higher priority than a USS”→“a non-XDD SS set has a higher or lower priority than an XDD SS set”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied.

As Option 8-7 of the seventh embodiment, the prioritization of “a CSS has a higher priority than a USS”→“a cell where the XDD operation is not indicated or configured has a higher or lower priority than a cell where the XDD operation is indicated or configured”→“a non-XDD SS set has a higher or lower priority than an XDD SS set”→“a smaller cell index has a higher priority than a greater cell index”→“a non-XDD PDCCH monitoring occasion has a higher or lower priority than an XDD PDCCH monitoring occasion”→“a smaller SS index has a higher priority than a greater SS index” may be applied.

As Option 8-8 of the seventh embodiment, the prioritization of “a cell where the XDD operation is not indicated or configured has a higher or lower priority than a cell where the XDD operation is indicated or configured”→“a CSS has a higher priority than a USS”→“a smaller cell index has a higher priority than a greater cell index”-+“a non-XDD SS set has a higher or lower priority than an XDD SS set”→“a non-XDD PDCCH monitoring occasion has a higher or lower priority than an XDD PDCCH monitoring occasion”→“a smaller SS index has a higher priority than a greater SS index” may be applied.

As Option 8-9 of the seventh embodiment, the prioritization of “a CSS has a higher priority than a USS”→“a cell where the XDD operation is not indicated or configured has a higher or lower priority than a cell where the XDD operation is indicated or configured”→“a smaller cell index has a higher priority than a greater cell index”→“a non-XDD SS set has a higher or lower priority than an XDD SS set”→“a non-XDD PDCCH monitoring occasion has a higher or lower priority than an XDD PDCCH monitoring occasion”→“a smaller SS index has a higher priority than a greater SS index” may be applied.

In this manner, according to the seventh embodiment, a UE may select a PDCCH monitoring beam in an XDD time unit where PDCCH monitoring is configured and perform the PDCCH monitoring for the selected PDCCH monitoring beam. Correspondingly, a base station may control the PDCCH monitoring beam in the XDD time unit where the PDCCH monitoring is configured and transmit control information with the PDCCH monitoring beam.

Specifically, the UE may select the PDCCH monitoring beam in accordance with prioritizations.

Also, a PDCCH monitoring beam may be selected based on a first prioritization between a common search space (CSS) and a user specific search space (USS), a second prioritization among cell indices, and a third prioritization among search space indices (SS indices).

Also, the PDCCH monitoring beam may be selected further based on one or more of a fourth prioritization between a cell where the XDD operation is indicated or configured and a cell where the XDD operation is not indicated or configured, a fifth prioritization between a non-XDD search space (non-XDD SS) set and an XDD search space (XDD SS) set, and a sixth prioritization between a non-XDD PDCCH monitoring occasion and an XDD PDCCH monitoring occasion.

The above-stated indication or configuration may be transmitted based on at least one of a RRC (Radio Resource Control) information element, a DCI (Downlink Control Information) and a MAC CE (Medium Access Control Control Element), for example. Also, the present disclosure is not limited to the PDCCH monitoring and may be applied to other types of control signals transmitted from a base station to a UE or other base stations (for example, an IAB node).

In order to implement the above-stated XDD operation, a UE may transmit UE capability information regarding the XDD operation to a base station, and the base station may indicate or configure the XDD operation for the UE based on the received UE capability information. Specifically, the UE capability information regarding whether to support determination of a TC state for PDCCH monitoring including or overlapping with a PDCCH monitoring occasion by considering whether the XDD operation is indicated or configured for a cell, whether an XDD SS set or a non-XDD SS set is present, and/or whether an XDD PDCCH monitoring occasion is present may be defined. A UE may transmit the UE capability information regarding whether to support determination of a TCI state for PDCCH monitoring including or overlapping with a PDCCH monitoring occasion by considering whether the XDD operation is indicated or configured for a cell, whether an XDD SS set or a non-XDD SS set is present, and/or whether an XDD PDCCH monitoring occasion is present to a base station.

According to the seventh embodiment, if the XDD operation is indicated, configured or applied to a cell where the PDCCH monitoring is configured, UE operations regarding PDCCH monitoring beams can be defined.

For the above-stated embodiments, applied embodiments, options and/or operations may be indicated or configured by an upper layer parameter, may be indicated or reported by a UE as the UE capability information, may be defined in specifications, or may be determined by a configuration of the upper layer parameter and the reported UE capability information.

### (Hardware Configuration)

Note that, the block diagrams used to describe the above embodiment illustrate blocks on the basis of functions. These functional blocks (components) are implemented by any combination of at least hardware or software items. Implementation manners of the functional blocks are not particularly limited. That is, the functional blocks may be implemented using one physically or logically coupled apparatus. Also, two or more physically or logically separate apparatuses may be directly or indirectly connected (for example, via wires or in the air), and the plurality of apparatuses may be used to implement the functional blocks. The functional blocks may be implemented by combining software items with the one apparatus or the plurality of apparatuses described above.

The functions may include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component) that functions to achieve transmission is referred to as “a transmitting unit” or “a transmitter”. The implementation manners of the functions are not particularly limited as described above.

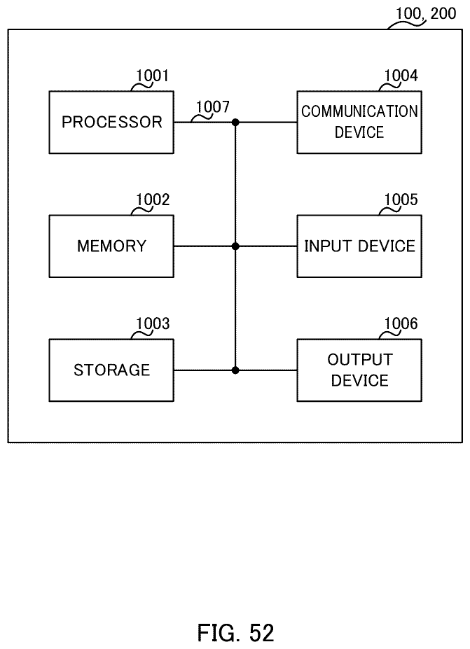

For example, a base station, a user terminal and the like according to one embodiment of the present disclosure may function as a computer that executes processing of radio communication methods of the present disclosure. FIG. 52 illustrates an exemplary hardware arrangement of the base station and the user terminal according to one embodiment of the present disclosure. The base station 10 and the user terminal 20 as stated above may be physically arranged as a computer device including a processor 1001, a memory 1002, a storage 1003, a communication device 1004, an input device 1005, an output device 1006, a bus 1007, and the like.

Note that the term “apparatus” in the following description can be replaced with a circuitry, a device, a unit, or the like. The hardware arrangements of the base station 10 and the user terminal 20 may include one or more of the devices illustrated in FIG. 52 or may not include a part of the devices.

The functions of the base station 10 and the user terminal 20 may be implemented by predetermined software items (programs) loaded into a hardware item, such as the processor 1001, the memory 1002, and the like, to cause the processor 1001 to perform an operation or control communication by the communication device 1004 or at least one of reading and writing of data from/in the memory 1002 and the storage 1003.

The processor 1001 executes an operating system to control the entire computer, for example. The processor 1001 may be composed of a central processing unit (CPU) including an interface with peripheral devices, a controller, an arithmetic device, a register, and the like. For example, the baseband signal processing unit 104, the call processing unit 105 and the like as described above may be implemented using the processor 1001.

Also, the processor 1001 loads a program (program code), a software module, data, and the like from at least one of the storage 1003 and the communication device 1004 to the memory 1002 and performs various types of processing in accordance with the program (program code), the software module, the data, and the like. As the program, a program for causing the computer to perform at least a part of the operations described in the above embodiments may be used. For example, the control unit 401 of the user terminal 20 may be implemented using a control program stored in the memory 1002 and executed by the processor 1001, and the other functional blocks may also be implemented similarly. While it has been described that the various types of processing as described above may be performed by the single processor 1001, the various types of processing may be performed by the two or more processors 1001 in parallel or sequentially. The processor 1001 may be implemented using one or more chips. Note that the program may be transmitted from a network through a telecommunication line.

The memory 1002 is a computer-readable storage medium and may be composed of, for example, at least one of a Read Only Memory (ROM), an Erasable Programmable ROM (EPROM), an Electrically Erasable Programmable ROM (EEPROM), and a Random Access Memory (RAM). The memory 1002 may be called as a register, a cache, a main memory (main storage device), or the like. The memory 1002 can save a program (program code), a software module, and the like that can be executed to perform a radio communication method according to one embodiment of the present disclosure.

The storage 1003 is a computer-readable storage medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may also be called as an auxiliary storage device. The storage medium as described above may be, for example, a database, a server, or other appropriate media including at least one of the memory 1002 and the storage 1003.

The communication device 1004 is hardware (transceiver device) for communication between computers through at least one of wired and wireless networks and is also called as, for example, a network device, a network controller, a network card, or a communication module. The communication device 1004 may be configured to include a high frequency switch, a duplexer, a filter, a frequency synthesizer, and the like in order to achieve at least one of Frequency Division Duplex (FDD) and Time Division Duplex (TDD), for example. For example, a transmission and reception antenna 101, an amplification unit 102, a transmission and reception unit 103, a channel interface 106 and the like as stated above may be implemented using the communication device 1004. The transmission and reception unit 103 may be implemented as being physically or logically separated into a transmission unit 103a and a reception unit 103b.

The input device 1005 is an input device (for example, a keyboard, a mouse, a microphone, a switch, a button, or a sensor) that receives inputs from the outside. The output device 1006 is an output device (for example, a display, a speaker, or an LED lamp) which feeds outputs to the outside. Note that the input device 1005 and the output device 1006 may be integrated (for example, a touch panel).

Also, the respective devices, such as the processor 1001, the memory 1002, and the like are connected by the bus 1007 for communication of information. The bus 1007 may be arranged using a single bus or using buses different between each pair of the devices.

Also, the base station 10 and the user terminal 20 may be arranged to include hardware items such as a microprocessor, a digital signal processor (DSP), an application specific integrated circuit (ASIC), a programmable logic device (PLD), a field programmable gate array (FPGA) and the like, and a portion or all of the respective functional blocks may be implemented by the hardware items. For example, the processor 1001 may be implemented using at least one of these hardware items.

Indication of information is not limited to the aspects or embodiments described in the present disclosure, and the information may be indicated in other manners. For example, information may be indicated or signaled by a physical layer signaling (for example, Downlink Control Information (DCI) and Uplink Control Information (UCI)), upper layer signaling (for example, Radio Resource Control (RRC) signaling, Medium Access Control (MAC) signaling, broadcast information (Master Information Block (MIB), and System Information Block (SIB))) or other signals or combinations thereof. Also, the RRC signaling may be referred to as an RRC message and may be, for example, an RRC connection setup message, an RRC connection reconfiguration message, or the like.

The aspects and embodiments described in the present disclosure may be applied to at least one of systems using Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark) or other appropriate systems and a next-generation system enhanced based on the above systems. Also, combinations of multiple systems (e.g., a combination of at least LTE or LTE-A and 5G) may be applied.

The orders of the processing procedures, the sequences, the flow charts, and the like of the aspects and embodiments described in the present disclosure may be changed as long as there is no contradiction. For example, for the methods described in the present disclosure, elements of various steps are presented in exemplary orders, but the methods are not limited to the presented specific orders.

In some cases, specific operations which are described in the present disclosure as being performed by a base station may be performed by an upper node. Various operations performed for communication with a terminal in a network constituted by one or more network nodes including the base station can be obviously performed by at least one of the base station and a network node other than the base station (for examples, an MME or a S-GW, but not limited to, may be conceived). Although the case where there is one network node in addition to the base station has been illustrated above, a plurality of other network nodes may be combined (for example, an MME and an S-GW).

Information and the like (the item “information and signaling” may be referred to) can be fed from a higher layer (or a lower layer) to a lower layer (or a higher layer). The information and the like may be fed in or out through a plurality of network nodes.

Input and output information and the like may be saved in a specific place (for example, a memory) or may be managed using a management table. The input and output information and the like can be overwritten, updated, or additionally written. The output information and the like may be deleted. The input information and the like may be transmitted to another apparatus.

Determination may be made based on a value represented by one bit (0 or 1), based on a Boolean value (true or false), or based on comparison with a numerical value (for example, comparison with a predetermined value).

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, if the software is transmitted from a website, a server, or another remote source by using at least one of a wired technique (e.g., a coaxial cable, an optical fiber cable, a twisted pair, and a digital subscriber line (DSL)) and a wireless technique (e.g., an infrared ray and a microwave), the at least one of the wired technique and the wireless technique is included in the definition of the transmission medium.

The information, the signals, and the like described in the present disclosure may be represented by using any of various different techniques. For example, data, instructions, commands, information, signals, bits, symbols, chips, and the like that may be mentioned throughout the above description may be represented by voltage, current, electromagnetic waves, magnetic fields, magnetic particles, optical fields or photons or arbitrary combinations thereof.

Note that terminologies described in the present disclosure and terminologies necessary to understand the present disclosure may be replaced with those having the same or similar meaning. For example, at least one of channels and symbols may be a signal (signaling). The signal may be a message. Also, a component carrier (CC) may be called a carrier frequency, a cell, a frequency carrier, or the like.

The terms “system” and “network” used in the present disclosure can be interchangeably used.

Information, parameters, and the like described in the present disclosure may be represented using an absolute value, using a value relative to a predetermined value, or using other corresponding information. For example, radio resources may be indicated by indices.

The names used for the above-stated parameters are not limitative in any respect. Furthermore, the numerical formulas and the like using the parameters may be different from the ones explicitly disclosed in the present disclosure. Various channels (for example, a PUCCH and a PDCCH) and information elements can be identified by any suitable names, and various names assigned to these various channels and information elements are not limitative in any respect.

In the present disclosure, the terms “Base Station (BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” may be used interchangeably. The base station may be referred to as a macro cell, a small cell, a femtocell, a pico cell or the like.

The base station can accommodate one or more (for example, three) cells. If the base station accommodates a plurality of cells, the entire coverage area of the base station can be divided into a plurality of smaller areas, and each of the smaller areas can provide a communication service based on a base station subsystem (for example, a remote radio head (RRH) serving as an indoor small base station). The term “cell” or “sector” denotes a part or all of the coverage area of at least one of the base station and the base station subsystem that perform a communication service in the coverage.

In the present disclosure, transmission of information from a base station to a terminal may be replaced with instructions of control and operation from the base station to the terminal based on the information.

In the present disclosure, the terms “Mobile Station (MS)”, “user terminal”, “User Equipment (UE)”, “terminal” and the like may be used interchangeably.

The mobile station may be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terminologies.

At least one of a base station and a mobile station may be referred to as a transmitter, a receiver, a communication apparatus, or the like. Note that at least one of the base station and the mobile station may be a device mounted in a mobility, the mobility itself, or the like. The mobility may be, but not limited to, a vehicle, a transport vehicle, an automobile, a motorcycles, a bicycle, a connected car, an excavator, a bulldozer, a wheel loader, a dump truck, a forklift, a train, a bus, a rear carriage, a rickshaw, a ship (ship and other watercraft), an aircraft, a rocket, a satellite, a drone (registered trademark), a multicopter, a quadcopter, a balloon, and articles mounted thereon. The mobility may also be a mobile entity that runs autonomously based on operational commands. It may be a vehicle (e.g., car, airplane, etc.), an unmanned moving vehicle (e.g., drone, self-driving car, etc.), or a robot (manned or unmanned). Note that at least one of the base station and the mobile station may also include an apparatus that does not necessarily move during communication operation. For example, at least one of the base station and the mobile station may be an Internet-of-Things (IoT) equipment such as a sensor.

Also, the base station in the present disclosure may be interchanged with the user terminal. For example, the aspects and the embodiments of the present disclosure may be applied to an arrangement where communications between the base station and the user terminal is replaced with communications between multiple user terminals (for example, such communication may be referred to as device-to-device (D2D), vehicle-to-everything (V2X), or the like). In this case, the terminal 20 may be configured to have the same functionalities as those of the above-stated base station 10. Also, the wordings “uplink” and “downlink” may be replaced with corresponding wordings for inter-terminal communication (for example, “side”). For example, an uplink channel, a downlink channel, and the like may be replaced with a side channel.

Similarly, a terminal in the present disclosure may be replaced with a base station. In this case, the base station 10 is configured to have the same functionalities as those of the above-stated user terminal 20.

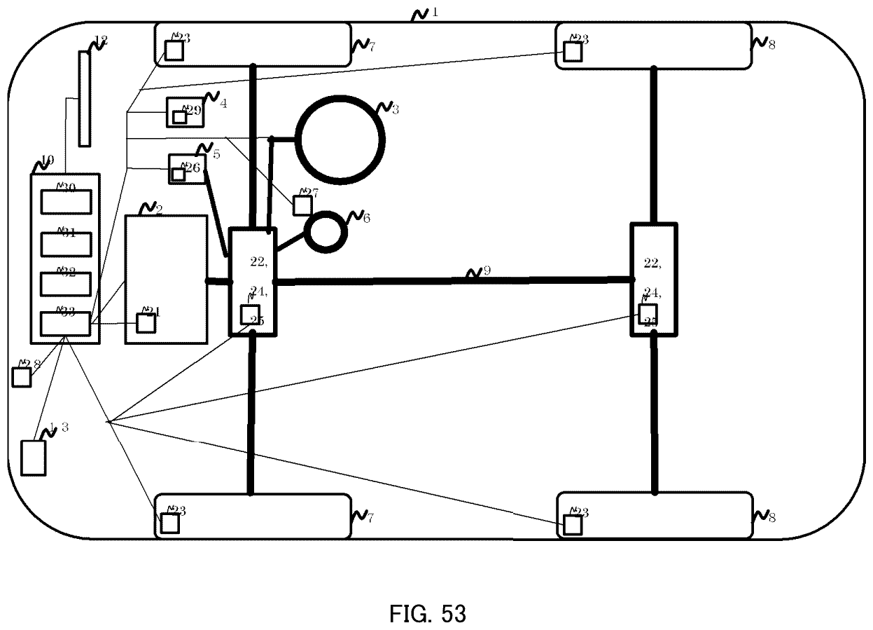

FIG. 53 illustrates an exemplary arrangement of a vehicle 1. As illustrated in FIG. 53, the vehicle 1 includes a driving unit 2, a steering unit 3, an accelerator pedal 4, a brake pedal 5, a shift lever 6, front wheels 7, rear wheels 8, an axle 9, an electronic controller 10, various sensors 21 to 29, an information service unit 12 and a communication module 13.

The driving unit 2 may be composed of an engine, a motor or a hybrid of the engine and the motor, for example.

The steering unit 3 may at least include a steering wheel (which is also called a handle) and be arranged to steer at least one of the front wheels and the rear wheels based on user's operation of the steering wheel.

The electronic controller 10 is composed of a microprocessor 31, a memory (ROM, RAM) 32 and a communication port (IO port) 33. Signals from the various sensors 21 to 27 incorporated in the vehicle are fed to the electronic controller 10. The electronic controller 10 may be referred to as an ECU (Electronic Control Unit).

The signals fed from the various sensors 21 to 28 may include a current signal from a current sensor 21 for sensing the current of a motor, an engine speed signal for the front or rear wheels obtained with an engine speed sensor 22, an air pressure signal for front or rear wheels obtained with an air pressure sensor 23, a vehicle speed signal obtained with a vehicle speed sensor 24, an acceleration signal obtained with an acceleration sensor 25, a stepping-in amount signal of an accelerator pedal obtained with an accelerator pedal sensor 29, a stepping-in amount signal of a brake pedal obtained with a brake pedal sensor 26, an operating signal of a shift lever obtained with a shift lever sensor 27, and a detection signal for detecting an obstacle, a vehicle, a pedestrian and the like obtained with an object detection sensor 28.

The information service unit 12 may be composed of various equipments for providing various information items such as driving information, traffic information, entertainment information, for example, a car navigation system, an audio system, a speaker, a television set and a radio set, and one or more ECUs for controlling these equipments. The information service unit 12 may use information obtained from an external device via the communication module 13 and the like to provide various multimedia information items and multimedia services to an occupant in the vehicle 1.

The information service unit 12 may include input devices for receiving inputs from external devices (for example, a keyboard, a mouse, a microphone, a switch, a button, a sensor, a touch panel and the like) and output devices for outputting to external devices (for example, a display, a speaker, a LED lump, a touch panel and the like).

A driving assistance system unit 30 may be composed of various equipments for providing functionalities for preventing an accident before it happens or reducing driving load of a driver, for example, a millimeter-wave radar, a LiDAR (Light Detection and Ranging), a camera, a positioning locator (for example, a GNSS or the like), map information (for example, a high definition (HD) map, an autonomous vehicle (AV) map and the like), a gyro system (for example, an IMU (inertial Measurement Unit), an INS (Inertial Navigation System) and the like), an AI (Artificial Intelligence) chip, and an AI processor, and one or more ECUs for controlling these equipments. Also, the driving assistance system unit 30 may transmit and receive various information items via the communication module 13 to implement a driving assistance functionality and an autonomous driving functionality.

The communication module 13 may communicate with the microprocessor 31 and components in the vehicle 1 via a communication port. For example, the communication module 13 transmits and receives data to and from the driving unit 2, the steering unit 3, the accelerator pedal 4, the brake pedal 5, the shift lever 6, the front wheels 7, the rear wheels 8 and the axle 9 provided in the vehicle 1, the microprocessor 31 and the memory (ROM, RAM) 32 in the electronic controller 10 and the sensors 21 to 28.

The communication module 13 is a communication device that can be controlled by the microprocessor 31 in the electronic controller 10 and communicate with an external device. For example, the communication module 13 may transmit and receive various information items to and from the external device in the air. The communication module 13 may be inside or outside the electronic controller 10. The external device may be a base station, a mobile station and the like, for example.

The communication module 13 may transmit at least one of signals from the above-stated various sensors 21-28 incoming into the electronic controller 10, information obtained based on the signals and information incoming from an external one (user) via the information service unit 12 to external devices via radio communication. The electronic controller 10, the various sensors 21-28, the information service unit 12 and the like may be referred to as an input unit for accepting inputs. For example, a PUSCH transmitted by the communication module 13 may include the information based on the above-stated inputs.

The communication module 13 receives various types of information (traffic information, traffic light information, vehicle distance information and others) and displays the information items to the information service unit 12 installed into the vehicle 1. The information service unit 12 may be referred to as an output unit for outputting information (feeding information to devices such as a display, a speaker and the like based on a PDSCH (or data/information decoded from the PDSCH) received at the communication module 13).

The communication module 13 stores various types of information received from an external device in the memory 32 available to the microprocessor 31. The driving unit 2, the steering unit 3, the accelerator pedal 4, the brake pedal 5, the shift lever 6, the front wheels 7, the rear wheels 8, the axle 9, the sensors 21-28 and others mounted in the vehicle 1 may be controlled by the microprocessor 31 based on the information items stored in the memory 32.

### (Summary of Embodiments)

As stated above, according to one aspect of the present disclosure, there is provided a terminal including a receiver that receives an indication or a configuration regarding an XDD (Cross Division Duplex) operation to radio resources, and a controller that controls uplink transmission or downlink reception in the radio resources in accordance with the indication or the configuration regarding the XDD operation.

According to this arrangement, the radio resources (for example, a cell, a BWP or the like) where the XDD operation can be configured can be limited.

In one embodiment, the receiver may receive an indication or a configuration regarding the XDD operation per frequency resource for time units on a bandwidth part, and the indication or the configuration regarding the XDD operation per frequency resource may indicate or configure a first frequency resource of the bandwidth part for uplink transmission or downlink reception and a second frequency resource of the bandwidth part for downlink reception or uplink transmission. According to this embodiment, the XDD operation can be configured per frequency resource.

In one embodiment, the receiver may receive an indication or a configuration regarding the XDD operation per terminal for time units on a bandwidth part, and the indication or the configuration regarding the XDD operation per terminal may indicate or configure the time units to a first terminal for uplink transmission or downlink reception and the time units to a second terminal for downlink reception or uplink transmission. According to this embodiment, the XDD operation can be configured per terminal.

In one embodiment, the receiver may receive an indication or a configuration indicative of a bandwidth part of a cell where the XDD operation is configured or a bandwidth part for the XDD operation of the cell. According to this embodiment, the BWP where the XDD operation is configured can be specified.

Also, according to one aspect of the present disclosure, there is provided a base station including a transmitter that transmits an indication or a configuration regarding an XDD (Cross Division Duplex) operation to radio resources, and a controller that controls uplink transmission or downlink reception in the radio resources in accordance with the indication or the configuration regarding the XDD operation.

According to the above arrangement, the radio resources (for example, a cell, a BWP or the like) where the XDD operation can be configured can be limited.

Also, according to one aspect of the present disclosure, there is provided a terminal implemented radio communication method including receiving an indication or a configuration regarding an XDD (Cross Division Duplex) operation to radio resources, and controlling uplink transmission or downlink reception in the radio resources in accordance with the indication or the configuration regarding the XDD operation.

According to this arrangement, the radio resources (for example, a cell, a BWP or the like) where the XDD operation can be configured can be limited.

Also, according to one aspect of the present disclosure, there is provided a terminal including a receiver that receives a PDCCH monitoring configuration for an XDD (Cross Division Duplex) operation, and a controller that controls PDCCH monitoring in accordance with the PDCCH monitoring configuration.

According to the above arrangement, if the XDD operation can be configured for PDCCH monitoring resources, the PDCCH monitoring in the XDD operation can be properly achieved.

In one embodiment, the PDCCH monitoring configuration may include a first PDCCH monitoring configuration for a non-XDD time unit and a second PDCCH monitoring configuration for an XDD time unit. According to this embodiment, the proper PDCCH monitoring configuration can be configured at the respective ones of the XDD operation and the non-XDD operation.

In one embodiment, the first PDCCH monitoring configuration may include one or more of a search space set configuration for the non-XDD time unit, a CORESET (COntrol REsource SET), a frequency domain resource configuration, and a frequency monitoring position configuration, and the second PDCCH monitoring configuration may include one or more search space set configurations for the XDD time unit, one or more CORESET configurations, one or more frequency domain resource configurations, one or more CORESET configurations, one or more frequency domain resource configurations and one or more frequency monitoring position configurations. According to this embodiment, the proper PDCCH monitoring configuration can be configured at the respective ones of the XDD operation and the non-XDD operation.

In one embodiment, the PDCCH monitoring configuration may include a PDCCH search space configuration, and the controller may control the PDCCH monitoring depending on whether a PDCCH monitoring occasion specified by the PDCCH search space configuration overlaps with XDD time units. According to this arrangement, the PDCCH monitoring can be properly achieved depending on whether the PDCCH monitoring occasion specified by the PDCCH search space configuration overlaps with the XDD time units.

Also, according to one aspect of the present disclosure, there is provided a base station including a configuration unit that configures a PDCCH monitoring configuration for an XDD (Cross Division Duplex) operation, and a transmitter that transmits the PDCCH monitoring configuration.

According to the above arrangement, if the XDD operation can be configured for PDCCH monitoring resources, the PDCCH monitoring in the XDD operation can be properly achieved.

Also, according to one aspect of the present disclosure, there is provided a terminal implemented radio communication method including receiving a PDCCH monitoring configuration for an XDD (Cross Division Duplex) operation, and controlling PDCCH monitoring in accordance with the PDCCH monitoring configuration.

According to the above arrangement, if the XDD operation can be configured for PDCCH monitoring resources, the PDCCH monitoring in the XDD operation can be properly achieved.

Also, according to one aspect of the present disclosure, there is provided a terminal including a receiver that receives a PDCCH monitoring capability regarding an XDD (Cross Division Duplex) operation for radio resources, and a controller that controls PDCCH monitoring in accordance with the PDCCH monitoring capability.

According to this arrangement, if the XDD operation can be configured for PDCCH monitoring resources, the PDCCH monitoring in the XDD operation can be properly achieved in accordance with the PDCCH monitoring capability.

In one embodiment, the PDCCH monitoring capability may be commonly configured for the XDD operation and the non-XDD operation. According to this embodiment, the PDCCH monitoring in the XDD operation can be properly achieved in accordance with the PDCCH monitoring capability.

In one embodiment, the PDCCH monitoring capability can be separately configured for the XDD operation and the non-XDD operation. According to this embodiment, the PDCCH monitoring in the XDD operation can be properly achieved in accordance with the PDCCH monitoring capability.

In one embodiment, the controller may count PDCCH candidates or non-overlap control channel elements in the XDD operation and PDCCH candidates or non-overlap control channel elements in the non-XDD operation separately or jointly. According to this embodiment, the PDCCH monitoring in the XDD operation can be properly achieved in accordance with the PDCCH monitoring capability.

Also, according to one aspect of the present disclosure, there is provided a base station including a controller that configures a PDCCH monitoring capability regarding an XDD (Cross Division Duplex) for radio resources, and a transmitter that transmits the PDCCH monitoring capability.

According to this embodiment, if the XDD operation can be configured for PDCCH monitoring resources, the PDCCH monitoring in the XDD operation can be properly achieved in accordance with the PDCCH monitoring capability.

Also, according to one aspect of the present disclosure, there is provided a terminal implemented radio communication method including receiving a PDCCH monitoring capability regarding an XDD (Cross Division Duplex) operation for radio resources, and controlling PDCCH monitoring in accordance with the PDCCH monitoring capability.

According to this embodiment, if the XDD operation can be configured for PDCCH monitoring resources, the PDCCH monitoring in the XDD operation can be properly achieved in accordance with the PDCCH monitoring capability.

Also, according to one aspect of the present disclosure, there is provided a terminal including a controller that controls PDCCH overbooking in XDD (Cross Division Duplex) time units where PDCCH monitoring is configured, and a receiver that performs the PDCCH monitoring in a PDCCH monitoring occasion selected in the controlled PDCCH overbooking.

According to this arrangement, if the XDD operation can be configured for PDCCH monitoring resources, a PDCCH monitoring occasion can be properly selected in the PDCCH overbooking, and the PDCCH monitoring can be performed in the selected PDCCH monitoring occasion.

In one embodiment, the controller may select the PDCCH monitoring occasion in accordance with a prioritization. According to this embodiment, the PDCCH monitoring occasion can be properly selected in accordance with the prioritization.

In one embodiment, the PDCCH monitoring occasion may be selected based on a first prioritization between a common search space and a user specific search space, a second prioritization between a non-XDD search space set and an XDD search space set, and a third prioritization among search space indices. According to this embodiment, the PDCCH monitoring occasion can be properly selected in accordance with the prioritization.

In one embodiment, the PDCCH monitoring occasion may be selected further based on a fourth prioritization between a non-XDD PDCCH monitoring occasion and an XDD PDCCH monitoring occasion. According to this embodiment, the PDCCH monitoring occasion can be properly selected in accordance with the prioritization.

Also, according to one aspect of the present disclosure, there is provided a base station including a controller that configures a PDCCH monitoring occasion overbooking in XDD (Cross Division Duplex) time units where PDCCH monitoring is configured, and a transmitter that transmits control information in the PDCCH monitoring occasion.

According to the above arrangement, if the XDD operation can be configured for PDCCH monitoring resources, the PDCCH monitoring occasion can be properly selected in the PDCCH overbooking, and the PDCCH monitoring can be performed in the selected PDCCH monitoring occasion.

Also, according to one aspect of the present disclosure, there is provided a terminal implemented radio communication method including controlling PDCCH overbooking in XDD (Cross Division Duplex) time units where PDCCH monitoring is configured, and performing the PDCCH monitoring in a PDCCH monitoring occasion selected in the controlled PDCCH overbooking.

According to the above arrangement, if the XDD operation can be configured for PDCCH monitoring resources, the PDCCH monitoring occasion can be properly selected in the PDCCH overbooking, and the PDCCH monitoring can be performed in the selected PDCCH monitoring occasion.

Also, according to one aspect of the present disclosure, there is provided a terminal including a controller that selects a PDCCH monitoring beam in XDD (Cross Division Duplex) time units where PDCCH monitoring is configured, and a receiver that performs the PDCCH monitoring for the selected PDCCH monitoring beam.

According to the above arrangement, if the XDD operation can be configured for PDCCH monitoring resources, the PDCCH monitoring beam can be properly selected, and the PDCCH monitoring can be performed with the selected PDCCH monitoring beam.

In one embodiment, the controller may select the PDCCH monitoring beam in accordance with a prioritization. According to this embodiment, the PDCCH monitoring beam can be properly selected.

In one embodiment, the PDCCH monitoring beam may be selected based on a first prioritization between a common search space and a user specific search space, a second prioritization among cell indices, and a third embodiment among search space indices. According to this embodiment, the PDCCH monitoring beam can be properly selected.

In one embodiment, the PDCCH monitoring beam may be selected further based on a fourth prioritization between a cell where the XDD operation is indicated or configured and a cell where the XDD operation is not indicated or configured, a fifth prioritization between a non-XDD search space and an XDD search space, and a sixth prioritization between a non-XDD PDCCH monitoring occasion and an XDD PDCCH monitoring occasion. According to this embodiment, the PDCCH monitoring beam can be properly selected.

Also, according to one aspect of the present disclosure, there is provided a base station including a controller that controls a PDCCH monitoring beam in XDD (Cross Division Duplex) time units where PDCCH monitoring is configured, and a transmitter that transmits control information with the PDCCH monitoring beam.

According to the above arrangement, if the XDD operation can be configured for PDCCH monitoring resources, the PDCCH monitoring beam can be properly selected, and the PDCCH monitoring can be performed with the selected PDCCH monitoring beam.

Also, according to one aspect of the present disclosure, there is provided a terminal implemented radio communication method including selecting a PDCCH monitoring beam in XDD (Cross Division Duplex) time units where PDCCH monitoring is configured, and performing the PDCCH monitoring for the selected PDCCH monitoring beam.

According to the above arrangement, if the XDD operation can be configured for PDCCH monitoring resources, the PDCCH monitoring beam can be properly selected, and the PDCCH monitoring can be performed with the selected PDCCH monitoring beam.

### (Supplement of Embodiments)

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming”, “expecting”, “considering”, and the like.

The terms “connected” and “coupled” as well as any derivatives of the terms mean any direct or indirect connection and coupling between two or more elements, and the terms can include cases in which one or more intermediate elements exist between two “connected” or “coupled” elements. The coupling or the connection between elements may be a physical or logical coupling or connection or may be a combination of the physical and logical couplings or connections. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

A reference signal can also be abbreviated as an RS and may also be called as a pilot depending on the applied standard.

The recitation “based on” used in the present disclosure does not mean “based only on”, unless otherwise specified. In other words, the recitation “based on” means both of “based only on” and “based at least on”.

Any reference to elements by using the terms “first”, “second”, and the like that are used in the present disclosure does not generally limit the quantities of or the order of these elements. These terms can be used in the present disclosure as a convenient manner of distinguishing between two or more elements. Therefore, reference to first and second elements does not mean that only the two elements can be employed, or that the first element has to precede the second element somehow.

The “means” in the arrangements of the above respective apparatuses may be replaced with “unit”, “circuitry”, “device”, or the like.

In cases where terms “include”, “including”, and their derivatives are used in the present disclosure, these terms are intended to be inclusive like the term “comprising”. Further, the term “or” used in the present disclosure is not intended to be an exclusive OR.

A radio frame may be constituted by one or more frames in the time domain. The one frame or each of the plurality of frames may be referred to as a subframe in the time domain. The subframe may be further constituted by one or more slots in the time domain. The subframe may have a fixed time length (e.g., 1 ms) independent of numerology.

The numerology may be a communication parameter that is applied to at least one of transmission and reception of a certain signal or channel. For example, the numerology may indicate at least one of SubCarrier Spacing (SCS), a bandwidth, a symbol length, a cyclic prefix length, a Transmission Time Interval (TTI), the number of symbols per TTI, a radio frame arrangement, a specific filtering processing that is performed by a transceiver in the frequency domain, a specific windowing processing that is performed by the transceiver in the time domain, and the like.

The slot may be constituted by one or more symbols (e.g., an Orthogonal Frequency Division Multiplexing (OFDM) symbol, a Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit longer than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be referred to as other corresponding names.

For example, one subframe, a plurality of continuous subframes, one slot, or one mini-slot may be referred to as a Transmission Time Interval (TTI). Namely, at least one of the subframe and the TTI may be a subframe (1 ms) in the existing LTE or have a duration (for example, 1 to 13 symbols) shorter than 1 ms or a duration longer than 1 ms. Note that a unit that represents the TTI may be referred to as a slot, a mini-slot, or the like instead of a subframe.

Here, the TTI, for example, refers to a minimum time unit for scheduling in radio communication. For example, in an LTE system, an IAB node performs scheduling for allocating a radio resource (a frequency bandwidth, a transmit power, and the like that are available to each user terminal) on the unit of TTI to each user terminal. Note that the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in the case where one slot or one mini-slot is referred to as the TTI, one or more TTIs (that is, one or more slots, or one or more mini-slots) may be a minimum time unit for the scheduling. Furthermore, the number of slots (the number of mini-slots) that compose the minimum time unit for the scheduling may be controlled.

A TTI having a time length of 1 ms may be referred to as a regular TTI (a TTI in LTE Rel. 8 to LTE Rel. 12), a normal TTI, a long TTI, a regular subframe, a normal subframe, a long subframe, a slot, or the like. A TTI shorter than the regular TTI may be referred to as a shortened TTI, a short TTI, a partial TTI (or a fractional TTI), a shortened subframe, a short subframe, a mini-slot, a subslot, a slot, or the like.

Note that the long TTI (for example, the regular TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one or more symbols in the time domain, and may have a length of one slot, one mini slot, one subframe, or one TTI. One TTI and one subframe may be constituted by one or more resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region of one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. A terminal may be configured with one or more BWPs within one carrier.

At least one of the configured BWPs may be active, and the terminal does not have to assume transmission/reception of a predetermined signal or channel outside the active BWP. Note that “cell”, “carrier”, and the like in the present disclosure may be replaced with “BWP”.

Structures of the radio frame, the subframe, the slot, the mini-slot, the symbol, and the like as described above are merely illustrative. For example, the arrangement such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

The term “maximum transmit power” as described in the present disclosure may mean the maximum value of transmit power, the nominal UE maximum transmit power or the rated UE maximum transmit power.

In cases where articles, such as “a”, “an”, and “the” in English, for example, are added in the present disclosure by translation, nouns following these articles may have the same meaning as used in the plural.

The expression “A differs from B” may mean “A mutually differs from B” in the present disclosure. Note that the expression may mean “A and B each differs from C.” The terminologies “separate”, “couple” or the like may be interpreted similar to “differ”.

### REFERENCE SYMBOLS LIST

10 Radio communication system
100 Base station (gNB)
200 Terminal (UE)

1. A terminal, comprising:
a controller that controls PDCCH overbooking in XDD (Cross Division Duplex) time units where PDCCH monitoring is configured; and
a receiver that performs PDCCH monitoring in a PDCCH monitoring occasion selected in the controlled PDCCH overbooking.

2. The terminal as claimed in claim 1, wherein the controller selects the PDCCH monitoring occasion in accordance with a prioritization.

3. The terminal as claimed in claim 2, wherein the PDCCH monitoring occasion is selected based on a first prioritization between a common search space and a user specific search space, a second prioritization between a non-XDD search space set and an XDD search space set, and a third prioritization among search space indices.

4. The terminal as claimed in claim 3, wherein the PDCCH monitoring occasion is selected further based on a fourth prioritization between a non-XDD PDCCH monitoring occasion and an XDD PDCCH monitoring occasion.

5. Abase station, comprising:
a controller that configures a PDCCH monitoring occasion overbooking in XDD (Cross Division Duplex) time units where PDCCH monitoring is configured; and
a transmitter that transmits control information in the PDCCH monitoring occasion.

6. A terminal implemented radio communication method, comprising:
controlling PDCCH overbooking in XDD (Cross Division Duplex) time units where PDCCH monitoring is configured; and
performing PDCCH monitoring in a PDCCH monitoring occasion selected in the controlled PDCCH overbooking.
